(19) United States
(12) Patent Application Publication
(10) Pub. No.: US 2026/0149322 A1
(43) Pub. Date: May 28, 2026

(54) Permanent Magnet Rotor for Electrical Submersible Motor and Methods of Construction Thereof Using Retaining Sleeve

(71) Applicant: Halliburton Energy Services, Inc., Houston, TX (US)

(72) Inventors: Hassan Mansir, Frimley (GB); Michael Rimmer, Frimley (GB); Andras Bencze, Frimley (GB)

(21) Appl. No.: 18/958,844

(22) Filed: Nov. 25, 2024

(51) Int. Cl. H02K 1/276; H02K 15/03

(52) U.S. Cl. CPC H02K 1/276; H02K 15/03; H02K 2215/00

(57) ABSTRACT

Improved rotor modules and methods of assembly are disclosed. For example, a rotor module may comprise a plurality of laminations, each configured to be concentrically disposed on the drive shaft; a plurality of magnets; two end rings; and a retaining sleeve. The plurality of laminations can be axially stacked to form a carrier having a plurality of axially-extending grooves, each configured to retain one or more of the plurality of magnets. The retaining sleeve can extend concentrically around the carrier and magnets, holding the magnets within the grooves of the carrier, and can be configured to retain the end rings onto both ends of the carrier, for example via permanent deformation and/or interference fit.

### CROSS-REFERENCE TO RELATED APPLICATIONS

None.

### STATEMENT REGARDING FEDERALLY SPONSORED RESEARCH OR DEVELOPMENT

Not applicable.

### FIELD

This disclosure relates generally to the field of pumping. More particularly, this disclosure relates to the field of electric submersible pumps for use downhole in a well. Still more particularly, this disclosure relates to downhole motors of the sort which may be used in electric submersible pumps, and to improved rotor modules for such downhole motors.

### BACKGROUND

Electric submersible pump (ESP) assemblies are used to artificially lift fluid to the surface, for example in deep wells such as oil or water wells. ESP assemblies are commonly used in the oil and gas industry to extract fluids from underground reservoirs. By way of example, the artificial lift provided by ESP assemblies may be useful in situations when the reservoir does not have sufficient energy to allow the well to naturally produce effectively, or when an additional boost to production of the well is desired. Improvements to ESP assemblies can improve overall production of fluids from a well, which may thereby improve the profitability of the well. Improvements in the construction and assembly of the ESP and/or its component parts may result in lower ESP costs and/or in improved characteristics (such as durability or life).

A typical ESP assembly comprises, from bottom to top, an electric motor, a seal section, a pump intake, and a pump (e.g. typically a centrifugal pump), which are all mechanically connected together with shafts and shaft couplings. The electric motor supplies torque to the shafts, which provide power to the pump. The electric motor is isolated from a wellbore environment by a housing and by the seal section. In some embodiments, the seal section can act as an oil reservoir for the electric motor. For example, the oil can function both as a dielectric fluid and as a lubricant in the electric motor. The seal section also may provide pressure equalization between the electric motor and the wellbore environment.

The pump is configured to transform mechanical torque received from the electric motor via a drive shaft to fluid pressure which can lift fluid up the wellbore. For example, a centrifugal pump typically has rotatable impellers within stationary diffusers. A shaft extending through the centrifugal pump is operatively coupled to the motor, and the impellers of the centrifugal pump are rotationally coupled to the shaft. In use, the motor can rotate the shaft, which in turn can rotate the impellers of the centrifugal pump relative to and within the stationary diffusers, thereby imparting pressure to the fluid within the centrifugal pump. The electric motor is generally connected to a power source located at the surface of the well, for example using a cable and a motor lead extension. The ESP assembly can be placed into the well and usually is disposed inside a well casing. In a cased completion, the well casing separates the ESP assembly from the surrounding formation. In operation, perforations in the well casing allow well fluid to enter the well casing and flow to the pump intake for transport to the surface.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic illustration of an exemplary electric submersible pump (ESP) assembly disposed in a wellbore, according to an embodiment of the disclosure;

FIG. 2 is a cross-sectional view of an exemplary motor for the electric submersible pump assembly of FIG. 1, according to an embodiment;

FIG. 3 is an exploded isometric view of the motor of FIG. 2, according to an embodiment of the disclosure;

FIG. 4 is a partial cut-away isometric view of an exemplary ESP motor having a plurality of rotor modules with rotor bearing assemblies therebetween, according to an embodiment of the disclosure;

FIG. 5 is an isometric view of an exemplary rotor assembly for an ESP motor of an ESP pump assembly, according to an embodiment of the disclosure;

FIG. 6A is a side view of an exemplary rotor module for an exemplary rotor assembly, according to an embodiment of the disclosure;

FIG. 6B is a radial cross-sectional view of the rotor module of FIG. 6A, according to an embodiment of the disclosure;

FIG. 7A is a side view of another exemplary rotor module embodiment similar to that of FIG. 6A but having additional balance planes, according to an embodiment of the disclosure;

FIG. 7B is a cross-sectional view of two exemplary embodiments of a balance plane of the sort used in FIG. 7A, according to an embodiment of the disclosure;

FIG. 7C is a schematic end view of the axial balance plane embodiment of FIG. 7B, according to an embodiment of the disclosure;

FIG. 8 is a radial cross-sectional view of yet another exemplary rotor module, according to an embodiment of the disclosure;

FIG. 9 is a radial cross-sectional view of still another exemplary rotor module, according to an embodiment of the disclosure;

FIGS. 10A-C illustrate exemplary balance mass channel variants at exemplary balance positions in an exemplary rotor module, according to an embodiment of the disclosure;

FIG. 11A is a radial cross-sectional view of yet another exemplary rotor module (e.g. similar to FIG. 8, but with balance mass channels and/or balance positions), according to an embodiment of the disclosure;

FIG. 11B illustrates an alternate exemplary insert for the rotor module embodiment of FIG. 11A, according to an embodiment of the disclosure;

FIG. 11C is a side view of the rotor module embodiment of FIG. 11A, according to an embodiment of the disclosure;

FIG. 11D is an isometric view of the rotor module of FIG. 11A schematically illustrating insertion of one or more balance masses into balance mass channels of the rotor module, according to an embodiment of the disclosure;

FIG. 12A is a radial cross-sectional view of still another exemplary rotor module (e.g. similar to FIG. 9, but with balance mass channels and/or balance positions), according to an embodiment of the disclosure;

FIG. 12B is a side view of the rotor module embodiment of FIG. 12A, according to an embodiment of the disclosure;

FIG. 12C is a side view of an alternate embodiment of a rotor module similar to that of FIG. 12B in which the balance mass channels each extend from the corresponding end of the rotor module for less than half of the length of the rotor module, leaving a central portion of the active length of the rotor module without channels extending therein, according to an embodiment of the disclosure;

FIG. 13 is a radial cross-sectional view of yet another exemplary rotor module (e.g. for a synchronous reluctance rotor), according to an embodiment of the disclosure;

FIG. 14 is a radial cross-sectional view of still another exemplary rotor module (e.g. for a switch reluctance (e.g. 8-pole rotor), according to an embodiment of the disclosure;

FIG. 15 is a radial cross-sectional view of yet another exemplary rotor module (e.g. for a 2-pole hybrid PMM rotor), according to an embodiment of the disclosure;

FIG. 16 is a radial cross-sectional view of still another exemplary rotor module (e.g. for an exemplary induction motor rotor), according to an embodiment of the disclosure;

FIG. 17 is a radial cross-sectional view of yet another exemplary rotor module (e.g. for an exemplary 2-pole PMM motor rotor), illustrating exemplary balance mass channel positioning according to an embodiment of the disclosure;

FIG. 18 is a radial cross-sectional view of still another exemplary rotor module (e.g. for an exemplary 2-pole PMM motor rotor similar to FIG. 17, but illustrating exemplary alternate balance mass channel positioning), according to an embodiment of the disclosure;

FIG. 19 is a radial cross-sectional view of yet another exemplary rotor module (e.g. for an exemplary induction motor rotor similar to FIG. 16, but illustrating exemplary alternate balance mass channel positioning), according to an embodiment of the disclosure;

FIG. 20A is an isometric view illustrating an exemplary balance mass (e.g. configured for insertion into a channel of an exemplary rotor module, for example in a manner similar to that shown in FIG. 11D and/or to help balance the rotor module), according to an embodiment of the disclosure;

FIG. 20B is an isometric view of another exemplary balance mass (e.g. similar to FIG. 20A but also having threading), according to an embodiment of the disclosure;

FIG. 20C is an isometric view of yet another exemplary balance mass (e.g. similar to FIG. 20A, but also comprising multiple balance mass segments), according to an embodiment of the disclosure;

FIG. 21A is a schematic view of an exemplary rotor module (e.g. having four balance positions and/or channels, which are evenly spaced around the axis of the rotor module and/or the drive shaft, for example with 90 degrees therebetween), according to an embodiment of the disclosure;

FIG. 21B is a schematic view of another exemplary rotor module (e.g. having four balance positions and/or channels, which are unevenly spaced around the axis of the rotor module and/or the drive shaft, for example with 60 degrees between some adjacent channels and 120 degrees between other adjacent channels), according to an embodiment of the disclosure;

FIG. 22 is a schematic view of an exemplary rotor module, illustrating an exemplary mass-splitting approach (e.g. for determining the specific balance mass channels and/or specific masses for insertion of the balance masses to help balance the rotor module), according to an embodiment of the disclosure; and

FIG. 23A-B are schematic views of an exemplary rotor module, illustrating an exemplary mass-splitting approach (e.g. similar to that of FIG. 22, but for higher pole count rotor modules), according to an embodiment of the disclosure.

FIG. 24 is an isometric view of another exemplary rotor module, according to an embodiment of the disclosure;

FIG. 25 is an exploded view of the rotor module of FIG. 24, according to an embodiment of the disclosure;

FIG. 26A is a side view of an exemplary retaining strip of the sort used in FIG. 25, according to an embodiment of the disclosure;

FIG. 26B is a side view of an alternate exemplary retaining strip embodiment, according to an embodiment of the disclosure;

FIG. 27 is a partial isometric view of an end of the rotor module embodiment of FIG. 24 during assembly, according to an embodiment of the disclosure;

FIG. 28 is a partial isometric view of the end of the rotor module of FIG. 27 with the retaining strips bent/folded to secure the end rings in place according to an embodiment of the disclosure;

FIG. 29 is an end view of FIG. 27, according to an embodiment of the disclosure;

FIG. 30 is an end view of FIG. 28, according to an embodiment of the disclosure;

FIG. 31 is a cross-sectional view of FIG. 27, according to an embodiment of the disclosure;

FIG. 32 is a cross-sectional view of FIG. 28, according to an embodiment of the disclosure;

FIG. 33 is a cross-sectional view of an alternate embodiment having carrier strips configured to secure the lamination stack (e.g. prior to attachment of the end rings, for example using retaining strips), according to an embodiment of the disclosure;

FIG. 34A is an isometric view of the exemplary end ring of FIG. 33, illustrating an exterior surface, according to an embodiment of the disclosure;

FIG. 34B is an isometric view of the exemplary end ring of FIG. 34A, illustrating an interior surface (e.g. configured to face and/or contact the end of the lamination stack/carrier), according to an embodiment of the disclosure;

FIG. 35 is an isometric view of an exemplary carrier/lamination stack with carrier strips, according to an embodiment of the disclosure;

FIG. 36 is an exploded view of the carrier of FIG. 35, according to an embodiment of the disclosure;

FIG. 37 is a partial isometric view of an end of the carrier of FIG. 35, with the carrier strips inserted through the carrier during assembly, according to an embodiment of the disclosure;

FIG. 38 is a partial isometric view of the end of the carrier of FIG. 37, with the carrier strips bent/folded to secure the laminations of the lamination stack/carrier together (e.g. prior to addition of end rings), according to an embodiment of the disclosure;

FIG. 39A is an end/top view of an exemplary lamination, which can be stacked with other such laminations to form the lamination stack of FIG. 37, according to an embodiment of the disclosure;

FIG. 39B is an isometric view of the lamination of FIG. 39A, according to an embodiment of the disclosure;

FIG. 40 is a partial isometric view of an end of another exemplary rotor module, according to an embodiment of the disclosure;

FIG. 41 is an isometric view of another exemplary embodiment of a rotor module (e.g. using a surface mount configuration), according to an embodiment of the disclosure;

FIG. 42 is an exploded view of the rotor module of FIG. 41, according to an embodiment of the disclosure;

FIG. 43 is a partial isometric view of an end of the rotor module of FIG. 41 during assembly, according to an embodiment of the disclosure;

FIG. 44 is a partial isometric view of the end of FIG. 43 with the retaining sleeve swaged radially inward at the distal ends (e.g. so that the retaining sleeve at its distal end has an inner diameter less than the outer diameter of the end ring and/or carrier), according to an embodiment of the disclosure;

FIG. 45 is an end view of the rotor module of FIG. 44, according to an embodiment of the disclosure;

FIG. 46 is a cross-section of FIG. 43 (e.g. prior to swaging), according to an embodiment;

FIG. 47 is a cross-section of FIG. 44 (e.g. illustrating exemplary swag of the retaining sleeve), according to an embodiment of the disclosure;

FIG. 48 is an isometric view of an exemplary carrier subsection, according to an embodiment of the disclosure;

FIG. 49 is an isometric view of a plurality of exemplary subsections being joined into a single, unitary rotor module (e.g. by a single retaining sleeve), according to an embodiment of the disclosure;

FIG. 50 is an end/top view of an exemplary lamination of the sort used in the lamination stack of the carrier of FIG. 42 or the carrier subsection of FIG. 48, according to an embodiment of the disclosure;

FIG. 51 is a partial view of an end of an alternate embodiment of a rotor module with retaining sleeve, according to an embodiment of the disclosure;

FIG. 52 is a partial view of an end of another alternate embodiment of a rotor module with retaining sleeve, according to an embodiment of the disclosure;

FIG. 53 is a cross-sectional view of an end ring for the rotor module embodiment of FIG. 51, according to an embodiment;

FIG. 54 is a cross-sectional view of an end ring for the rotor module embodiment of FIG. 52, according to an embodiment of the disclosure;

FIG. 55 is a cross-sectional view of the end of the rotor module of FIG. 51, according to an embodiment of the disclosure;

FIG. 56 is a cross-sectional view of the end of the rotor module of FIG. 52, according to an embodiment of the disclosure;

FIG. 57A is an isometric view of an exemplary device useful in assembly/construction of the rotor module of FIG. 24, showing the device before bending of the retaining strips, according to an embodiment of the disclosure;

FIG. 57B is an isometric view of the device of FIG. 57A as the retaining strips are being bent to hold the end rings in place, according to an embodiment of the disclosure;

FIG. 57C is an isometric view of the device of FIG. 57A with the retaining strips bent to hold the end rings in place, according to an embodiment of the disclosure;

FIG. 58A is a cross-section of another exemplary device useful in assembly/construction of the rotor module of FIG. 24, showing the device before bending of the retaining strips, according to an embodiment of the disclosure;

FIG. 58B is a cross-section view of the device of FIG. 58A as the retaining strips are bent to hold the end rings in place, according to an embodiment of the disclosure;

FIG. 59A is a cross-section of an exemplary device useful in assembly/construction of the rotor module of FIG. 41, showing the device before swaging of the retaining sleeve, according to an embodiment of the disclosure;

FIG. 59B is a cross-section of the device of FIG. 59A after swaging of the ends of the retaining sleeve, according to an embodiment of the disclosure;

FIG. 60 is an isometric view of an exemplary module subsection, according to an embodiment of the disclosure; and

FIG. 61 is an exploded isometric view of an exemplary rotor module having a plurality of module subsections similar to FIG. 60, according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As used herein, orientation terms “upstream,” “downstream,” “up,” and “down” are defined relative to the direction of flow of well fluid in the well casing. “Upstream” is directed counter to the direction of flow of well fluid, towards the source of well fluid (e.g., towards perforations in well casing through which hydrocarbons flow out of a subterranean formation and into the casing). “Downstream” is directed in the direction of flow of well fluid, away from the source of well fluid. “Down” is directed counter to the direction of flow of well fluid, towards the source of well fluid. “Up” is directed in the direction of flow of well fluid, away from the source of well fluid.

Disclosed embodiments relate generally to improved techniques for forming/assembling rotor assemblies. More specifically, disclosed embodiments may relate to rotor assemblies for an ESP motor (e.g. for use with a pump to form an ESP assembly for use downhole in a well to pump formation fluids from the well formation to the surface), and to improved systems and methods for balancing such rotor modules.

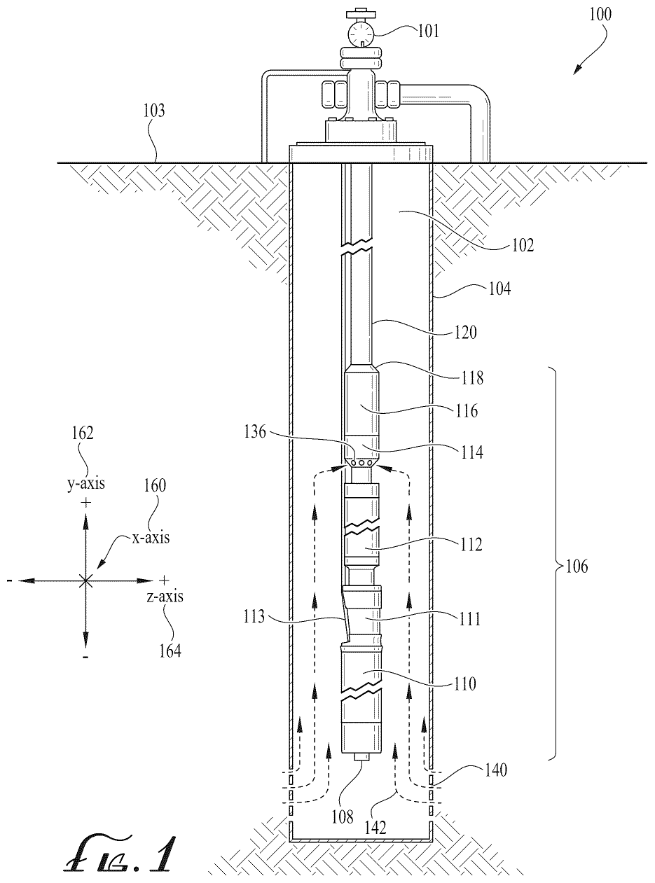

Turning now to FIG. 1, an exemplary producing well environment 100 is described. In an embodiment, the environment 100 comprises a wellhead 101 above a wellbore 102 located at the surface 103. A casing 104 is provided within the wellbore 102. For convenience of reference, FIG. 1 provides a directional reference comprising three coordinate axes—an X-axis 160 where positive displacements along the X-axis 160 are directed into the sheet and negative displacements along the X-axis 160 are directed out of the sheet; a Y-axis 162 where positive displacements along the Y-axis 162 are directed upwards on the sheet and negative displacements along the Y-axis 162 are directed downwards on the sheet; and a Z-axis 164 where positive displacements along the Z-axis 164 are directed rightwards on the sheet and negative displacements along the Z-axis 164 are directed leftwards on the sheet. In the embodiment of FIG. 1, the Y-axis 162 is approximately parallel to a central axis of a vertical portion of the wellbore 102.

An exemplary electric submersible pump (ESP) assembly 106 is deployed downhole in a well within the casing 104 and comprises an optional sensor unit 108, an electric motor 110 which may include a motor head 111, a seal section 112, an electric power cable 113, a pump intake 114, a centrifugal pump 116, and a pump outlet 118 that couples the centrifugal pump 116 to a production tubing 120. The centrifugal pump 116 is operatively coupled to the motor 110 by a shaft (not shown). In an embodiment, the ESP assembly 106 may employ thrust bearings in several places, for example in the electric motor 110, in the seal section 112, and/or in the centrifugal pump 116. While not shown in FIG. 1, in an embodiment, the ESP assembly 106 can comprise a gas separator that may employ one or more thrust bearings. The motor head 111 couples the electric motor 110 to the seal section 112. The electric power cable 113 may connect to a source of electric power at the surface 103 and to the electric motor 110, for example being configured to provide power from the source of electric power at the surface 103 to the electric motor 110.

In operation, the casing 104 is pierced by perforations 140, and reservoir fluid 142 flows through the perforations 140 into the wellbore 102. The fluid 142 flows downstream in an annulus formed between the casing 104 and the ESP assembly 106, is drawn into the pump intake 114, is pumped by the centrifugal pump 116, and is lifted through the production tubing 120 to the wellhead 101 to be produced at the surface 103. The fluid 142 may comprise hydrocarbons such as oil and/or gas, water, or both hydrocarbons and water.

While the example illustrated in FIG. 1 relates to land-based subterranean wells, similar ESP systems can be used in a subsea environment and/or may be used in subterranean environments located on offshore platforms, drill ships, semi-submersibles, drilling barges, etc. And while the wellbore is shown in FIG. 1 as being approximately vertical, in other embodiments, the wellbore may be horizontal, deviated, or any other type of well. Also, while the pump of the ESP is described with respect to FIG. 1 as a centrifugal pump, other types of pumps (such as a rod pump, a progressive cavity pump, any other type of pump suitable for the system, or combinations thereof) may be used instead.

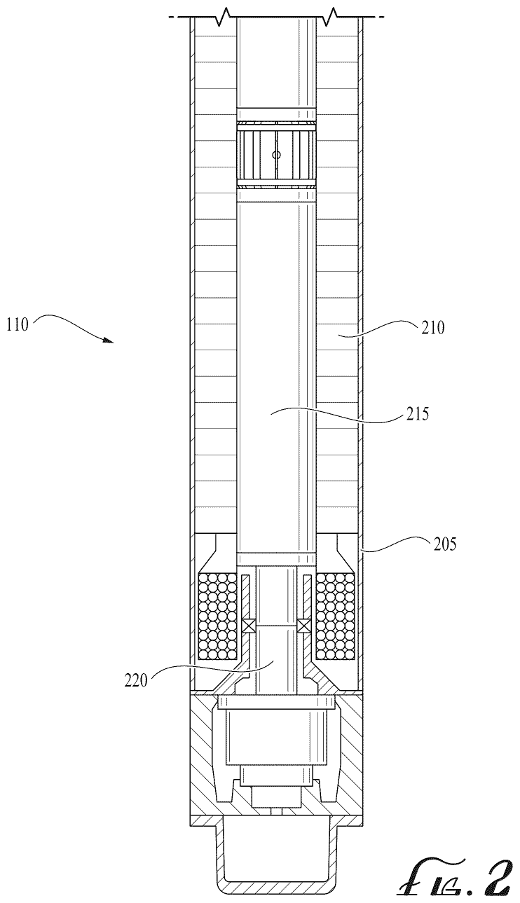

As shown in FIGS. 2-3, an exemplary motor 110 of the ESP assembly includes a housing 205, a stator 210, a rotor 215, and a drive shaft 220. The housing 205 typically comprises a hollow cylinder or tube and is configured to protect the internal components of the motor 110 from the external environment. The stator 210 also typically comprises a hollow cylinder and is secured to the housing 205 (e.g. to the inner surface of the housing 205) so as to be stationary within the housing 205. Typically, the stator 210 comprises a plurality of laminations, which may be thin sheets of electrical steel, wrapped by a plurality of electrically conductive windings. When energized, the windings can generate a rotating magnetic field for interaction with the rotor 215 to induce rotation of the rotor 215. The rotor 215 also typically comprises a hollow cylinder and is concentrically arranged between the stator 210 and the drive shaft 220, for example with the drive shaft 220 typically extending longitudinally along the centerline of the motor 110, the rotor 215 disposed around the drive shaft 220, and the stator 210 disposed around the rotor 215, within the housing 205. The rotor 215 is rotatable within the stator 210 and secured to the drive shaft 220, such that rotation of the rotor 215 drives the drive shaft 220. In embodiments, the motor 110 may be a two or more pole motor, a three-phase squirrel cage induction motor, a permanent magnet motor (PMM), a hybrid PMM, or other motor configuration.

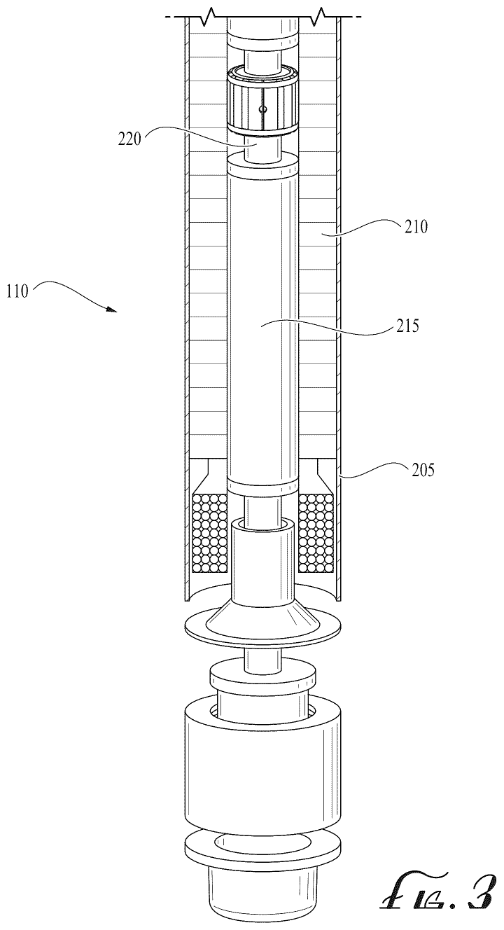

Depending on the power requirements of the motor 110, the rotor 215 can be an assembly which typically includes a number of rotor modules, which together jointly form the rotor assembly 215, with each rotor module secured to the drive shaft 220. The rotational magnetic field of the stator 210 when energized can induce rotation of the rotor 215, and thereby the drive shaft 220, with the drive shaft 220 transmitting rotational torque from the motor 110 to the pump 116. As shown in FIG. 4, the rotor modules 405 (jointly forming the rotor 215) are spaced apart from each other along the drive shaft 220, with a rotor bearing assembly 410 typically located between adjacent rotor modules 405. Rotor bearing assemblies 410 can also be located at the top of the uppermost rotor module 405 and/or the bottom of the lowermost rotor module 405 (e.g. at the top and bottom of the rotor). In some embodiments, the rotor bearing assembly 410 can be a hydrodynamic bearing assembly. Each rotor bearing assembly 410 is configured to support the rotor 215 at predefined axial positions to maintain correct radial alignment of the drive shaft 220 during motor operation.

FIG. 5 illustrates a typical rotor assembly 215 of an electric motor 110 (for example, of an ESP assembly). In embodiments, the electric motor 110 can be a permanent magnet motor. Typically, the rotor assemblies 215 shown in the figures belong to such a permanent magnet motor (PMM). However, alternate embodiments may include an electric motor of any conventional type, i.e. an induction motor or a hybrid PMM containing elements of both permanent magnet and induction motors. The rotor assembly 215 of the PMM utilizes permanent magnets to generate the electromagnetic field, compared to induction motors where the magnetic field is generated by inducing a current in rotor interconnected bars (e.g. rotor/cage bars), which may be made from copper or copper alloys.

A rotor assembly 215 embodiment can comprise a single drive shaft 220, a plurality of magnetic rotor modules 405, and a plurality of radial hydrodynamic bearing assemblies 410. Typically, a bearing assembly 410 can be disposed between adjacent rotor modules 405. In embodiments, the rotor assembly 215 can also include a pre-loading mechanism 505 (as shown in FIG. 5), which can provide thermal expansion compensation for the rotor assembly 215. In the embodiment shown in FIG. 5, the pre-loading mechanism 505 is disposed at the non-drive end (e.g. the motor base) of the rotor assembly 215, and it can be configured to act against the gravitational load 520 created by all the rotor modules 405 and journal bearing assemblies 410 installed on the shaft 220 (as well as addressing differential thermal expansion, for example). Alternatively, or in conjunction, the pre-loading mechanism 505 can be positioned at the drive end (e.g. the motor head) of the shaft 220, according to other embodiments.

For rotors to work most effectively, the rotor assembly should have low unbalance. For example, unbalanced rotors will lead to increased motor vibration, which can reduce run life of the motor and other ESP string components (e.g. due to increased wear). Additionally, improvements to rotor balance may allow for increased operational speeds for the motor. Accordingly, ISO/API standards exist with regard to rotor balance, and further improvements to rotor balance may prove even more beneficial.

Unfortunately, there are several issues which can make rotor balancing difficult. For example, in permanent magnet motors (PMM), the permanent magnets that are used in the rotors may have subtly different mass per volume, for example due to tolerances of the sintering process used in their manufacture. As a high number of magnet segments can be used per rotor module, there can be a significant effect of creating unbalance where the mass of magnets on one side of the rotor differs from the other. On hybrid PMM motors, the problem can be further exacerbated by the cage structure, for example since the copper bars of the cage structure may also be of subtly different weight causing a similar compounding issue. Additionally, the rotor unbalance may be made worse by inherent radial height difference (eccentricity) from side to side on the rotor. Overall, these sorts of effects can lead to high unbalances, which can negatively impact rotor and/or motor performance and/or run life.

Vibration standards, such as API and ISO, typically specify a vibrational limit on the measured vibration of downhole rotating equipment. This may be expressed in terms of the vibrational speed (e.g. in units of inch/s or mm/s). For instance, ISO specifies various vibration limits, or “balance grades” (e.g. G1, G2.5, G6.3 etc.), which specify a maximum allowable vibration (e.g. of 1 mm/s, 2.5 mm/s and 6.3 mm/s respectively). API typically specifies a maximum limit of 3.96 mm/s for downhole rotating equipment, such as motors.

Unbalance (U) can be directly expressed in terms of mass (m in grams, g) and a radius (r in mm) with ISO units of g·mm:

$$U = m \times r$$

Per ISO, the balance requirements (or maximum allowable unbalance U_{MAX} in g·mm) of a rotor can be directly computed based on the rotors mass (mᵣₒₜ in kg), the target balance grade (G in mm/s) and the rotation speed in RPM using the equation:

$${U}_{MAX} = \frac{9549 \times {m}_{rot} \times G}{RPM}$$

In turn U_{MAX} can be used to express the maximum radial offset, termed “eccentricity” (e), in μm (microns) of the rotor mass (mᵣₒₜ) using the unbalance equation above as

$$e = \frac{{U}_{MAX}}{{m}_{rot}} = \frac{9549 \times G}{RPM}$$

By way of example, taking a typical PMM rotor module weighing ˜20 kg, with a balance grade of G3.96 and an operating speed of 3600 rpm the equations can be used to give:

$${U}_{MAX} = \frac{9549 \times 20 \times 3.96}{3600} = 210 g \cdot mm$$

$$e = \frac{9549 \times 3.96}{3600} = 10.5 μ m$$

Accuracies in machining, forming, sintering or similar formation of parts are typically much greater than 25 μm. Additionally, tolerances during assembly can compound as parts are assembled together. Therefore, balance eccentricity of 10.5 um may not be readily achievable by dimensional control of the rotor.

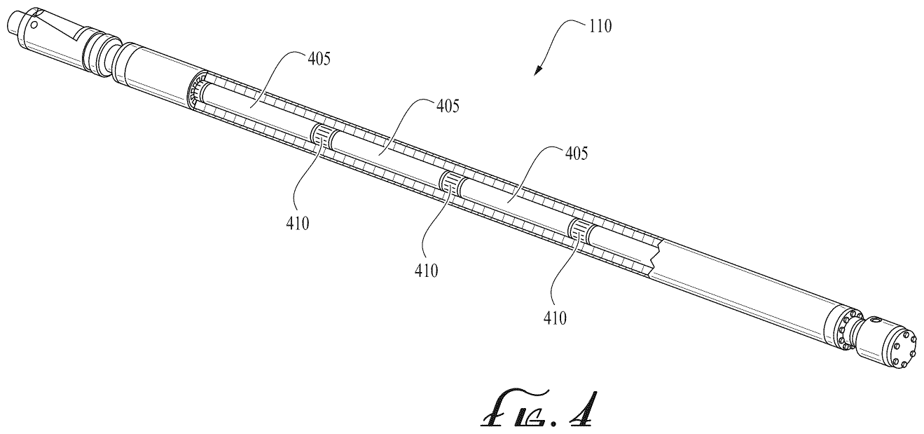

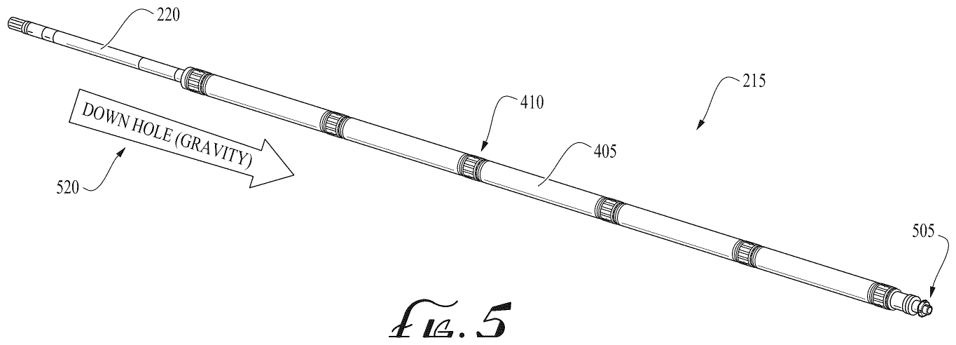

FIGS. 6A-B illustrate an exemplary rotor module 405, for example an exemplary hybrid PMM motor module, which may be considered with regard to balance issues. The rotor module 405 of FIG. 6A has an active length 61, which can be the axial length of the portion of the rotor module 405 configured for magnetic interaction with a corresponding stator, for example to drive the drive shaft, and/or the portion of the rotor module 405 operating (e.g. with the stator) to generate torque. In FIGS. 6A-B, the volume of magnets 5 may typically be controlled by 3 dimensions representing a height (h), width (w) and length (l). Additionally, the density of the sintered material forming the magnets 5 will often vary. This can result in significant variability in the mass of the magnets 5 of ˜mass=density×length×height×width; and the resulting unbalance effect, based on the radius (r) to the magnet's center of gravity may be characterized as ˜unbalance=density×length×height×width×radius. As an example, if each dimension varies by +1%, the mass can vary by ±4% and the unbalance effect by ±5%. By way of example, if the magnets 5 on one side of the rotor module 405 are at the lower bound (−5%), and the magnets 5 on the opposite side are at the upper bound (+5%), an exemplary worst-case unbalance effect on the rotor module 405 may be +10%. A similar issue of variability can occur with the rotor cage (e.g. comprising the rotor/cage bars 22 in FIG. 6B), where the masses of the rotor cage bars 22 may be distributed unevenly.

In practice for the typical rotor module, unbalances have been found to be on the order of approximately 2000-5000 g·mm, such that exemplary rotors may be 10-25 times outside of the required balance grade. Thus, rotor module balancing is likely required to achieve a desired standard, such as G3.96 ISO grade requirement, in a typical assembled motor. Consequently, additional approaches may be needed to achieve the desired rotor balance.

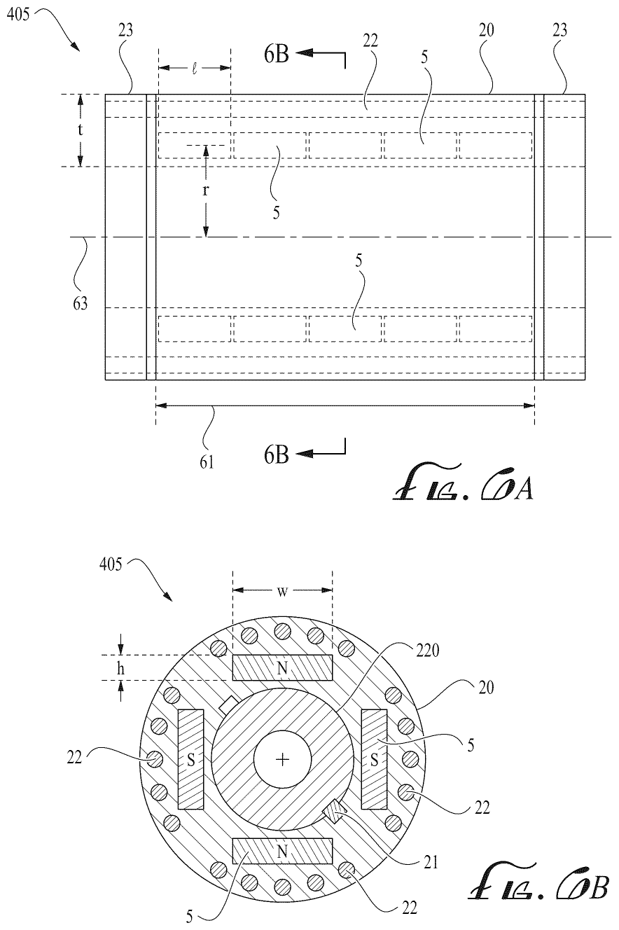

One exemplary approach for rotor balancing may be to add mass (e.g. by addition of grub screws or solid rod to a hole) or subtract mass (by drilling holes) into a balance plane 11, which may be an additional section (e.g. a non-active section having axial length) in addition to the active length 61 of the rotor module 405 (see for example FIGS. 7A-C). These balance planes 11 are typically located at each end of a rotor module 405, and thus the unbalance correction is typically distributed to each end of the rotor module 405 (e.g. for the example above 1000-2500 g·mm per plane). For the typical ESP rotor module 405, the balance hole radius can be on the order of 15 to 50 mm. In the example given, assuming a 42 mm balance hole radius, between 48 g to 119 g of mass addition or removal may be required based on the unbalance (m=U/r). At an exemplary radius of 42 mm, an exemplary balance plane 11 can fit a total of approximately 24 axially-oriented balance positions 6 (e.g. a tapped hole or a drill hole location) spaced at 15° per FIG. 7C (although, the number of balance positions is determined by the overall design, so in other embodiments any number is possible). Half of these balance positions 6 in FIG. 7C cannot be used, as the weight addition or removal must be on the side of the rotor module 405 of the correction direction 7 for balancing effect, resulting in a maximum of 12 balance positions for this exemplary rotor module balance plane 11. If the unbalance is rotated by half the angular spacing between holes then only 11 holes may be useable. A further issue is that as the balance positions angle away from the correction direction 7, the effect of the mass is reduced to the cosine of the angle (e.g. as shown in FIG. 7C). For example, the sum of balance position corrections represents 63.8% of the added/removed mass in the case of the 12 balance positions shown in FIG. 7C. Consequently, for a 6 mm diameter steel rod (e.g. for addition of mass in the balance plane 11) or hole (e.g. for subtraction of mass in the balance plane 11), the length/depth for each can be calculated as between 12 and 30 mm to achieve the required balance correction. Per FIG. 7A, an exemplary rotor module 405 can be on the order 300-800 mm long (e.g. total length). In a typical example, the length of the rotor module may be approximately 600 mm. When the holes are oriented axially (see for example the axial embodiment of FIG. 7B), the balance plane 11 needs to be at least the length of the maximum hole, and with two balance planes 11 of 30 mm at each end of the rotor module 405, this can represent approximately 60 mm of length. As a result, balance planes 11 for an exemplary rotor module 405 may occupy approximately 10% of the rotor module 405 length. This can have implications for an increased motor length, loss of motor power density, a potentially worse motor power factor and efficiency. Also, the sheer number of drilled holes or added masses may mean that assembly/manufacture becomes time consuming and adds to the manufacturing cost.

Similar issues may arise with respect to a radial approach using balance planes 11 with radially drilled balance holes in each balance plane (see for example the radial embodiment of FIG. 7B), where the radial thickness of the rotor module 405 may be insufficient to drill the explementary 12 mm to 30 mm hole. For instance, the radial thickness t of a rotor module 405 is typically no more than 22 mm. Additionally, the deeper portion of the hole has less effect, due to the radial change in height. Consequently, for the same example of 6 mm holes drilled in a module, the worst-case balance would require 2 axially disposed rows of 12 holes of depth 21.8 mm. This can cause a similar issue of making the balance planes 11 undesirable and adding manufacturing cost.

PMM rotors are typically long and of small diameter, which may result in only short local positions at which to add balance planes. Attempting to make the balance planes 11 added to the rotor module 405 too long can result in a loss of active length in the motor (e.g. since a significant portion of the overall length of the rotor may be taken up by balance planes 11, which do not serve as active portions of the motor, e.g. for generating torque), and thus loss of output and efficiency.

Additionally, the drilling option (e.g. to subtract mass from balance planes 11) may produce metal shavings and cuttings. Since PMM parts are typically constructed of magnetic materials, the metal shavings and cuttings may be attracted to the magnetic rotor surfaces and stick, becoming a challenge to remove and adding a further time consuming and costly assembly process. The strong attraction prevalent in permanent magnet rotor modules 405 can also lead to a safety issue, as these assemblies typically attract equipment such as drills and drill bits, which would be used to create holes in the subtract mass approach.

To overcome or address one or more of these types of issues, alternate disclosed embodiments may use a through hole add mass rotor balance approach. For example, the rotor module 405 may be balanced without additional balance planes by adding a length of solid rod (e.g. a balance mass), for example in channels positioned inside and typically passing through the entire magnetic length (e.g. active length 61) of the rotor module 405. Thus, the balance masses (e.g. solid rods) may extend (e.g. axially) into the active length 61 of the rotor module 405. For example, the channels can be disposed in the lamination structure supporting the magnets, for example in the interpolar spaces in some embodiments (as discussed below). Some embodiments may use 4 (or more) positions configured for addition of mass (e.g. four or more channels extending axially into the active length 61 of the rotor module 405 and each configured to receive a balance mass). By adding mass within the active length 61 of the rotor module 405, rotor balancing may be achieved while maximizing the active length of the rotor as a whole (which may for example allow for shorter rotors to be effective). This may address many of the concerns discussed above with either the addition or subtraction of mass balance plane approach.

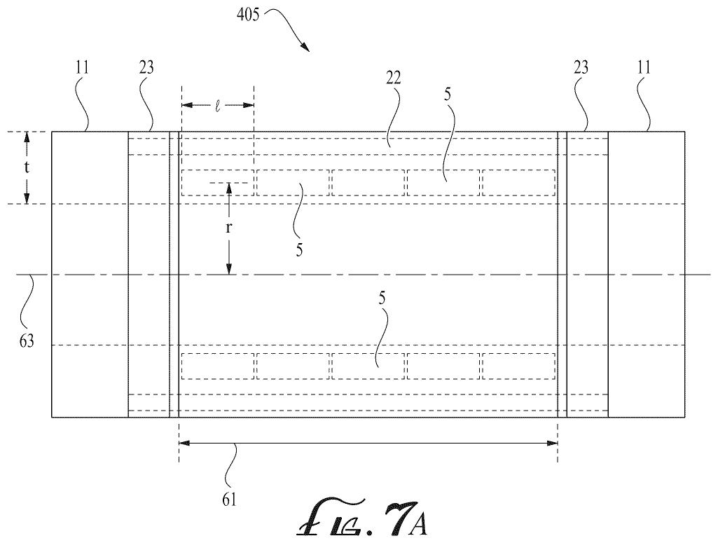

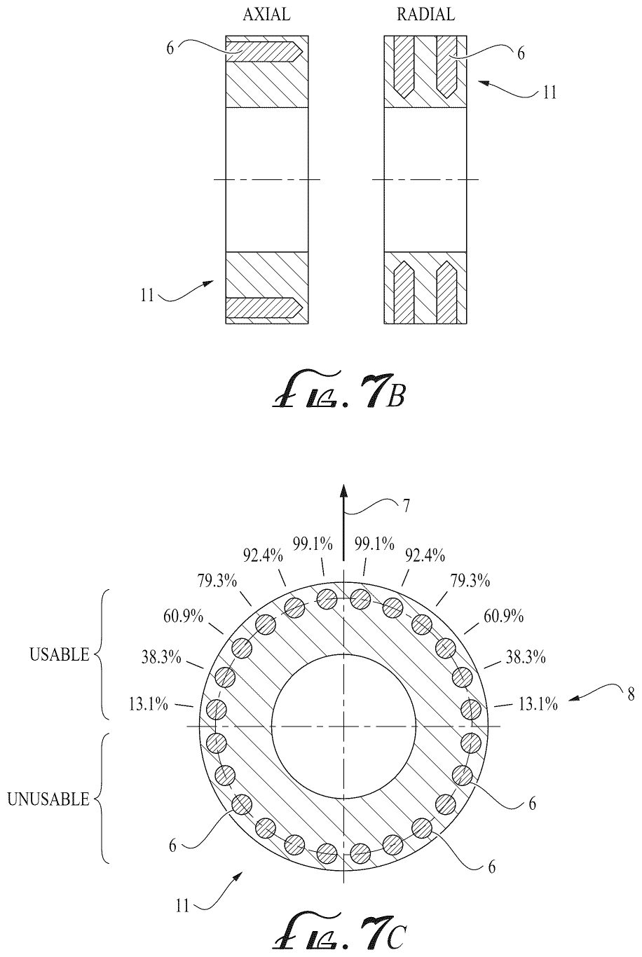

FIG. 8 illustrates an exemplary 4-Pole PMM. The example of FIG. 8 illustrates a surface mount design, in which the magnets 5 are mounted to a magnet carrier 17, which can be mounted to the drive shaft 220, for example with a key 21 configured to provide anti-rotation (e.g. to fix the rotation of the rotor module 405 to that of the shaft 220). In other embodiments the magnet carrier 17 and shaft 220 can be the same part (e.g. the magnet carrier can be integral with the shaft 220 and/or the shaft 220 can be formed to serve as the magnet carrier). In some embodiments, a retainer 19 may optionally be present to hold the magnets 5 to the magnet carrier 17. For example, the retainer 19 may be concentrically disposed around the magnets 5, the magnet carrier 17, and/or the drive shaft 220. FIG. 9 illustrates another exemplary rotor module 405, which is a hybrid PMM rotor module (e.g. in which magnets 5 are mounted into a lamination stack 20). In FIG. 9, rotor/cage bars 22 (e.g. configured for induction) also pass through the lamination stack 20 and can be electrically connected to cage ends 23 (see FIG. 6A-B for example) to create a squirrel cage (per an induction motor).

In the exemplary 4-pole magnetic rotor configurations of FIGS. 8-9, the design can include interpolar spaces 16. These are typically designed to create a flux barrier 23 to prevent the magnetic flux short cutting from the north magnet to the south through the rotor module 405, without linking through the stator windings. These flux barriers 23 are typically designed as non-magnetic voids. This void can be an air gap, oil gap or made from any suitable non-magnetic material (e.g. stainless steel, copper, titanium, tungsten, tungsten carbide, polymer, adhesive, potting compound etc.). The flux barrier 23 can also be a combination of air gaps (no material) and thin magnetic webs to provide structural support but designed to limit the leakage of flux.

In embodiments, a channel 24 can be disposed in one or more interpolar space/region 16, and configured to accept a rod of material (e.g. a balance mass 73, see below) to become a balance position 6 for the rotor module 405. The channel 24 can be part of the flux barriers 23, whose design is driven by electromagnetic considerations, but also can serve as a balance position 6 for the rotor module 405. In many PMM motors (e.g. see FIG. 8) and hybrid PMM motors (e.g. see FIG. 9), the magnets 5 can be held within a laminated structure, and the channels 24 can be directly stamped into the lamination. In some embodiments this can be a simple hole, although in other embodiments it may be any suitable shape to accept or hold the balance mass 73 (e.g. triangular, square, circular, polygonal, diamond, vee-shaped, c-shaped, threaded hole etc.). The channel 24 may be designed to support and/or retain the assembled balance mass 73, for example so that it cannot move inside the corresponding channel 24. Some exemplary geometries of the channel 24 are shown in FIGS. 10A-C. Assembly of the lamination stack 20 can create a plurality of channels 24 each extending axially (e.g. into the active length 61), for example along the entire length of the rotor module 405.

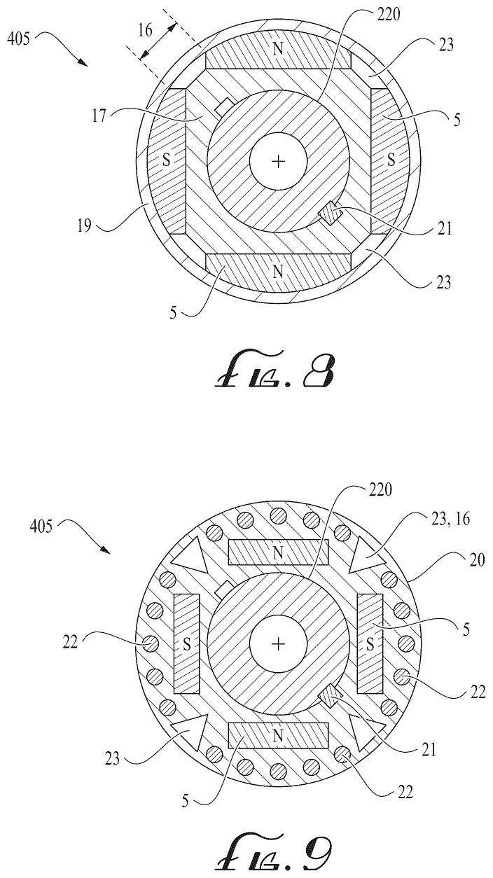

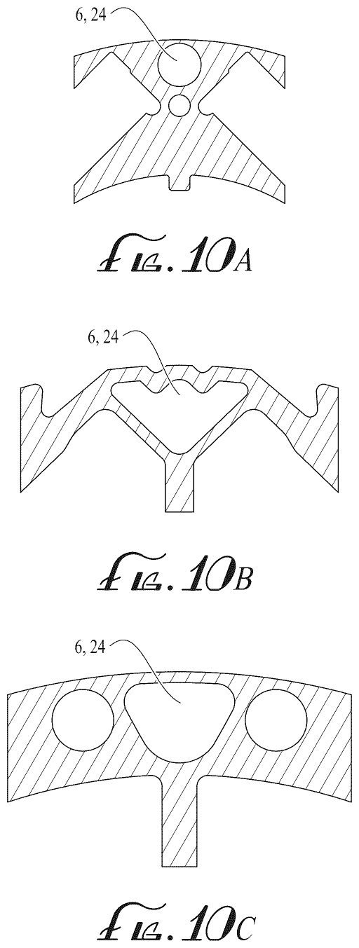

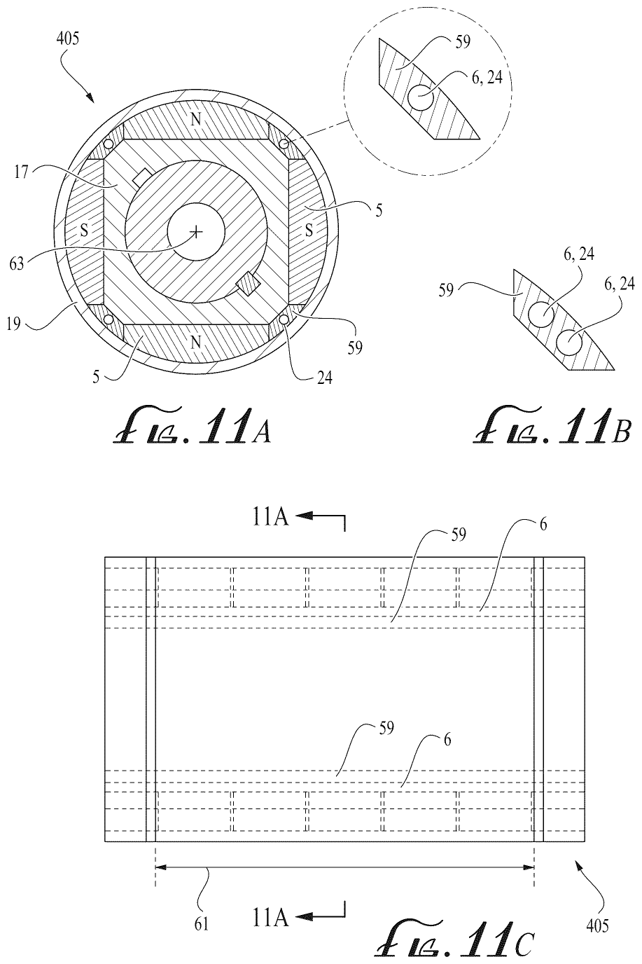

FIGS. 11A-D illustrate an exemplary rotor module 405 having such channels 24 each configured to receive a balance mass 73 and extending axially within the active length 61 of the rotor module 405 (e.g. its entire length). The exemplary rotor module 405 shown in FIGS. 11A-D is configured as a surface mount PMM. In some embodiments, each interpolar region may comprise a solid non-magnetic insert 59 with a suitable channel drilled/manufactured through it to once again make a channel 24 that extends into the active length 61 (e.g. at least half and up to the entire length of the rotor module 405). In some embodiments the insert 59 may be subdivided along the length and or width to ease manufacture. In some embodiments the channel 24 may be formed from the void created by omitting the solid non-magnetic insert 59 altogether. In some embodiments, the channels 24 may be punched or drilled in the lamination, the insert, and/or the magnet.

As shown in FIG. 11A, the channels 24 may be disposed around the drive shaft 220, for example creating a balance position 6 at approximately every 90° about the axis 63 of the rotor module 405 (which may be approximately parallel to the drive shaft 220). This concept can be extended to higher pole counts, e.g. 6-pole, 8-pole, 12-pole etc. with a corresponding number of interpolar spaces and channels. Also note, the number of channels 24 does not need to match the number of interpolar spaces 16 (e.g. an 8-pole rotor with interpolar gaps at every 45° could still have 4 channels disposed at every) 90°. In other embodiments, and dependent on geometry, there can be more than one channel 24 at each balance position 6 and/or in each insert 59 (see for example FIG. 11B). FIG. 11D illustrates insertion of one or more exemplary balance mass 73 (e.g. two balance masses) into the corresponding channel 24, for example as part of the balancing process for the rotor module 405. Embodiments may have 3-16 channels (e.g. extending through the length of the rotor module or disposed at each end), for example with higher numbers due to more poles in the motor (e.g. 6-pole, 8-pole etc.) or to having multiple channels at each interpolar location.

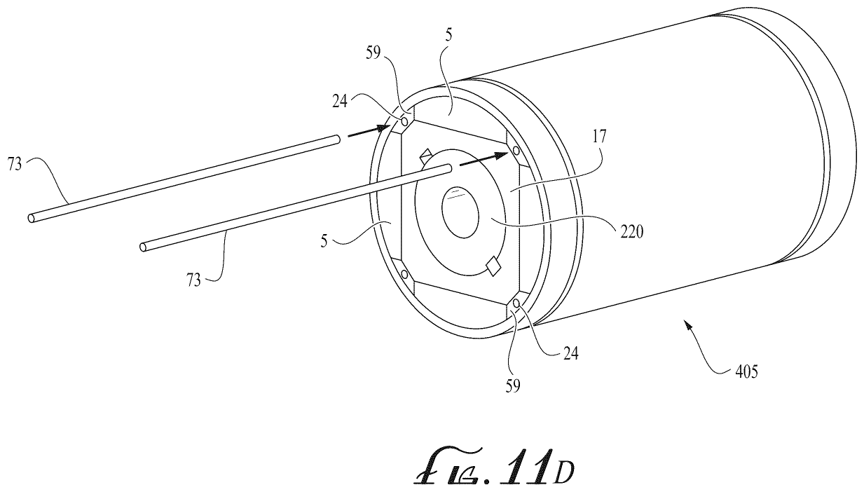

FIGS. 12A-B illustrate another exemplary rotor module 405, which has been configured as a hybrid PMM. Similar to the discussion regarding FIGS. 11A-D, the hybrid rotor module 405 of FIGS. 12A-B has a plurality of channels 24, each extending axially into the active length 61 of the rotor module 405. In embodiments, each channel 24 may extend axially approximately parallel to the axis 63 and/or drive shaft 220. Each channel 24 may be configured to contain/retain a balance mass 73 (e.g. allowing insertion of a balance mass 73 into the corresponding channel 24). In some embodiments, each channel 24 may be disposed in the interpolar space 16 and/or flux barrier 23 (for example, with the channel 24 formed in an insert 59 disposed therein). The plurality of channels 24 can be configured to be disposed around the drive shaft 220 and/or the longitudinal axis 63 of the rotor module 405.

In embodiments, each channel 24 may extend up to half of the overall length of the rotor module 405 (e.g. from ¼ to ½ the overall length of the rotor module), at least half of the active length 61 of the rotor module 405, between half and the entire active length 61, or the entire active length 61 of the rotor module 405 (for example the entire length of the rotor module 405). In some embodiments, one or more channel 24 (e.g. typically a plurality of channels 24) could extend (e.g. axially and/or into the active length) from each end of the rotor module 405, with each such channel 24 extending up to half of the overall length of the rotor module (and if channels from opposite sides/ends are aligned, they may jointly form a single channel with a total channel length no more than the overall length of the rotor module in some embodiments, for example a channel 24 extending the entire length of the rotor module 405). In some embodiments, the channels 24 extending from opposite sides/ends may not be aligned. In some embodiments (see for example FIG. 12C), each channel 24 extending from one of the ends of the rotor module 405 may extend no more than half of the overall length of the rotor module 405, such that there may be a portion of the active length in which the channels 24 do not extend (e.g. a central portion of the active length of the rotor module 405 may not have channels extending therein). In some embodiments, the plurality of channels 24 may be evenly and/or symmetrically spaced around the drive shaft 220 and/or longitudinal axis 63 of the rotor module 405 (e.g. at each end of the rotor module 405), while in other embodiments the channels 24 may not be evenly spaced. For example, the spacing of the plurality of channels 24 may range from 60-120 degrees or 60-90 degrees.

Balance rods 73 (e.g. two balance rods) may be inserted into corresponding channels in the rotor module 405 in order to balance the rotor module 405 (e.g. as discussed below in more detail). In some embodiments, two balance rods 73 can be inserted into two adjacent channels 24 in order to balance the rotor module 405, while other channels 24 of the rotor module 405 may remain empty (e.g. with no balance mass disposed therein). The specific adjacent pair of channels 24 and the amount of balance mass for each may be selected in order to balance the rotor module 405 (e.g. to correct any inherent unbalance in the rotor module 405). For example, disclosed method embodiments may be used in the selection process (e.g. by determining a direction and a mass amount representing unbalance of the rotor module, which may be stated in the form of a vector of unbalance of the rotor module, and then using that to determine which channels to select and the amount of mass to add to each selected channel). In embodiments, the selection process can utilize a balancing machine.

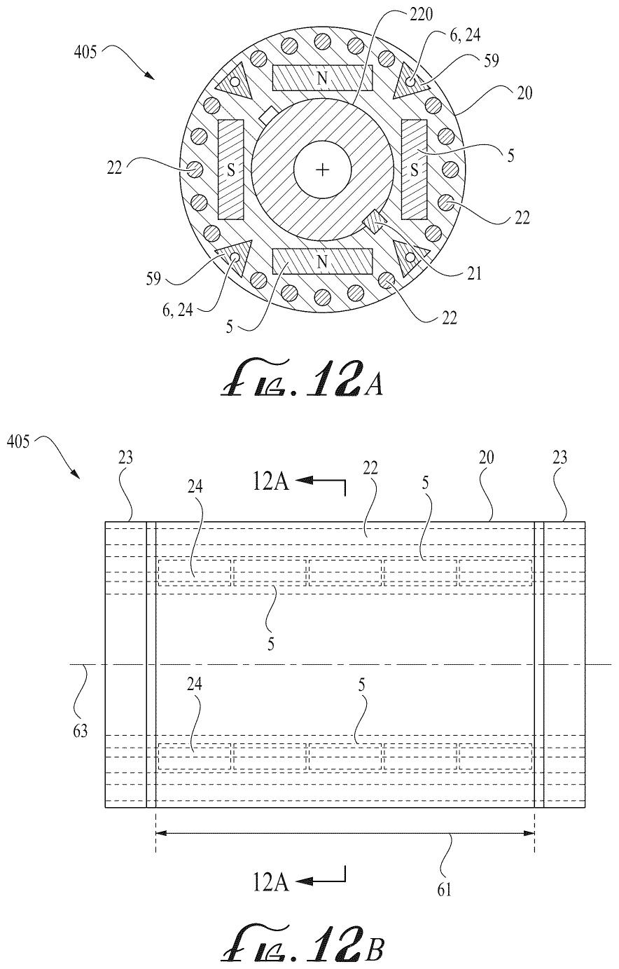

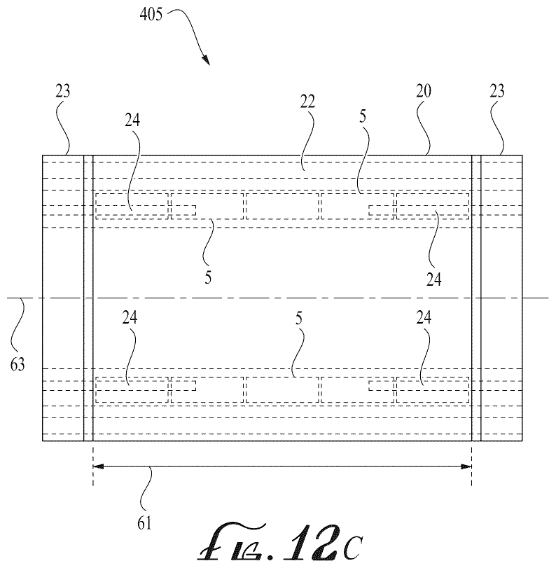

A similar approach (e.g. with channels 24 extending axially into the active length 61 of the rotor module 405) may be used in other types of rotors (e.g. without permanent magnets) as well. In some alternative embodiments where magnets are not used, e.g. a synchronous reluctance motor (e.g. see FIG. 13) or a switch reluctance motor (e.g. see FIG. 14), but which also exhibit pole-based lamination design, a similar approach can be taken to create channels 24 to form balance positions 6 which may be used to balance the rotor module 405 (e.g. by inserting two or more balance masses 73 into corresponding channels 24).

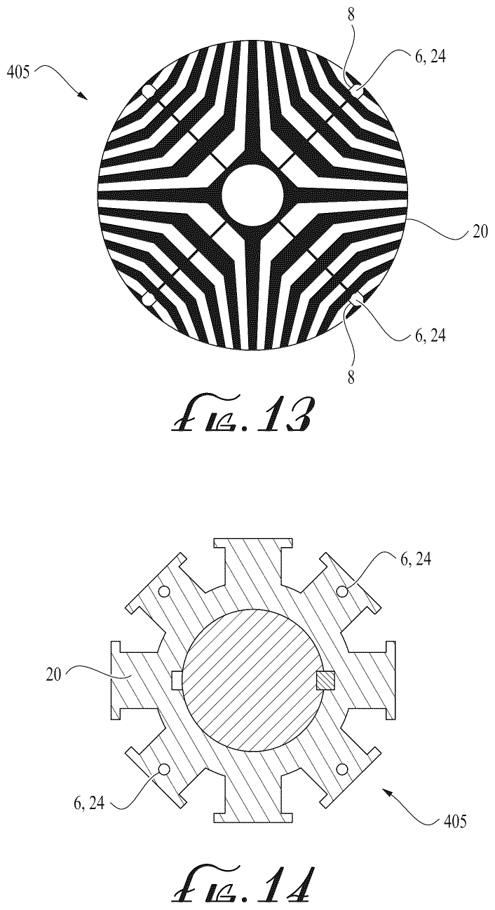

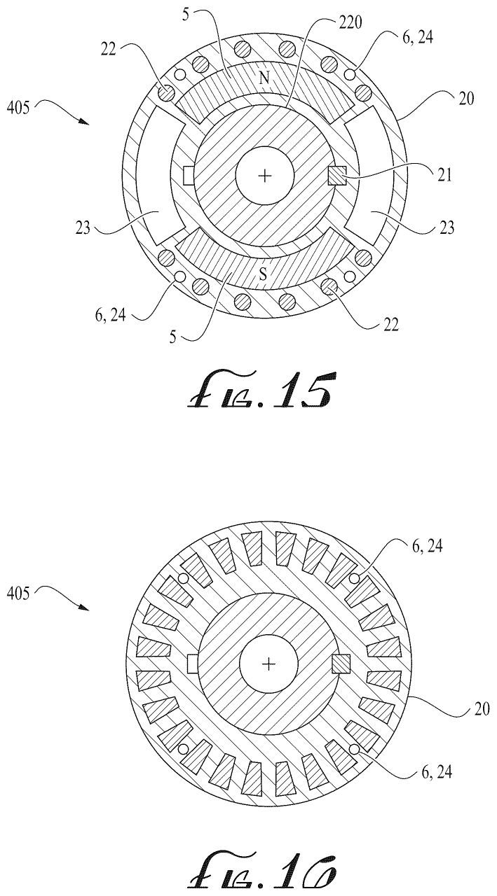

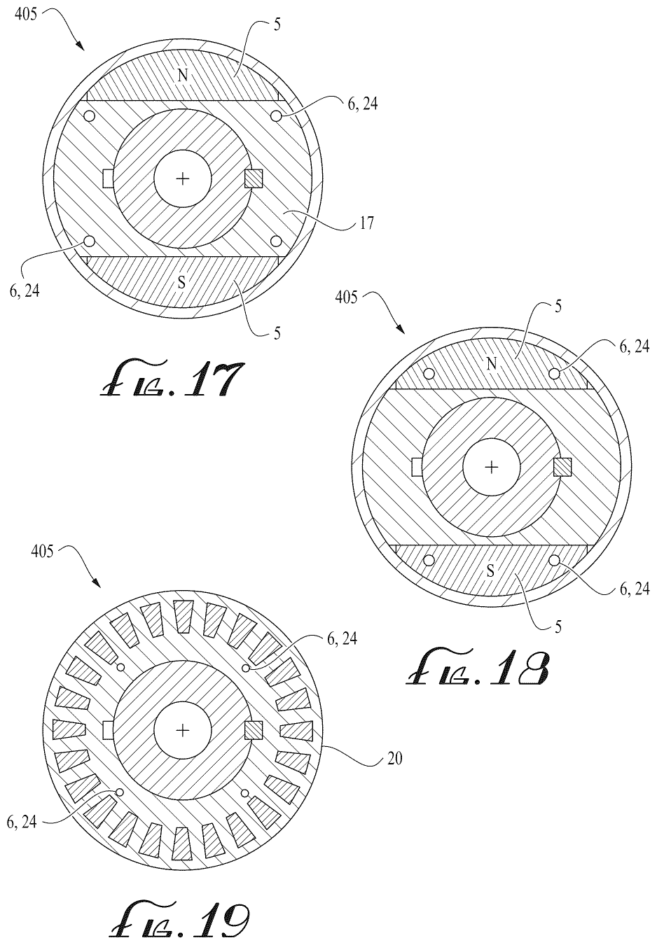

In some embodiments, as shown in FIGS. 15-19, the rotor can be a 2-pole PMM (or other 2 pole configuration) where the interpolar gaps only occur at 180°. This configuration may make the interpolar gaps unsuitable for balancing of the rotor module 405, as it does not offer a way of correcting for any arbitrary angle. To resolve this issue and recreate the four balance positions seen in earlier examples, the through holes (e.g. channels 24 extending axially into the active length 61) may be disposed elsewhere in the rotor module 405. In some embodiments this can be done by adding an additional small hole to the lamination at a suitable angle, e.g. near the interpolar position, that minimizes a reduction in motor performance while meeting the requirements of usability for balancing. In a hybrid rotor PMM, this additional small hole(s) (e.g. channel(s) 24) may be disposed between the rotor bars 22 (see for example FIG. 15). In the induction motor rotor module 405 of FIG. 16, the channels 24 may be disposed between the rotor bars. In other embodiments, such as induction motors, the through holes (e.g. channels 24) can be disposed in the drive shaft 220, in the magnet carrier 17, in the magnets 5, in the lamination stack 20 (e.g. anywhere within the lamination stack), etc., and/or at any interface between component parts (e.g. half of a hole in a magnet and half of a hole in the shaft). FIGS. 15-19 illustrate various exemplary locations for the channels 24 and/or various exemplary types of rotor modules 405 in which channels may be used for this approach.

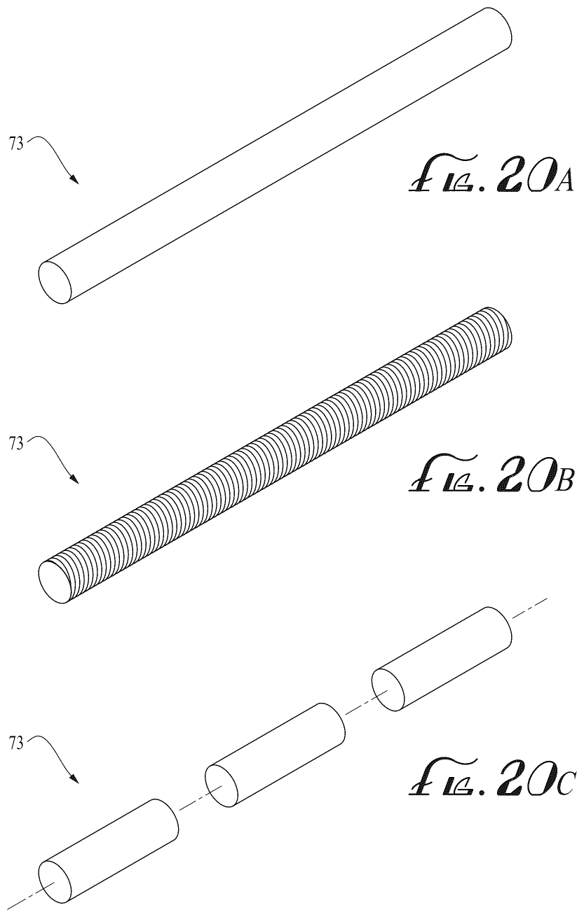

FIGS. 20A-C illustrate exemplary balance mass 73 embodiments. In some embodiments, the balance mass 73 can be of a round form (e.g. a solid rod, having a circular cross-section), as shown for example in FIG. 20A, however other cross-sectional shapes such as triangular, square, c-shaped and polygon are equally acceptable. In some configurations the balance mass 73 can also be threaded (see for example FIG. 20B), for example with threading on some portion of its length corresponding to threading in the channel. Typically, the rod material of the balance mass 73 may be a non-magnetic material, such as a non-magnetic metal (e.g. any suitable metal such as stainless steel, copper, tungsten, titanium, tantalum, etc.), ceramic (e.g. tungsten carbide, alumina, zirconia) or other material. In some embodiments, the rod material of the balance mass 73 may be magnetic if it does not significantly impact motor performance. Typically, the material for the balance mass 73 may be chosen for its density, for example to maximize/optimize the level of mass addition during the balancing process. In some embodiments, the rod of the balance mass 73 can be assembled as a single length, while in other embodiments (e.g. see for example FIG. 20C) the balance mass 73 can be subdivided into multiple shorter lengths which can jointly be built up to meet the overall requirement (e.g. jointly forming the balance mass 73).

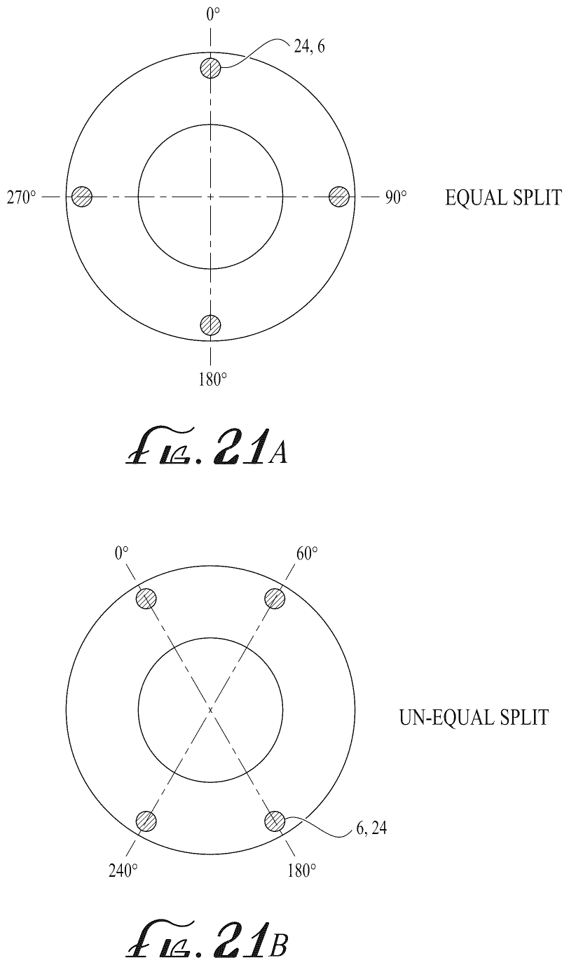

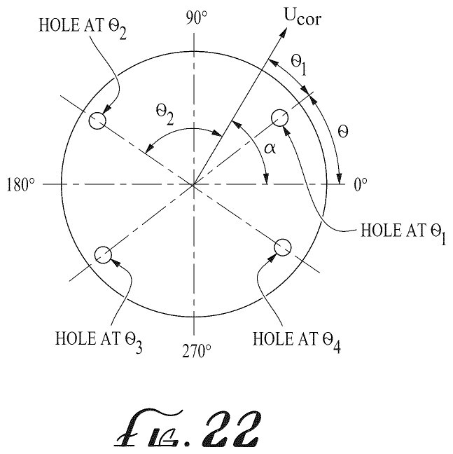

FIGS. 21A-B illustrate exemplary cases of four balance positions 6 (e.g. four channels 24 extending through the entire length of the rotor module 405). In FIG. 21A, the balance positions 6 (e.g. channels 24) can be disposed roughly at 90° intervals (e.g. with the channels 24 spaced around the drive shaft 220 and/or axis 63 of the rotor module 405 by approximately 90 degrees). In other embodiments, the balance positions 6 (e.g. channels 24) may be disposed with an un-equal split, for example with 60 degrees between some adjacent balance positions/channels and 120 degrees between other adjacent balance positions/channels. Four balance positions/channels are often used, for simplicity of balancing calculations, but other numbers of balance positions are permitted (for example 3 balance positions is feasible but less practical, while 5 or more balance positions are mathematically more complex and less practical to use). With four balance positions/channels (e.g. as shown in FIG. 21A), any combination of angle of balance can be created by using 2 adjacent balance positions/channels (e.g. 0° and 90°, or 90° and 180°, or 180° and 270° or 270° and) 0° and then splitting the mass in each hole pair (e.g. pair of adjacent channels 24) to set the vector sum of the correction to have the correct mass and angle between the two-hole pair (e.g.) 90°. In this example, rotating to the next hole pair may just add 90° to the angle of correction. As shown in FIG. 21B, it is not necessary for the spacing of the balance positions/channels to all be regular, and in some embodiments the angle between hole pairs can vary (e.g. 0° and 60°, or 60° and 180°, or 180° and 240° or 240° and 0°, i.e. spacing of 60°, 120°, 60° and 120° respectively). In some embodiments, the spacing of the balance positions/channels may be set for mathematical convenience for mass splitting calculations and/or for practical positioning in the rotor. In some embodiments, it is permitted to have more balance positions to increase capacity, but the calculation for splitting the mass becomes more complex.

Conceptually, the rotor module 405 can still be considered to have a balancing plane at each end, which essentially can correspond to half the rotor module 405 length. For example, each end portion of the rotor module 405 (e.g. up to the midpoint of the axial length) can be considered as acting as a conceptual balance plane. With such a conceptual balance plane at each end, the rotor module 405 can end up with two “halves” that make a whole rotor module length. For each of the halves, the channels 24 and/or balance masses 73 could extend some portion (e.g. from the corresponding end up to the midpoint).

In some embodiments, if the balance mass 73 were to extend more than half of the rotor module length, the portion of the balance mass 73 longer than half of the rotor module length may be counterproductive (e.g. not able to assist in providing balance). Therefore in some embodiments, for each channel 24, the maximum length of rod (e.g. balance mass 73) useable (e.g. per plane) may be half the rotor module 405 length and/or half the active length 61. For example, based on the previous 600 mm module example, the maximum rod length would be 300 mm. For the through hole add mass balance approach, the hardest case to correct may typically be where the unbalance correction angle is aligned to a channel angle (e.g.) 0°. Here, the rod (e.g. balance mass 73) may still be utilized fully, i.e. it is correcting by 100% of its capacity to correct. By adding a second balance rod 73 to the next (e.g. adjacent) balance position (e.g.) 90°, the capacity to balance actually may increase to a maximum of ˜141% of the single balance rod, and therefore the rotor module 405 may become easier to correct. For a balance rod of the same diameter and material as discussed in the 24-hole balance plane example shown previously (e.g. FIG. 7C), the equivalent through hole method may require a balance rod of 230 mm long to achieve the same effect as the 24-hole balance plane. In this example, this leaves approximately 70 mm of further length to correct to a higher unbalance. In other words, the disclosed through hole add mass method may have approximately 30.6% more balance capacity, while not requiring any sacrifice in active length, assuming the same diameter and material. In some embodiments, the geometry may be restricted by other design factors and so this statement may not always hold true. In some embodiments, each balance mass 73 length may extend up to the full length of the rotor module 405, for example based on the specific unbalance of each end or conceptual balancing plane and/or the length of the corresponding channel 24. So for example, each channel 24 may have anywhere from no balance mass therein to a full length balance mass 73 rod disposed therein (e.g. the full length of the channel 24 and/or the full length of the rotor module 405).

In order to determine the amount of mass and/or positioning (e.g. the corresponding channels 24) for each of the two balance masses 73, a mass-splitting calculation may occur. The mass splitting on a four-balance position system can be mathematically straightforward. For example, two balance positions are assumed to be symmetric about an arbitrary 0° line as shown on FIG. 22, such that they are located at ±θ° (i.e. if θ=30°, one hole is at +30°, the second hole is at −30°). The remaining two balance positions are then rotated at ±[180+θ]° (i.e. if θ=30°, one hole is at +150°, the second hole is at −150°). The unbalance correction (U_{COR}) is then located at angle α from the 0° line.

The position of the balance positions/channels can be made relative to the unbalance angle, so that in the positive angle sector (0° to) 180° the first hole at angle θ₁ and second hole at θ₂ lie at:

$${θ}_{1} = θ - α$$

$${θ}_{2} = 180 - θ - α$$

The unbalance split may then be a ratio of U_{COR} calculated where the unbalance in the hole at θ₁ is U₁ and the unbalance in the hole at θ₂ is U₂ as follows:

$${U}_{1} = {U}_{COR} / [ cos {θ}_{1} - \frac{sin {θ}_{1}}{sin {θ}_{2}} \cdot cos {θ}_{2} ]$$

### Note:

If sin θ₂=0, then U₁=0 and U₂=U_{COR}
If U₁<0 then the mass is −U₁ and is moved 180° to the third hole at θ₃
If U₂<0 then the mass is −U₂ and is moved 180° to the fourth hole at θ₄

To derive a mass (m) from the unbalance we can divide U₁ and U₂ by the plane radius:

$${m}_{1} = {U}_{1} / r$$

$${m}_{2} = {U}_{2} / r$$

If the rod cross-section is constant, then the mass (m) is proportional to the length (L) and can be directly calculated by dividing through by the mass per unit length. Therefore U can be substituted with m or L depending on the input type (unbalance, mass or length) to the calculation, e.g. for length:

$${L}_{1} = {L}_{COR} / [ cos {θ}_{1} - \frac{sin {θ}_{1}}{sin {θ}_{2}} \cdot cos {θ}_{2} ]$$

$${L}_{2} = - {L}_{1} \cdot \frac{sin {θ}_{1}}{sin {θ}_{2}}$$

A similar substitution can be used for any other quantity based system, for example the number of short sections of rod, or number of dowels, or screw to be added to the balance position. This relies on the trial weight to be also based on a number of said quantity (e.g. 2× screws).

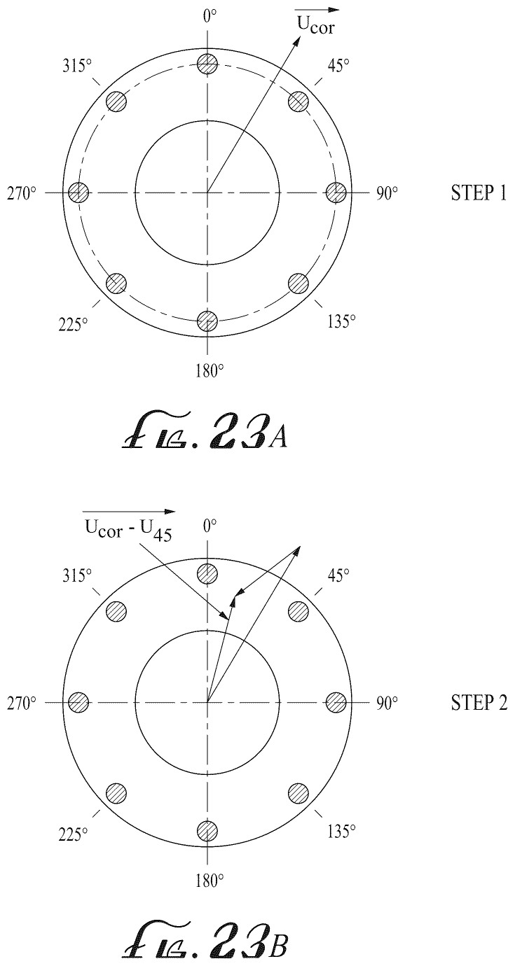

For higher pole counts (e.g. 8-pole), the equations are still valid, however the process becomes multi-stepped. The calculation can orient the balance positions so that the unbalance angle lies between the first pair of balance positions, for example the hole at 0° and 45° on FIGS. 23A-B. The balance positions at 0°, 45°, 180° and 225° become analogous to the balance positions in FIG. 22, where θ=22.5°, and the results are corrected for the angle difference (i.e. −θ=−22.5°). The calculation can then be used to calculate the lengths for step 1. If a mass required exceeds the maximum allowable capacity of the balance position (i.e. filled to the maximum length) the process may be repeated in a step 2. Here for example the mass in the hole at 45° is assumed at maximum length and has an unbalance effect U₄₅. The residual unbalance effect for this step can be calculated by deducting off U₄₅ from U_{COR}, noting this is a vector subtraction to get both magnitude and angle. In this example the balance positions are now at 0°, 90°, 180° and 270° per FIGS. 23A-B, and once again become analogous to the balance positions in FIG. 22, where θ=45°. The results of the calculation are then corrected for the angle difference (i.e. −θ=−45°). In this manner, the calculation can repeat to determine what the split weights need to be, as either further balance positions become fully occupied or the desired correction is achieved.

The method of correction can include determining the required correction (e.g. the amount of mass and direction to correct the unbalance, which might be termed a correction vector). In embodiments, the method above may work to determine the unbalance correction in a single pass. For example, this may use a trial weight method consisting of three runs, operating at the same speed on the balancing machine (or similar) as follows:
Run 1—Measure the rotors underlying unbalance (magnitude and phase angle) at both planes;
Run 2—Add a trial weight at the first balance position on plane 1 and then measure the rotors unbalance (magnitude and phase angle) at both planes; and
Run 3—Move trial weight to second balance position on plane 2 and then measure the rotors unbalance (magnitude and phase angle) at both planes.

A software based mathematical conversion can be used to then calculate the required unbalance correction directly. Beneficially, this process can typically achieve the desired correction on the first pass, ensuring the correct mass/length/unbalance is added to the plane on the first pass. This reduces what is potentially a complex balance process of a rotor module to a simple, quick, relatively unskilled process. If the tolerance is not achieved, the trial weight process can be repeated to get the rotor in to balance.

In some embodiments, the balancing machine may determine correction vectors for each end of the rotor module. For simplicity, these two vectors can be combined to form an overall correction vector (e.g. for the rotor module as a whole) in some embodiments. Once the overall vector of correction is determined, the vector of correction (e.g. unbalance correction vector) can be split into two (or more) split vectors that would sum back up to be the same as the unbalance correction vector. The split vector then can describe the weight to be inserted into each selected channel (e.g. based on the vector magnitude), noting that the angle part of the vector can correspond to the channel angles. For example, the channels may be selected so that the vector of correction extends between the selected channels. Some balance machines may be configured to do more than simply determine the underlying unbalance of the rotor module and/or the vector of correction, and may actually provide the vector splits directly.

Although a balancing machine has been described as an exemplary means of determining the underlying unbalance of the rotor module, alternative approaches may be used instead in some embodiments. In embodiments, any equivalent method or device that would give an indication of the underlying unbalance and/or the vector of correction would suffice. An example of such an alternate approach would be a set of vibration sensors, for example proximate to end/plane 1 and end/plane 2 of the rotor module. Such vibration sensors could be used with a once per revolution timing signal, which can then allow measurement of magnitude and phase of the vibration. In embodiments, the resulting “vibration vector” may be used in place of the unbalance vector (e.g. noting that the vibration vector can be the unbalance vector times a unit conversion factor). For example, a velocity style vibration sensor can be used. In embodiments, the results of the vibration sensor(s) can be converted back to velocity, and may indirectly allow the same thing to be achieved without the balance machine.

To hold the weight/mass (e.g. balance mass 73) in position, the weight needs to be prevented from moving. For example, this can be done by peening (e.g. denting) the channel 24, for example at each end of the added weight (e.g. balance mass 73), to prevent axial movement. In other embodiments the weight (e.g. balance mass 73) can be bent to increase the insertion force or prevent a part of the weight entering the channel 24. In other embodiments an additional part can be added to stop the weight moving.

Reducing unbalance, and thus the motor's vibration, can improve the run life of a downhole motor (or any other rotating equipment). The method and system for using balance masses extending into the active length of the rotor module 405 can provide a rapid and practical approach to reduce the unbalance of the rotor to a low level (e.g. ensuring that motor vibration meets ISO/API standards). This also can have benefits to the bearings of the rotor, which can operate better due to lower dynamic loads. Similarly, low rotor vibration can reduce the exciting forces that can reduce the magnitude of vibration where a rotor passes through a resonant mode, thus improving a machine's ability to operate at increasingly high speeds (e.g. 10000 rpm). Further, by maximizing the active length of the motor, the power factor and efficiency of the motor may be maximized. Additionally, rotor module balance can be achieved quickly using disclosed embodiments, for example typically achieving a low unbalance on the first pass, which may reduce the time to balance and hence reduce labor cost. These and other benefits may be provided by disclosed embodiments.

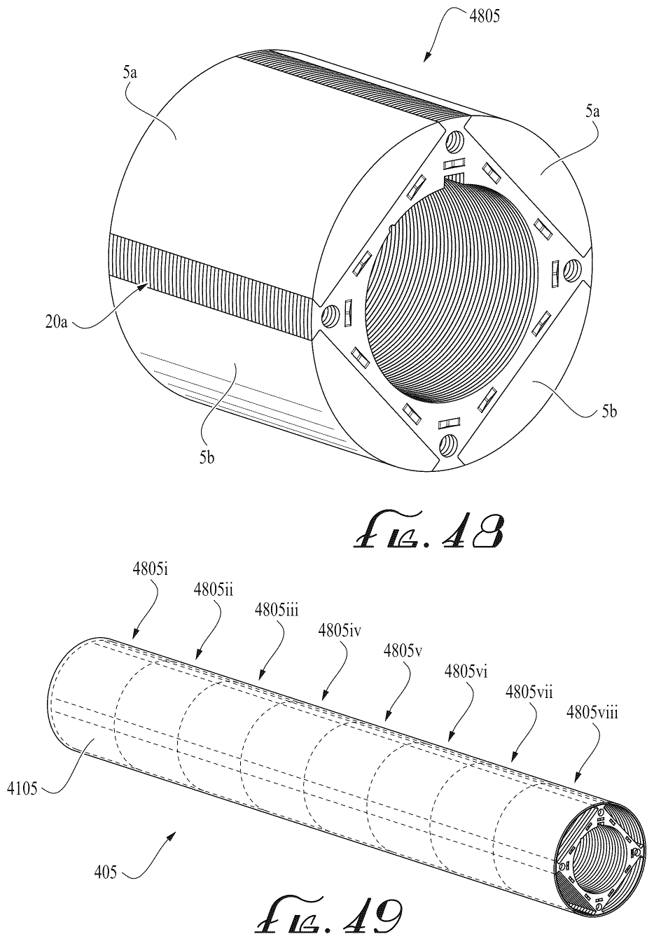

FIGS. 24-56 illustrate additional rotor module embodiments, which may simplify assembly/construction and/or reduce costs. In some embodiments, these alternate rotor module embodiments may be specifically configured for rotor balancing, for example using the approach set forth above with respect to FIGS. 1-23B. The construction approach for such exemplary rotor modules may differ from other rotor module embodiments and may provide a simple and effective way to form a rotor (e.g. by disposing a plurality of rotor modules onto drive shaft). Additionally, rotor assemblies may be retrofit with one or more such rotor module (e.g. with one or more such rotor module embodiment replacing a pre-existing rotor module of a different type).

While motors, such as used in an ESP, may be induction type or permanent type, there may be drawbacks to some induction motors in some instances. As previously noted, the motor is a key part of an ESP system and can comprise a stator and a rotor. In the vast majority of currently available systems, the rotor modules are of induction type. These are typically fabricated using a stack of laminations with openings at their periphery that contain bars made typically of copper or aluminum (e.g. configured for induction when powered). These are typically inserted into the lamination stack and brazed to a pair of end rings one at each end. The circuit formed by such conductor arrangement can allow induced current to be created from the electric current supply in the stator. It is that interaction between the induced current in the rotor bars and the current in the stator phases that create the torque that drives the load in induction motors.

One drawback of such induction motor operation can be the additional losses and poor power factor due to the nature of the magnetization therein. For example, part of the current supplied to the motor stator is used to magnetize the rotor and provide a field in the airgap, and thus would not create useful torque. Accordingly, there can be benefit in using permanent magnet motors. For example, in permanent magnet motors where the magnetic field is permanently present and provided by the permanent magnets used in their rotors, all of the electric current supplied to the stator phases can be used to generate useful torque. For this fundamental reason, permanent magnet motors typically are more compact and far more efficient than induction motors.

As previously noted, the rotor generally can consist of a long shaft, with individual rotor modules disposed thereon and radial journal bearings located therebetween. In an induction rotor, the rotor module lamination stacks are typically secured by the copper bars (as discussed above). In permanent magnet rotors, however, since these copper bars for induction are typically not present (e.g. except in the case of a hybrid rotor where both magnets and rotor bars are present), any laminations would typically be secured by other means.

Permanent magnet rotors often have increased cost over induction rotors, for example due to the cost of rare earth magnets and more complex assembly costs. Disclosed rotor module embodiments may address these and other issues with permanent magnet rotors, for example using new permanent magnet rotor configurations and/or ways to assemble such rotor modules (for example in order to minimize the cost of a permanent rotor module). In embodiments, the proposed rotor module designs can utilize some concept of an induction rotor (e.g. a lamination stack), and combine this with the permanent magnets (e.g. no copper bars and/or cage). The figures illustrate two exemplary types of permanent magnet rotor modules, as discussed in more detail below: internal permanent magnet (IPM) and surface mount permanent magnet (SMPM). While there are certain differences between these two proposed magnet assembly methods, the end goal for both may be increased motor capacity and improved efficiency, for example at a competitive production cost.

Benefits of disclosed embodiments may include lower manufacturing cost and complexity. The methods of manufacturing and assembly of the disclosed permanent magnet rotors may rely on using thin electrical steel (e.g. magnetically permeable) laminates (e.g. shaped sheets), stacked into lamination stacks producing a core or carrier (e.g. configured to hold/carry the magnets). This can be beneficial since introducing a single piece carrier for the magnets may often pose manufacturing challenges and/or may introduce additional cost. Once the carrier/core has been constructed, the magnets can then be installed into closed or open pockets in the lamination stack (e.g. closed/internal pockets for IPM and open pockets/external grooves for SMPM). A variety of simple and economical ways of securing the lamination stack and magnets in place can yield a cost effective finished permanent magnet rotor module. Additionally, disclosed embodiments may provide increased power per unit of length. For example, by using permanent magnet rotors instead of induction rotors, the power of a submersible electric motor with the same stator configuration could be increased by up to 50%.

Further, disclosed embodiments may provide higher efficiency, thus lowering running cost. Due to the complete supplied current usage inside the permanent magnet motor, these motors can be more efficient than an induction motor, for example reaching 92-93% efficiency and/or a power factor (PF) close to unity. Due to the combination of induction rotor design elements (e.g. lamination stacks) and permanent magnets, a cost effective and uprated rotor module design can be achieved. Disclosed permanent rotor module configurations and their proposed assembly methods may also improve production processes. In embodiments, disclosed rotor modules can also be used to retrofit rotor modules from existing induction and permanent magnet motors and/or such disclosed techniques can be used in a hybrid rotor approach (e.g. using elements of disclosed permanent magnet rotor module in conjunction with induction rotor elements, such as cage bars).

By way of example, a rotor module embodiment (e.g. configured to be concentrically disposed on a drive shaft (e.g. for an ESP motor)) can comprise: a plurality of laminations, each configured to be concentrically disposed on the drive shaft; a plurality of magnets (e.g. half south polarity and half north polarity); and two end rings. In embodiments, the plurality of laminations can be axially stacked to form a carrier (e.g. core) having a plurality of axially-extending pockets, each configured to retain/receive one or more of the plurality of magnets; and the carrier, magnets, and end rings can be secured into a unitary rotor module without threading (for example using permanent deformation (e.g. of another element, such as retaining strips or a retaining sleeve, as discussed in more detail below)). FIGS. 24-56 illustrate exemplary embodiments in more detail.

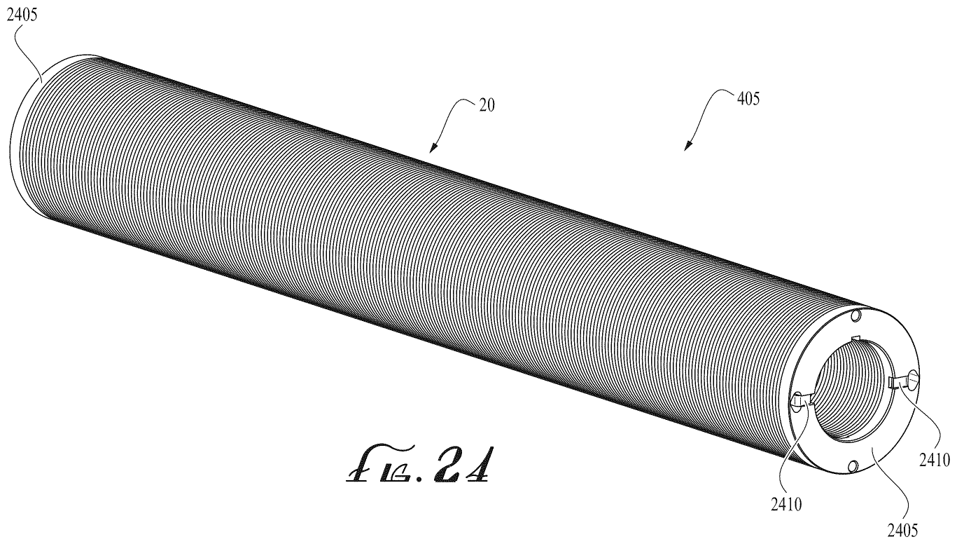

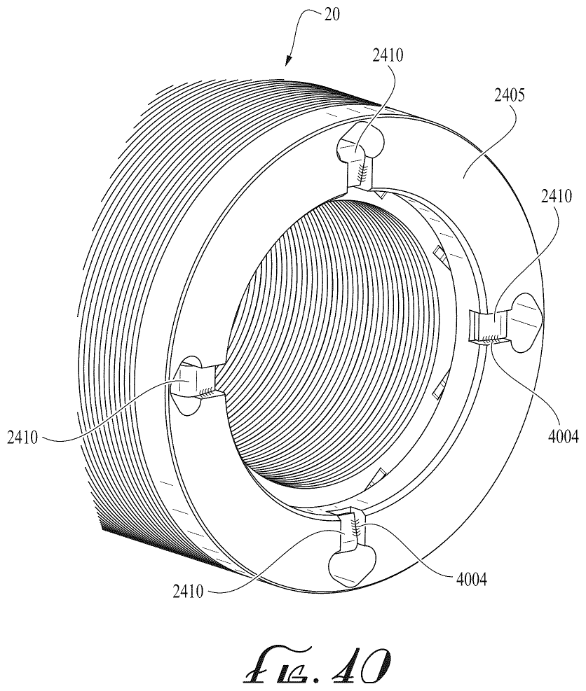

FIGS. 24-25 illustrate an exemplary rotor module 405, which may be characterized as an internal permanent magnet (IPM) rotor module (e.g. with the magnets mounted inside pockets within the carrier). The disclosed rotor module 405 embodiment typically comprises a carrier/core (e.g. a lamination stack) 20, which may in some embodiments comprise a plurality laminations 3900 (e.g. as shown in FIG. 39A, for example with each lamination 3900 comprising a thin stamped steel sheet, which may be magnetically permeable), a plurality of permanent magnets 5a (South polarity) and 5b (North polarity) (e.g. which may be disposed within pockets extending axially in the carrier 20), and end rings 2405 at each end of the rotor module 405 and/or carrier (e.g. lamination stack) 20. The end rings 2405 may be configured so that, when attached to the ends of the carrier 20, the magnets 5a, 5b are held/secured within the carrier 20 (e.g. within the pockets). A plurality of pockets of the carrier 20 are typically disposed around the longitudinal axis (for example evenly spaced around the axis and/or shaft, as discussed in more detail below). Pockets in the carrier 20 typically extend approximately the axial length of the carrier 20, and typically all magnets in each axially-extending pocket may have the same polarity (e.g. all magnets that are aligned axially within a pocket may have the same polarity).

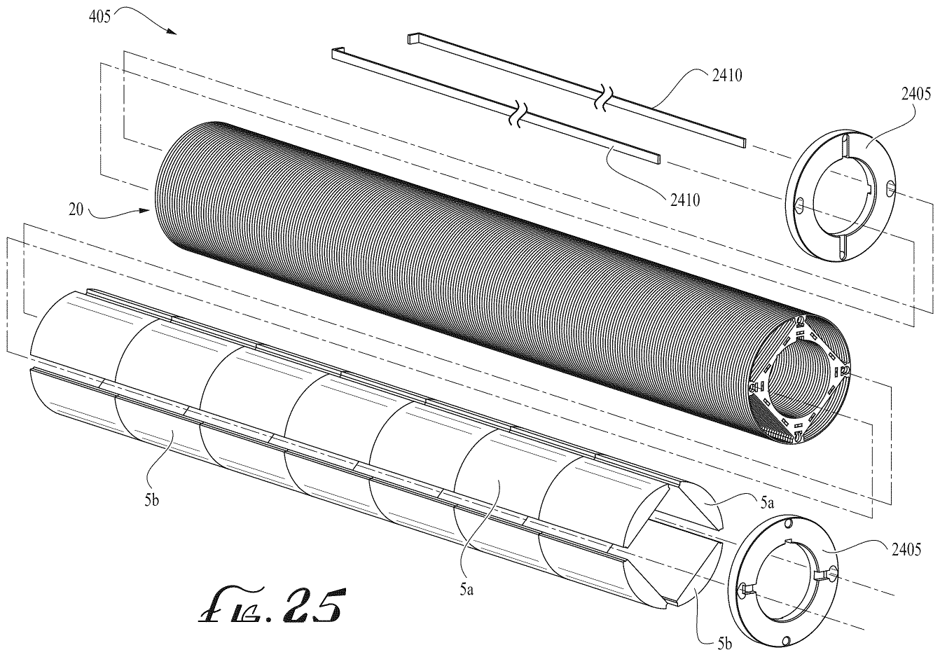

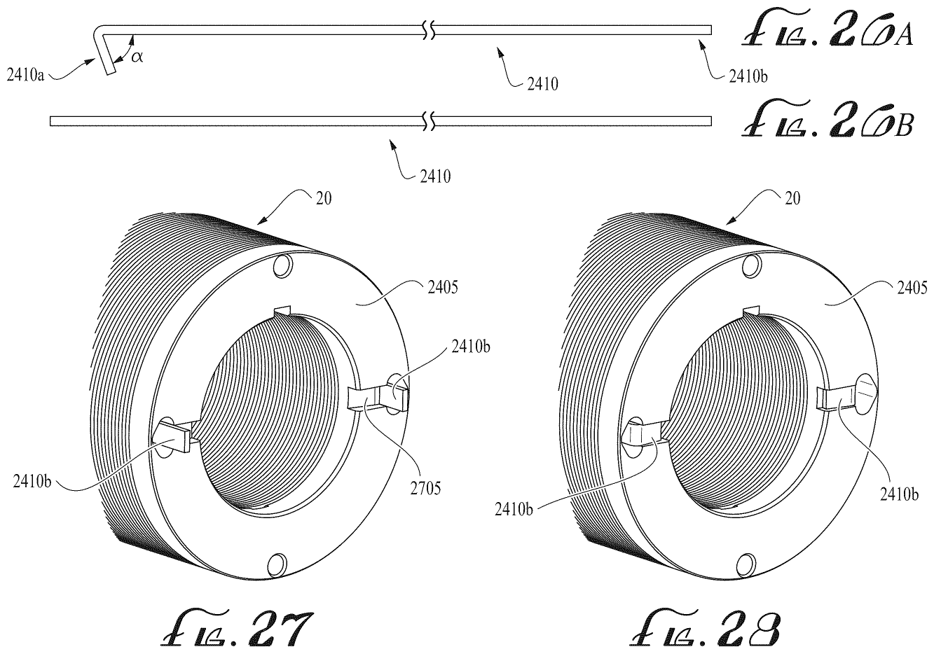

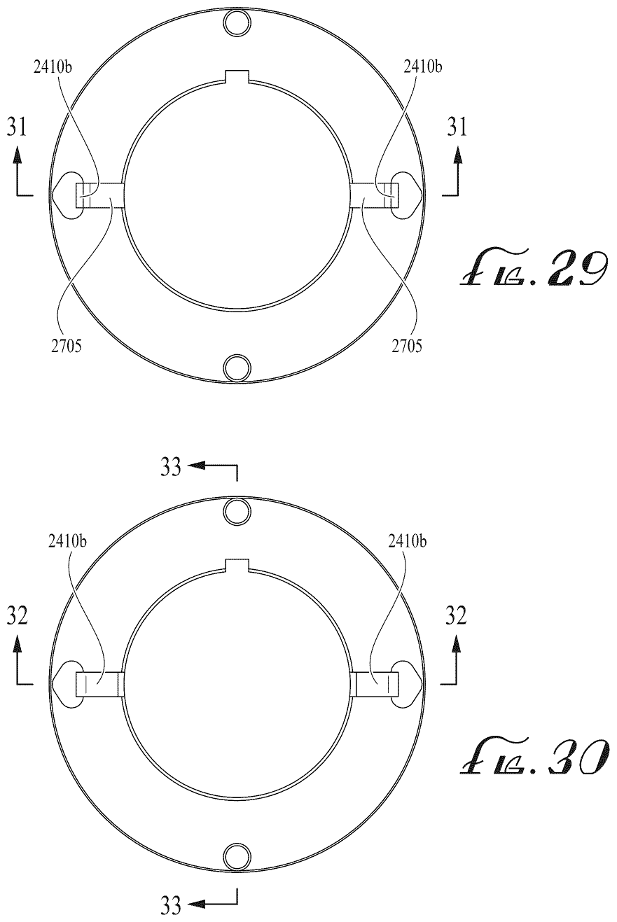

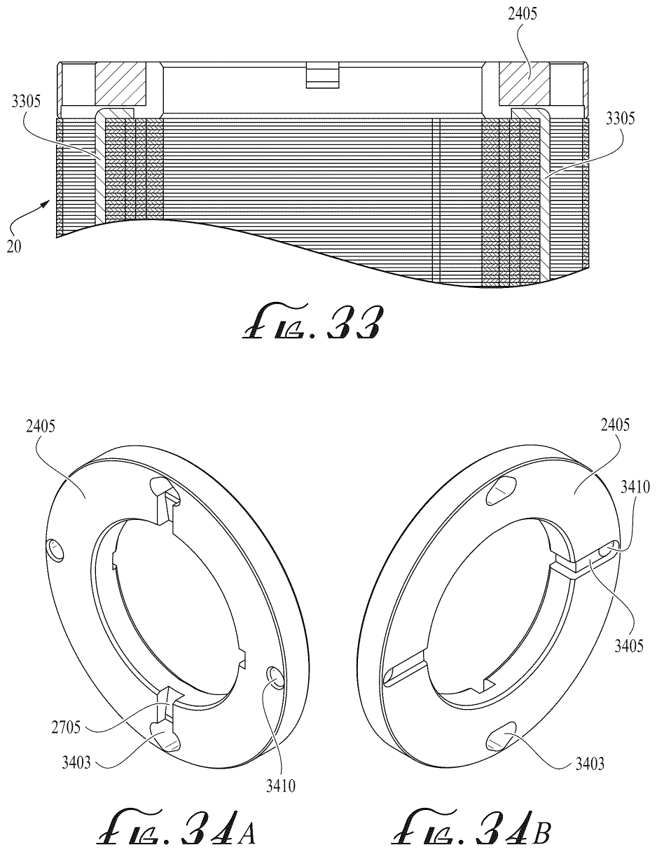

In this embodiment, the method of securing the end rings 2405 to the carrier 20 can be by means of formed (e.g. rectangular in this figure) retaining strips 2410 (e.g. typically of steel). The retaining strips can also be termed staples. In FIG. 24, two of these retaining strips 2410 can be inserted through one of the end rings 2405 (e.g. through corresponding holes in the end ring), through slots 3901 in the lamination stack (e.g. see FIG. 39, with the slot openings in each lamination jointly forming the slots extending axially through the carrier 20) of the compressed carrier/core 20 from one end until a set length of the retaining strip 2410 protrudes from the other end ring 2405 (e.g. through corresponding openings/holes in the end ring) on the opposite end of the rotor module 405 and/or carrier 20, for example as shown in FIG. 27 and in cross-section in FIG. 29. In some embodiments, one end 2410a of the strip 2410 can be pre-bent into shape, for example as shown in FIG. 26A (although as shown in FIG. 26B, in other embodiments both ends may initially be unbent, for example being bent only after insertion of the strip 2410 into the carrier 20). The angle α can be predefined/preset, for example depending on the method of assembly. By way of example, the angle α can range from approximately 90° to approximately 60° (e.g. approximately 90-70 degrees, approximately 80-60 degrees, approximately 80-70 degrees, or approximately 90-80 degrees), and this angle may match the profiled recess or exterior face of the end ring 2405 (see for example FIG. 32). In some embodiments the angle α is defined as 80° or 90°. In embodiments with a pre-bent end, the retaining strips can be inserted with straight end through openings in the end rings and slots 3901 until the pre-bent end contacts an end ring and/or until a pre-defined length of the retaining strip extends/protrudes from the opposite end ring. Once the retaining strips 2410 are in position (e.g. extending through both end rings 2405 and the carrier 20), the straight end 2410b of the steel strip 2410 can be bent into shape to retain the end ring 2405 onto the carrier, for example with the bent end 2410b disposed inside a recess 2705 in the end ring 2405. See for example, FIGS. 27, 29, and 31 illustrating the straight end of the strip 2410, and FIGS. 28, 30, and 32 illustrating the bent end of the strip 2410. In embodiments in which the retaining strip 2410 has two straight ends initially, both ends can be bent to fix the end rings 2405 onto the axial ends of the carrier 20.

In some embodiments, the retaining strips 2410 can comprise magnetic spring steel. While non-magnetic steel may be used in some embodiments, magnetic steel may be preferred over non-magnetic steel for its electromagnetic properties in the assembly. In embodiments, the end rings 2405 may comprise a material with low magnetic permeability, such as austenitic stainless steel (e.g. 300 series stainless steel), for example to ensure it does not affect the electromagnetic properties of the rotor assembly. Alternate materials for the end rings 2405 can include nickel alloys (such as Inconel), which also may have a low magnetic permeability. To maintain its shape and act as a compression spring, the strip 2410 material may comprise spring steel in some embodiments (e.g. specially heat-treated magnetic steel). After compression tooling is removed from the carrier 20, the lamination stack/carrier 20 can tend to relax (e.g. spring-back), and its length can grow. However, such expansion/relaxation can be counteracted by the retaining strips 2410, which can act as compression springs in some embodiments. In the embodiment shown in FIGS. 25 and 26, the retaining strip 2410 can be rectangular (e.g. a flat, elongate rectangular strip, for example of rectangular cross-section), but other shapes of strips 2410 may be used (for example, in alternate embodiments the strips 2410 may have a cross-section that is square, round, oval, triangular, hexagonal, or of another shape).

In some embodiments, the laminations 3900 are stacked into a carrier 20, and may be retained together prior to having the end rings 2405 secured to the ends of the carrier 20 by clinches (as discussed below). In other embodiments, the lamination stack forming the carrier 20 may be secured together as a unitary structure prior to the addition of the end rings 2405 and/or the use of retaining strips 2410. For example, in some embodiments, another set of strips (e.g. carrier strips) may be used to hold the laminations together as a stack.

FIG. 33 illustrates a cross-section through an exemplary rotor module 405, and in this embodiment a second set of steel strips (e.g. two or more carrier strips) 3305 can extend through corresponding slots (such as 3901) in the carrier 20. In this embodiment, the carrier strips 3305 can be used to secure the carrier (e.g. lamination stack) 20 before the end rings 2405 and the magnets 5a and 5b are installed. In function and/or features, the carrier strips 3305 may be similar to the retaining strips 2410 described above, but the carrier strips 3305 may only secure the lamination stack or carrier 20 into a unitary element (e.g. not pass through the end rings). In some embodiments, carrier strips 3305 and retaining strips 2410 may be disposed in different slots 3901 in the lamination stack/carrier 20. For example, in some embodiments the lamination stack/carrier 20 may have four slots 3901, and two carrier strips 3305 may pass through two of the four slots 3901 (e.g. one carrier strip in each corresponding carrier slot), while two retaining strips 2410 may pass through two other of the four slots 3901 (e.g. one retaining strip in each corresponding retaining slot). In other embodiments, it may be possible for carrier strips 3305 and retaining strips 2410 to pass through (e.g. share) the same slot 3901.

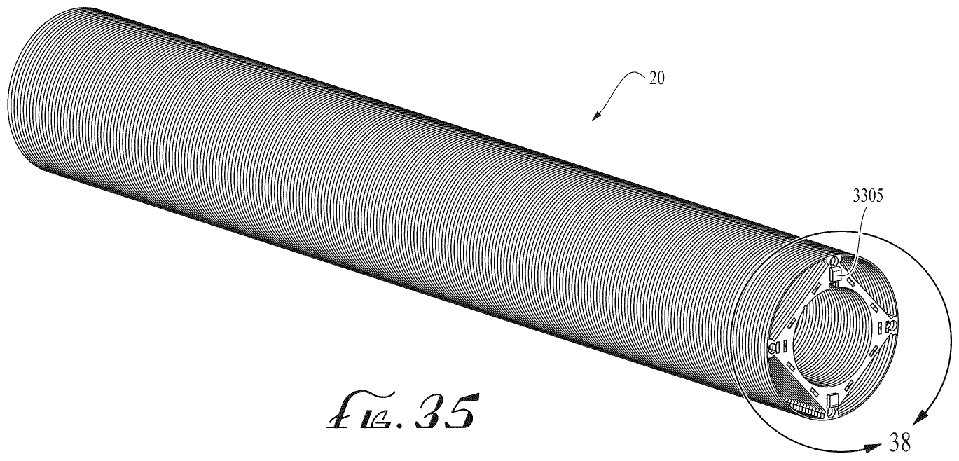

FIGS. 34A-B illustrate an exemplary end ring 2405. The end rings 2405 can have openings/holes 3403 allowing passage therethrough of the corresponding retaining strip 2410, for example so that the retaining strips 2410 can hold the end rings 2405 onto the ends of the carrier 20. Typically, the end rings 2405 each have a borehole (e.g. centralized), which can be aligned with the bore of the carrier 20 to allow for mounting of the rotor module 405 onto the shaft. The end rings 2405 can be sized and shaped so that, when attached to the ends of the carrier 20, the action of the retaining strips 2410 on the end rings 2405 (e.g. holding the end rings in place axially) can also act (e.g. via interference) on the carrier 20 (e.g. allowing the retaining strips 2410 to clamp the carrier 20 axially between the two end rings 2405).

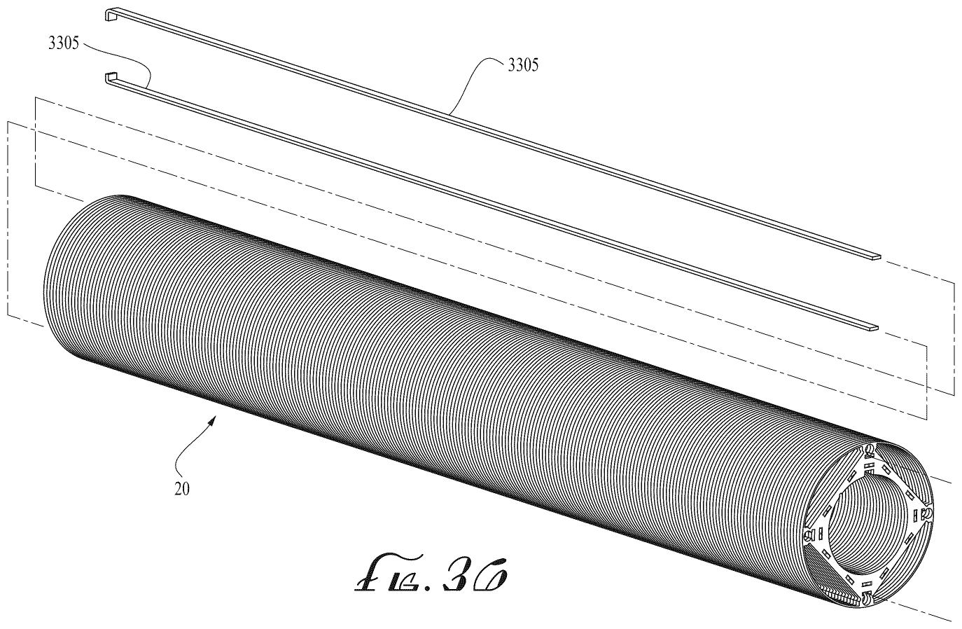

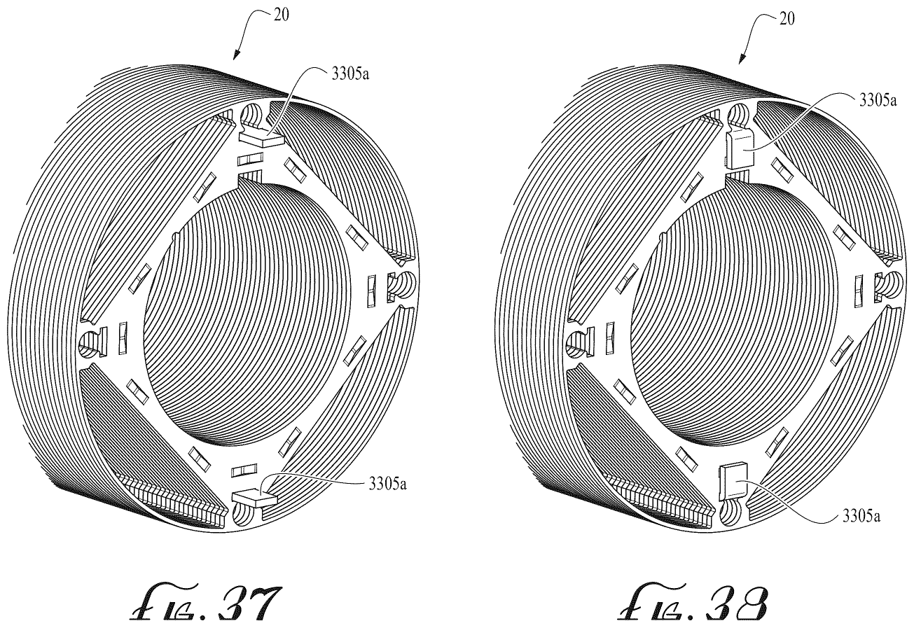

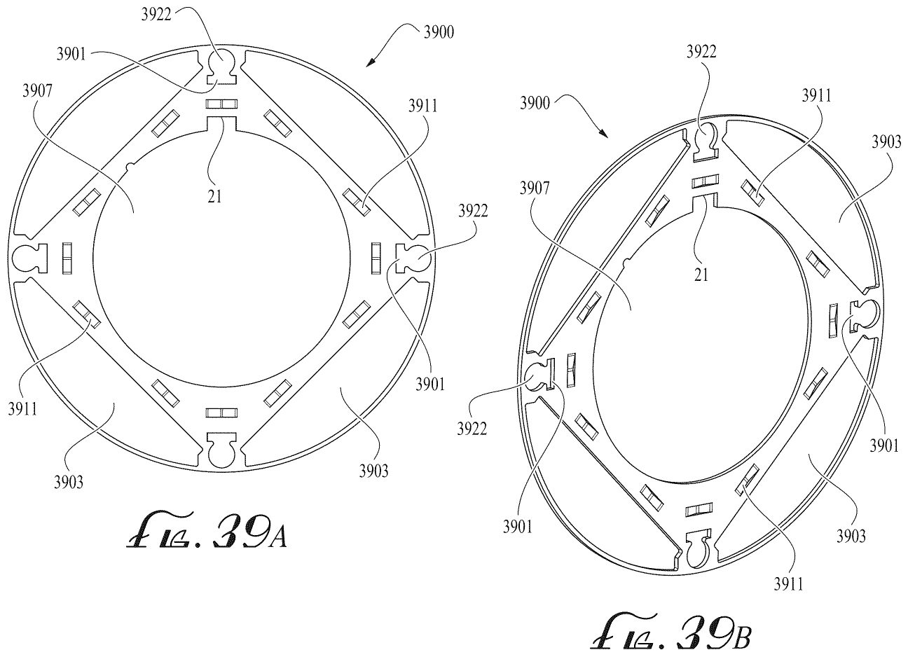

FIG. 35 and FIG. 36 depict a carrier 20 built from the individual laminations (e.g. such as 3900, as in FIG. 39) and two (e.g. optional) carrier strips 3305. The process of assembly using the carrier strips 3305 may be similar to the one for the retaining strips 2410 described above. For example, FIG. 37 shows the straight end 3305a of the carrier strip 3305 protruding from an end of the carrier 20 (e.g. after the carrier strips have been inserted though the carrier), and FIG. 38 illustrates the formed/bent ends 3305a of the carrier strip 3305 (e.g. permanently deformed to retain the laminations 3900 of the carrier 20 together). Returning to FIG. 34B, two recess 3405 can be present on the side of the end ring 2405 facing the carrier 20 (e.g. the interior surface of the end ring 2405). These recesses 3405 can provide the required clearance for the carrier strips 3305 after they are bent into shape (e.g. ensuring that the end rings 2405 can fit flush with the corresponding end of the carrier 20, despite the presence of the carrier strips folded ends). On the exterior surface of the end rings 2405, as shown in FIG. 34A, two recesses 2705 may be present (e.g. to receive the bent ends of the retaining strips 2410) (and this approach may be used for both the embodiments shown in FIGS. 24 and 33).

An end view of an exemplary IPM lamination 3900 is illustrated in FIG. 39A. Due to its manufacturing procedure (e.g. stamping from sheet metal), the individual thin lamination 3900 may incorporate one or more of a variety of features, such as: magnet pockets 3903 (which when the laminations are stacked, can be configured to extend axially in the carrier and to hold the magnets), the slots 3901 (which as described above, when the laminations are stacked, can extend axially through the carrier to allow for insertion of the strips), the shaft bore 3907 (which when laminations are stacked, can be configured for passage of the drive shaft), the balance mass hole(s) 3922 (which when laminations are stacked, can form balance mass channel(s) to allow for axial insertion of balance rods in some embodiments, for balancing of the rotor module, for example with the balance rod(s) extending axially into the active length of the rotor module (e.g. the portion with magnets)), and/or the keyway or key 21 (e.g. configured so that when the carrier is mounted on the drive shaft, the rotor module and the drive shaft rotate together and/or are rotationally coupled, for example configured to mate with a corresponding component on the shaft to rotationally fix the elements to rotate together).

When a plurality of such laminations 3900 are stacked together to form the carrier 20, the individual laminations 3900 can in some embodiments be held together via a method called clinching. For this purpose, a series of indentations called clinches 3911 may be present in the lamination 3900, which can interlock into each other when the laminations 3900 are stacked and compressed (e.g. to provide a method of retention and stability to the carrier 20, for example prior to full assembly with the magnets and/or retaining strips). Although this method can be useful for holding the carrier 20 together during production of the rotor module 405, it may not prevent laminations 3900 of the stack from separating, for example in the event that an external bending load is applied to the carrier 20. For this reason, there may be a need for the additional securing method proposed using carrier strips 3305 and/or retaining strips 2410. Although typically the carrier strips 3305 may be rectangular, in alternate embodiments the carrier strips 3305 can be of a round, square, hexagonal, or other cross-sectional shape. Similarly, slots of another shape (e.g. corresponding to the shape of the strips) can replace the rectangular slots 3901 in the exemplary lamination 3900. In some embodiments, the balance holes may be radially outward of a corresponding slot and/or may be open to the corresponding slot (e.g. with the balance hole and the corresponding slot linked into a single opening, as shown in FIG. 39A).

An advantage of this method of securing the rotor module 405 may be the low manufacturing cost of the components. In embodiments, an assembly support mandrel can be used through the assembly and balancing process of the rotor module 405 (e.g. with the carrier 20 being disposed on the mandrel). For example, the laminations 3900 can be stacked onto the mandrel during assembly, which may provide some support during assembly. The rotor module 405 can be removed from the mandrel once the strips (e.g. 2410 and/or 3305) are in place and the rotor balanced.

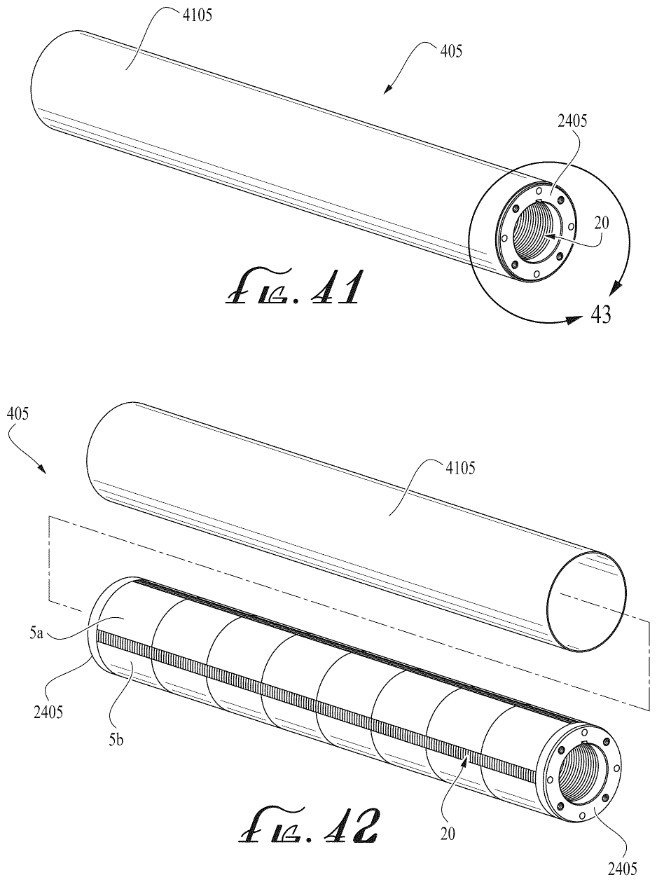

In an alternate configuration, four retaining strips 2410 can be inserted through both end rings 2405 and the slots 3901 in the carrier 20 (see for example, FIG. 40). Persons of skill will understand that any number of slots and retaining strips 2410 can be used. Typically, such slots and/or retaining strips 2410 may be evenly spaced around the longitudinal axis (e.g. symmetrically disposed around the laminations 3900). In embodiments, one end of the strip 2410 can pre-bent to shape (e.g. in this case a right angle). The opposite end of the strip 2410 can be bent into shape in the recess in the end ring 2405 on the opposite end (e.g. in this case a right angle). In some embodiments, welding, such as tack welding or fillet welding, of the strips 2410 inside the recess 2705 in the end ring 2405 can be performed (e.g. with the weld 4004 also disposed within the recess 2705 (e.g. entirely within the recess)). In some embodiments, the retaining strips 2410 can be spot welded in one or two locations per strip end. Adding such welds can enhance stability and strength of the rotor module and/or prevent the strips from becoming un-bent and/or removed during usage of the rotor module. In embodiments, this process can minimize spring back on the lamination stack/carrier 20 after releasing the compression on the carrier 20, thus maintaining the pre-set length of the rotor module 405. In some embodiments, the material of the strip 2410 can be carbon steel (e.g. typically in embodiments using welding).

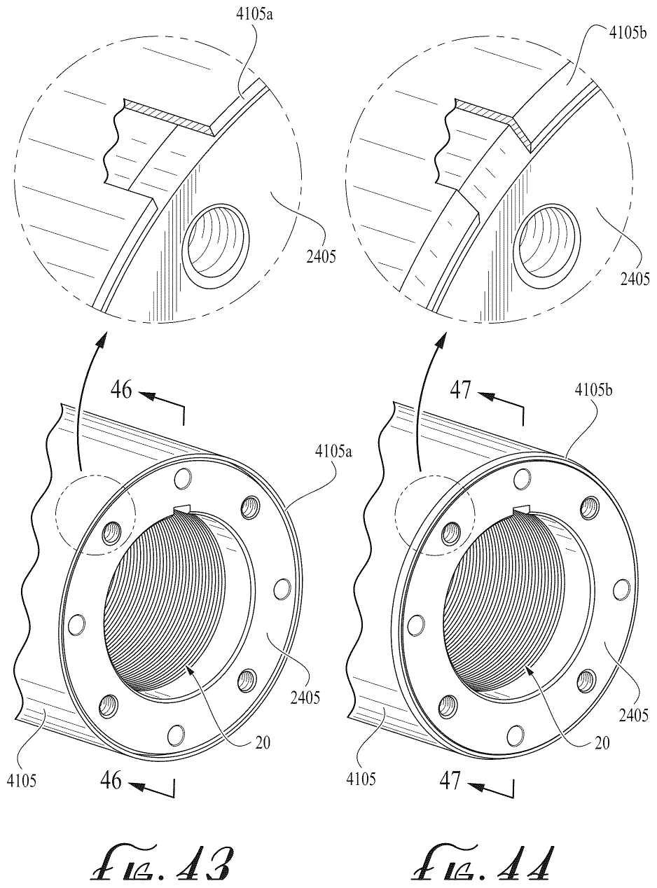

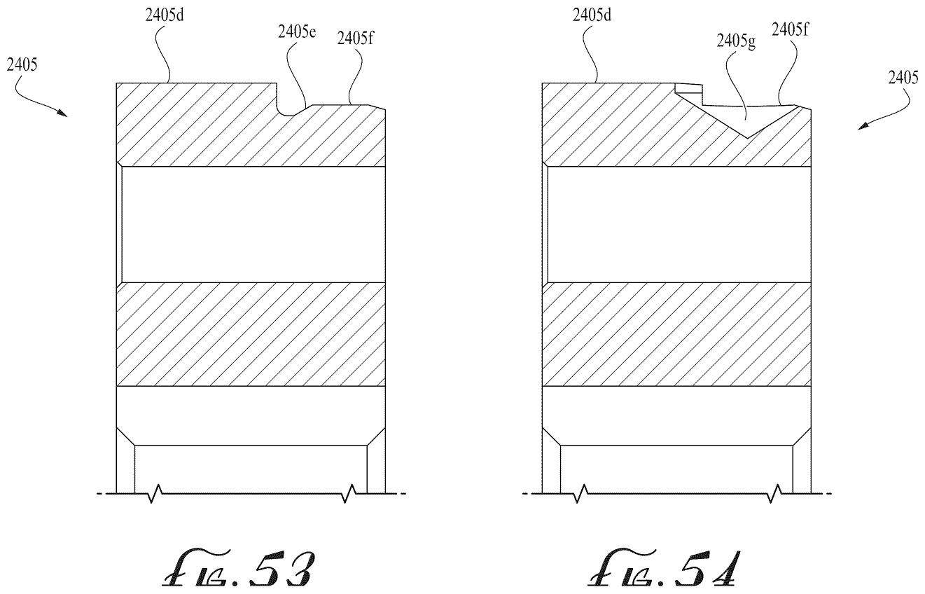

As discussed above, another approach for permanent magnet motors may include surface mounting the magnets on a carrier (e.g. a SMPM approach). FIG. 41 and FIG. 42 illustrate another exemplary rotor module embodiment, namely a surface mount permanent magnet (SMPM) rotor module 405. This rotor module 405 can comprise: a carrier/core/lamination stack 20 (e.g. built from a pre-defined number of thin (e.g. stamped steel sheet) laminations 3900, for example as shown in FIG. 50), a number of permanent magnets 5a (South polarity) and 5b (North polarity), and end rings 2405 disposed at each end of the rotor module 405 and/or carrier 20. In many aspects, the SMPM embodiment of FIG. 41 can be similar to the embodiment of FIG. 24 (for example, using a lamination stack to form the carrier and/or magnets disposed in pockets (although in this embodiment, the pocket is an external pocket/groove). In this embodiment, rather than (or possibly in addition to) using strips to secure the end rings 2405 to the carrier 20, a retention sleeve 4105 may be used. In embodiments, the use of the retention sleeve 4105 may allow for effective assembly of the rotor module 405 without additional structural members (e.g. threaded rods, treaded core/support, staples/strips, etc.). In such rotor module 405 embodiments, a support mandrel may only be required for producing the carrier/core/lamination stack 20 and assembling the magnets 5a and 5b (and in some embodiments inserting the assembly of magnets and carrier into the sleeve 4105 and swaging the ends of the retaining sleeve). In some embodiments, carrier strips may be used during formation of the carrier 20 (e.g. as discussed in other embodiments), with the retention sleeve 4105 being used to hold the end rings 2405 in place at each end. In some embodiments, clinches or other mechanisms may be used to hold the carrier laminations together prior to the retention sleeve 4105 being disposed around the carrier 20 and magnets 5.

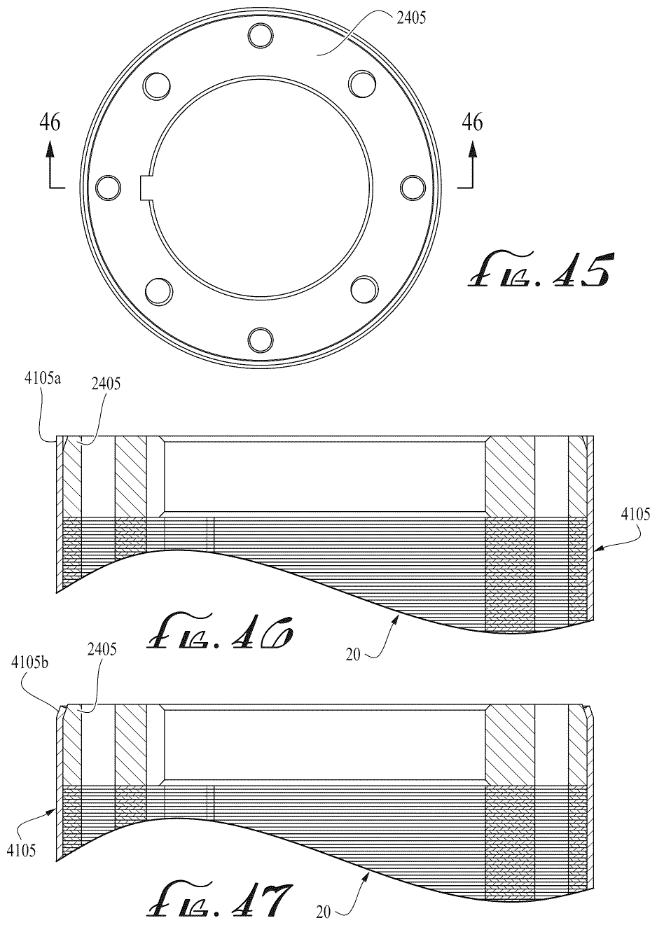

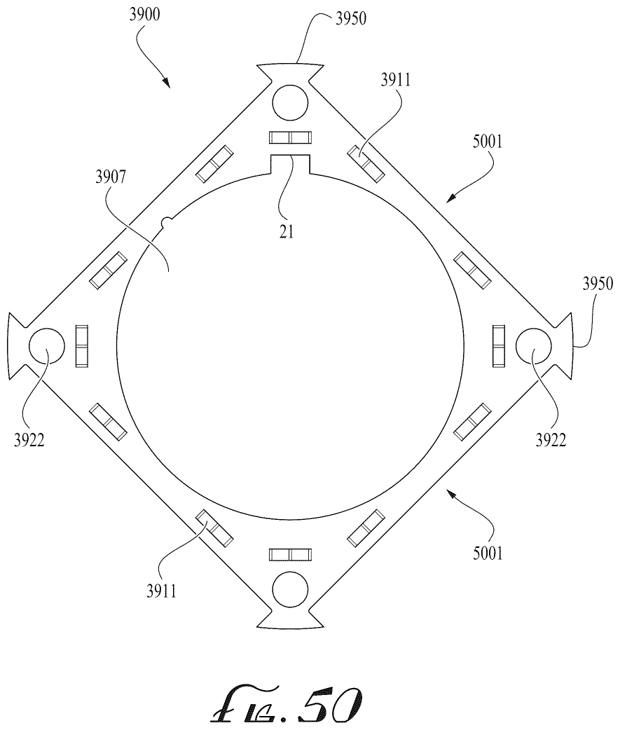

Being a surface mount magnet assembly method, the manufacturing time and complexity can be reduced. Once the assembly of the carrier 20, the magnets 5a and 5b, and the end rings 2405 is complete, such assembly can be inserted (e.g. pressing using a hydraulic press) into the retention sleeve 4105. In embodiments, the design can rely on (e.g. light) interference fit between the retention sleeve 4105, the carrier 20, the magnets, and/or the end rings 2405. The interference level can be determined and/or set such that it is maintained throughout the motor temperature operating range, which can be up to 220° C. for example. Additional means of retention between the retention sleeve 4105 and the end rings 2405 (and thus the carrier 20 and magnets 5 disposed between the end rings 2405) can be implement as shown in FIGS. 43-47. For example, a short end section 4105a of the straight retention sleeve 4105 can be formed over an end (e.g. a profiled end) of the end ring 2405 (e.g. by swaging). This can permanently deform the end of the sleeve 4105 (e.g. with a radially inward fold) into a shape such as 4105b all around the circumference of the sleeve 4105 (although in other embodiments, the swaging may be localized). In the embodiment of FIG. 47, a distal end of the retaining sleeve 4105 can be swaged (e.g. radially folded inward) over the corresponding distal end of the end ring 2405 (e.g. with the amount of inward fold corresponding to the angle of the surface (e.g. profiled surface) of the distal end of the end ring 2405). In embodiments, such cold forming can be achieved during the insertion process, for example using bespoke tooling during the pressing process. While the swaging is shown for only one side in FIG. 44, typically both ends of the rotor module retaining sleeve 4105 may be swaged (for example using a similar process).

FIGS. 46-47 present an axial cross-section of the rotor module shown in FIGS. 43-44. FIG. 46 is a representation of the un-swaged end 4105a of the retaining sleeve 4105, and depicts the taper (e.g. inward angled surface) on the end ring 2405 (e.g. with a taper angle formed between the taper and the inner diameter of the retaining sleeve 4105, when un-swaged). The taper angle on the end ring 2405 may be selected such that the required swaging force is minimized and/or the swaged end of the retaining sleeve 4105 does not suffer a catastrophic failure (e.g. rupturing, cracking, tearing, etc., for example during cold forming). This taper angle may range from approximately 10° to approximately 45°, although swaging tests may be performed to determine the optimal value. FIG. 47 shows the swaged end 4105b of the retaining sleeve 4105, which can follow/correspond to (e.g. approximately match) the shape of the taper on the end ring 2405. The swaged ends of the retaining sleeve 4105 can axially hold the end rings 2405 onto the carrier 20 (e.g. the lamination stack).

In embodiments, the retaining sleeve 4105 and/or end rings 2405 may comprise non-magnetic steel (e.g. austenitic stainless steel or some non-magnetic nickel alloy grades), as this may reduce Eddy current losses in the rotor module. In some embodiments, the retaining sleeve 4105 and/or end rings 2405 may have a similar thermal coefficient of expansion as the lamination stack, as this may provide continuous contact (e.g. interference fit) during motor operation. Additionally, the retaining sleeve 4105 may be formed of material suitable for swaging.

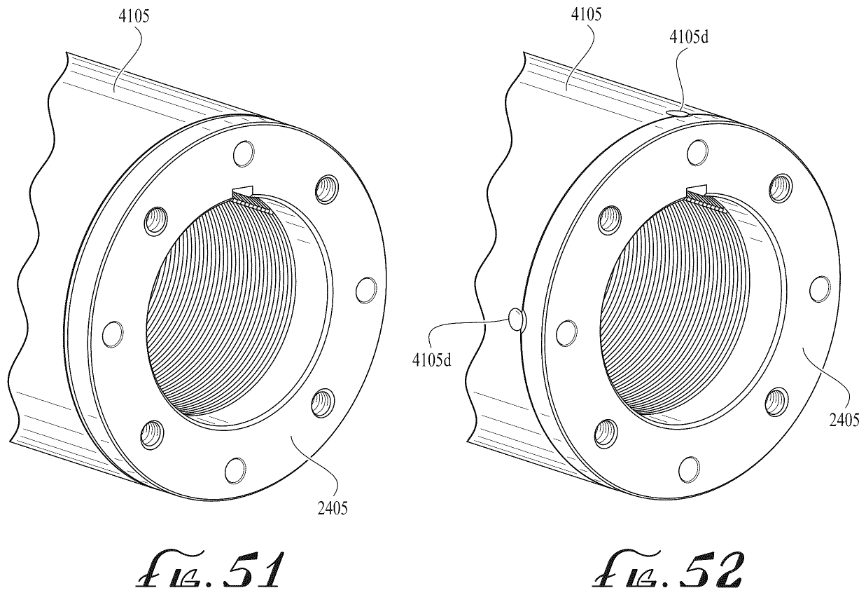

In some embodiments, each rotor module 405 and/or each carrier 20 may be formed using a plurality of subsections, which may for example be held together by a single retention sleeve 4105 (e.g. similar to that of FIG. 42, although in other embodiments a single one-piece carrier may extend the axial length of the rotor module). For example, the carrier 20 in some embodiments can be produced from individual subsections 4805, for example as depicted in FIGS. 48-49. In some embodiments, the individual carrier subsections 4805 may comprise a subsection lamination stack/carrier 20a (e.g. formed of a plurality of stacked laminations). The subsections 4805 may have laminations held together in any of the ways described herein with respect to carriers (e.g. clinches, an external sleeve disposed about the subsection, carrier strips, or/and bonding). Magnets 5a, 5b may be disposed around the carrier subsection stack 20a and bonded in place. In some embodiments, the carrier subsection stack 20a may have an axial length that is approximately the same as that of the corresponding magnets 5a, 5b. In some embodiments, the magnets may be held onto the carrier subsection stack 20 before being inserted into the sleeve 4105, forming a rotor module subsection 4805. By this method of manufacturing, large quantities of individual subsections 4805 can be manufactured and stored, such that during the rotor module 405 build, the subsections 4805 only need be loaded on an assembly mandrel before the carrier 20 is inserted into the retention sleeve 4105 to form the rotor module 405 (which may for example minimize cycle time and/or cost of manufacture). In some embodiments, due to the segment/subsection dimensions (e.g. short axial length of laminations and magnets and/or similar axial length of the two), in-situ magnetization of the magnets can be possible. For example, the un-magnetized raw magnets may be safely installed and bonded into the corresponding segment/subsection and stored at the vendor's facilities until the requirement for assembly arises, thus minimizing company's inventory. FIG. 49 illustrates embodiment having a plurality of subsections 4805 (e.g. 4805i-4805viii) held together by a single retaining sleeve 4105 to form a rotor module 405.

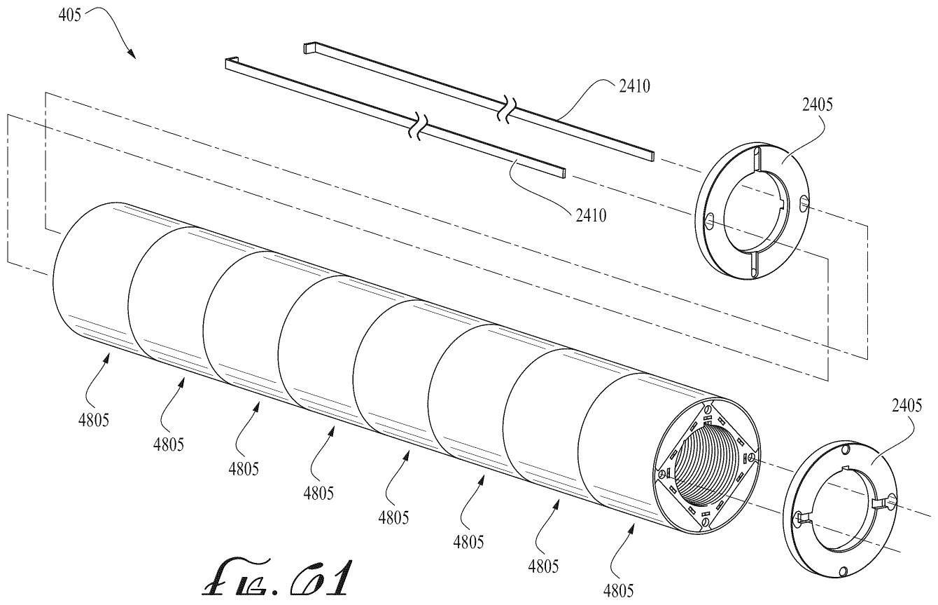

In other embodiments, each subsection can have magnets held onto the carrier subsection by an external sleeve (e.g. which can be similar to the retaining sleeve of other embodiments but can have approximately the same axial length as the corresponding magnets and/or carrier subsection), with the various subsections then being joined into a rotor module using another retaining mechanism such as retaining strips (e.g. similar to the discussion with respect to FIGS. 24-40). For example, end rings could be disposed at each end of an axial stack of module subsections, with retaining strips axially holding the subsections together (e.g. via axial fixation and/or compression of the end rings with the subsections therebetween). See for example FIG. 60, illustrating an exemplary module subsection (e.g. having a carrier subsection, which can be formed by an axial stack of laminations, a plurality of magnets, and an external sleeve concentrically disposed around the carrier subsection and corresponding magnets), and FIG. 61, illustrating an exemplary rotor module formed by axially fixing a plurality of module subsections between two end rings, for example using a retaining mechanism such as a plurality of retaining strips.

FIG. 50 illustrates an end/top view of an exemplary SMPM lamination 3900. Due to its manufacturing procedure (e.g. stamping from thin sheet metal), the individual thin lamination 3900 can incorporate one or more of a variety of features, such as: magnet recess/pockets (e.g. axially extending grooves 5001, which may be configured to hold the magnets in place between the carrier and the retaining sleeve), the shaft bore 3907, the balance mass channels 3922, and/or the keyway or key 21. When the laminations 3900 are stacked, they may jointly form features of the rotor module 405 (e.g. grooves, bore, balance mass channels, etc. that extend axially, for example for the entire axial length of the rotor module 405). Additionally, the lamination 3900 may have a plurality of tabs 3950, for example disposed (e.g. approximately evenly) around the exterior surface, in order to produce a circular outer edge of the carrier 20 for contact within the retaining sleeve 4105 (e.g. with the grooves 5001 disposed between adjacent tabs 3950). For example, the outer surface of each tab 3950 may be shaped as an arc, with the tabs 3950 as a whole having arcs that jointly are configured to engage the inner surface of the (e.g. circular cross-section) retaining sleeve 4105. For example, when the sleeve 4105 is installed onto the lamination stack (e.g. carrier 20), a light interference fit may occur between the tabs 3950 and the retaining sleeve 4105. The lamination 3900 of FIG. 50 may share similarities with that of FIG. 39A (e.g. but has external pockets/slots for surface mount configuration)

The number of such features may vary depending, for example, on the number of magnetic poles (e.g. the number of pole pairs) in the rotor module 405. When a plurality of such laminations 3900 are stacked to form either a complete carrier 20 or a carrier subsection 4805, the individual laminations 3900 can be held together by a method called clinching in some embodiments. For this purpose, a series of indentations called clinches 3911, may be produced in the lamination 3900, which can interlock into each other when the laminations 3900 are stacked and compressed (e.g. providing a method of retention and stability to the carrier 20 or carrier subsection 4805). Although this method may allow a carrier 20 or carrier subsection 4805 to be produced, it may not prevent laminations 3900 of the stack from separating if an external bending load is applied to the carrier 20 (e.g. hence the need for an additional securing method, such as a retaining sleeve 4105).

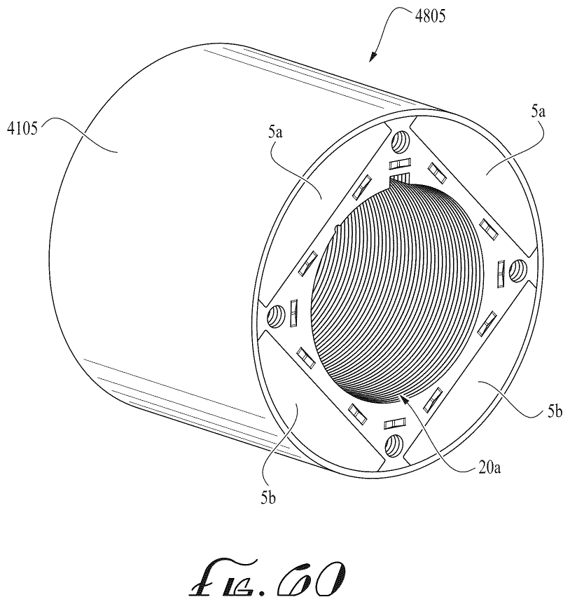

FIGS. 41-49 illustrate one exemplary SMPM approach. The compression and swaging method presented with respect to FIGS. 59A-B may be applied for this embodiment (e.g. as discussed in more detail below). Alternate or additional means of retention may be implemented between the retaining sleeve 4105 and the end rings 2405, for example as shown in FIG. 51 through FIG. 56. Two alternate embodiments of the retaining sleeve 4105 swaging are presented below, and persons of skill will understand these, and other related approaches based on this disclosure. It should be noted that the approaches shown in FIGS. 51-56 may be similar to that of FIGS. 41-49 in some aspects.

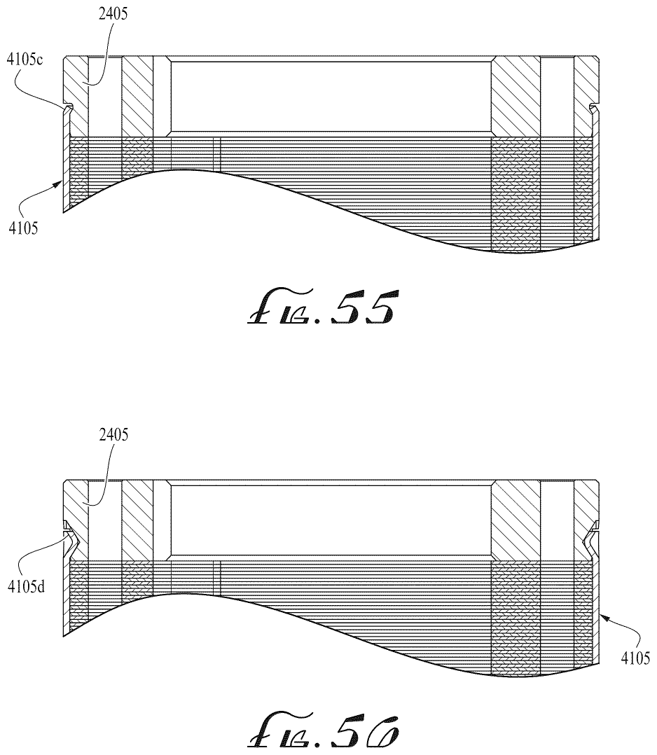

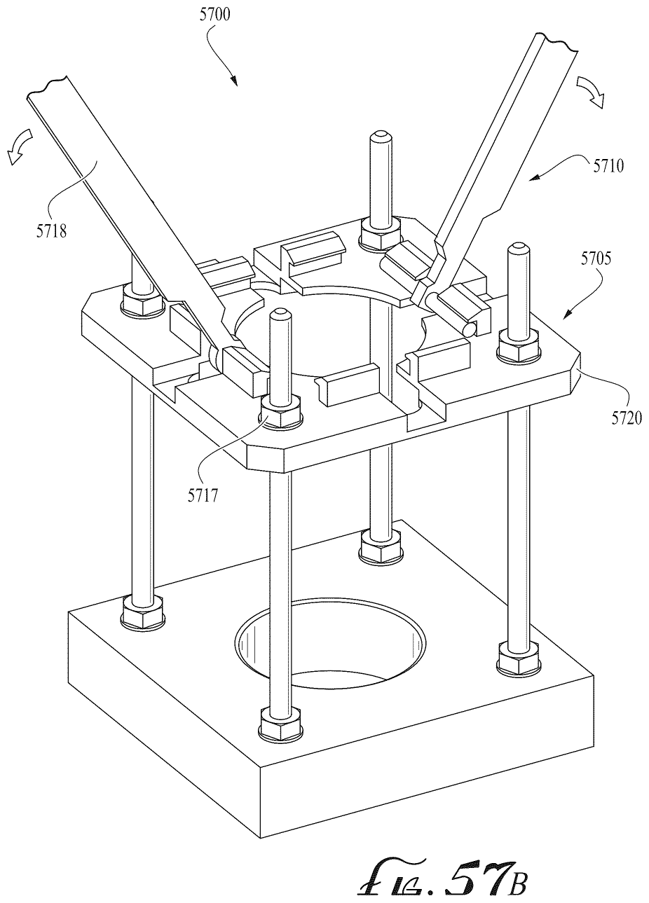

Both FIG. 51 and FIG. 52 depict a finished swaged configuration of the retaining sleeve 4105. The retaining sleeve 4105 end can be swaged on the full circumference of the end ring 2405, as depicted in FIG. 51, producing a swaged assembly similar to that of FIG. 44. The main difference between the swaging methods presented in FIG. 51 and FIG. 44 may relate to the location and the extent of the swaged portion of the retaining sleeve 4105 on the end ring 2405. A detail of the swaged retaining sleeve 4105 can be seen in the cross-section view in FIG. 55. It can be noted that in comparison with the swaged end of the retaining sleeve 4105 as depicted in cross section view in FIG. 47, the swaged end of the retaining sleeve 4105 depicted in FIG. 55 can be located at a certain axial distance from the end face of the end ring 2405 and/or that the depth of the swaged portion can be less than the swaged portion in FIG. 47. By way of example, the swaged end of the retaining sleeve 4105 may not reach the exterior surface/face of the end ring 2405, but may bend radially inward into a groove or divots (e.g. countersink holes) in the side of the end ring 2405 (for example as shown in FIG. 55, with less radially inward bending than in FIG. 47). This approach may leave a portion of the end ring 2405 extending axially beyond the retaining sleeve 4105 (e.g. with some portion of the side surface of the end rings 2405 exposed, rather than being entirely covered by the retaining sleeve 4105, and/or with the entire exterior face of the end rings 2405 being exposed).

This approach can be driven by the machined profile 2405e (recessed taper) and/or 2405f (interference diameter), as it can be seen in FIG. 53 (e.g. of the side surface of the end ring 2405). For example, the recessed taper/machined profile 2405e can comprise an inward divot or groove, for example configured to receive the swaged end of the retaining sleeve 4105. The interference diameter 2405f may have a larger diameter than the recessed taper 2405e (e.g. but in some embodiments may have a diameter less than the inward portion of the end ring 2405), for example to assist in retaining the swaged end of the retaining sleeve 4105 in the recessed taper 2405e. Typically, the recessed taper 2405e can extend circumferentially around the side surface of the end ring 2405, for example allowing circumferential swaging of the retaining sleeve 4105 onto the end ring 2405 (e.g. with the inward folded end of the retaining ring extending approximately the full circumference, for example to provide interference contact with approximately the entire circumference of the end ring 2405 within the recessed taper 2405e).

A possible advantage of this method of swaging can be the ability of the swaged assembly to be spun on a true machined surface 2405d of the end ring 2405 during the balancing process, compared to running the rotor assembly on swaged retaining sleeve (e.g. as may be the case for the embodiment of FIG. 44). Additionally, the assembly process may be simplified, in terms of assembling the lamination stack and magnets, then pressing them into the retaining sleeve 4105, and pressing in the end rings 2405 for each end before the swaging process. The compression and swaging method presented with respect to FIGS. 59A-B may still be applied for this alternate embodiment (e.g. similar methods may be used for any retaining sleeve embodiment using swaged ends), although the swaging may require a set of additional tooling components or a different tool. For example, the swaging tools may be displaced radially around the swaging area and may be mechanically or hydraulically actuated in radial direction to produce the swaged end of the retaining sleeve 4105. An advantage of this method can be reduction of the force required to produce the swaged profile (e.g. direct radial force versus a normal component of the axial force).

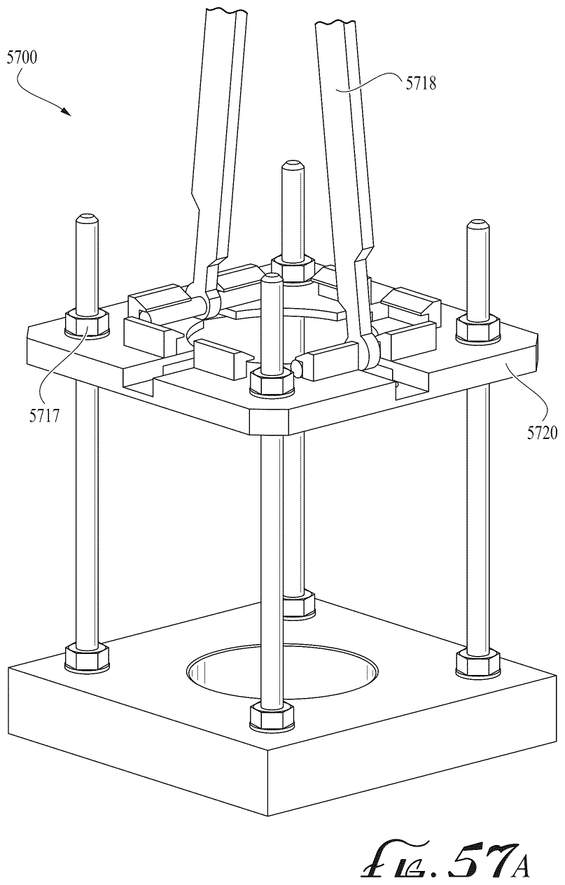

Another alternate embodiment can employ a localized cold forming method of the retaining sleeve 4105 onto the end ring 2405, for example as depicted in FIG. 52. For this method, custom features like countersink holes 2405g (e.g. four can be present in this embodiment, although the number may vary in other embodiments) may be machined in the end ring 2405 as shown in FIG. 54. These features may be machined at predefined distance from the end face of the end ring 2405, such that when the end rings 2405 are installed into the retaining sleeve 4105, they are partially visible and provide a visual indication of their location. For example, the swaged end of the retaining sleeve 4105 may bend radially inward into (e.g. at a corresponding profile angle) countersink holes 2405 on the sides of the end ring 2405. The indentations 4105d (e.g. swaged end positions of the sleeve 4105), as detailed in the cross-section view in FIG. 56, may be produced by bespoke tooling, for example operated mechanically or hydraulically in radial direction, similar to the first alternate embodiment above. Alternatively, a manual method (e.g. punching) may be implemented to produce these dents. The number of the countersink holes 2405g can vary, for example depending on the specifics of the embodiment. Again, this approach may leave a portion of the end ring 2405 extending axially beyond the retaining sleeve 4105 (e.g. with some portion of the side surface of the end rings 2405 exposed, rather than being entirely covered by the retaining sleeve 4105, and/or with the entire exterior face of the end rings 2405 being exposed). As shown in FIG. 52, the swaging may not extend around the entire circumference and/or may be disposed only at certain localized locations (e.g. disposed, for example symmetrically and/or evenly spaced, around the circumference). For example, the countersink holes 2405g may be discrete holes/indentations disposed at specific locations around the circumference of the end ring 2405 (e.g. typically evenly spaced apart), and only the portion of the retaining sleeve 4105 disposed over those discrete countersink holes may be swaged (e.g. folded radially inward). For example, swaging of the end of the retaining sleeve 4105 may not extend around the circumference, but may be disposed at only a discrete number of locations corresponding to the locations of the countersink holes 2405g. Persons of skill will appreciate these and other alternate embodiments relating to retaining end rings onto the end of a lamination stack using an external sleeve (e.g. with some form of swaging of the end as a possible retention mechanism).

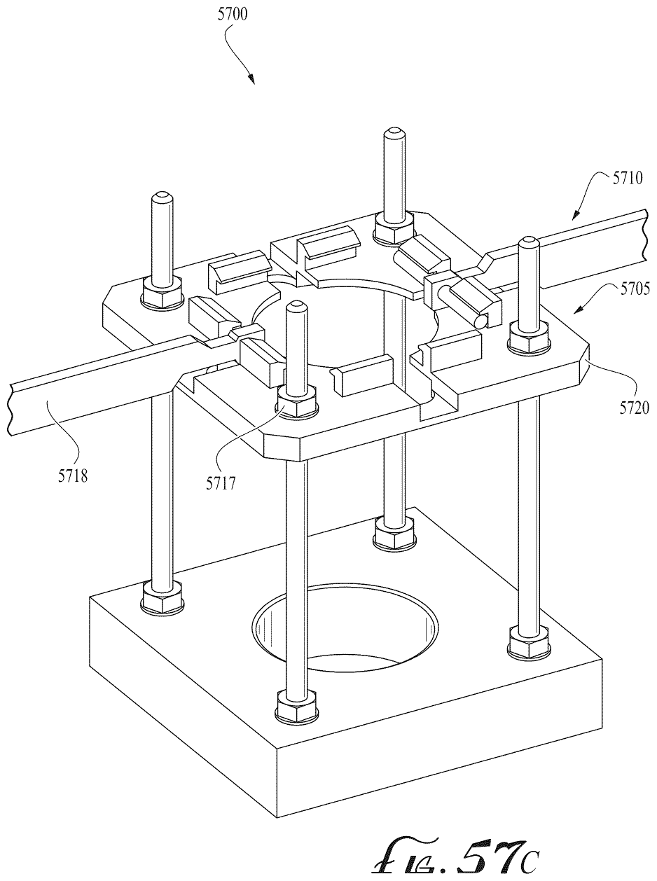

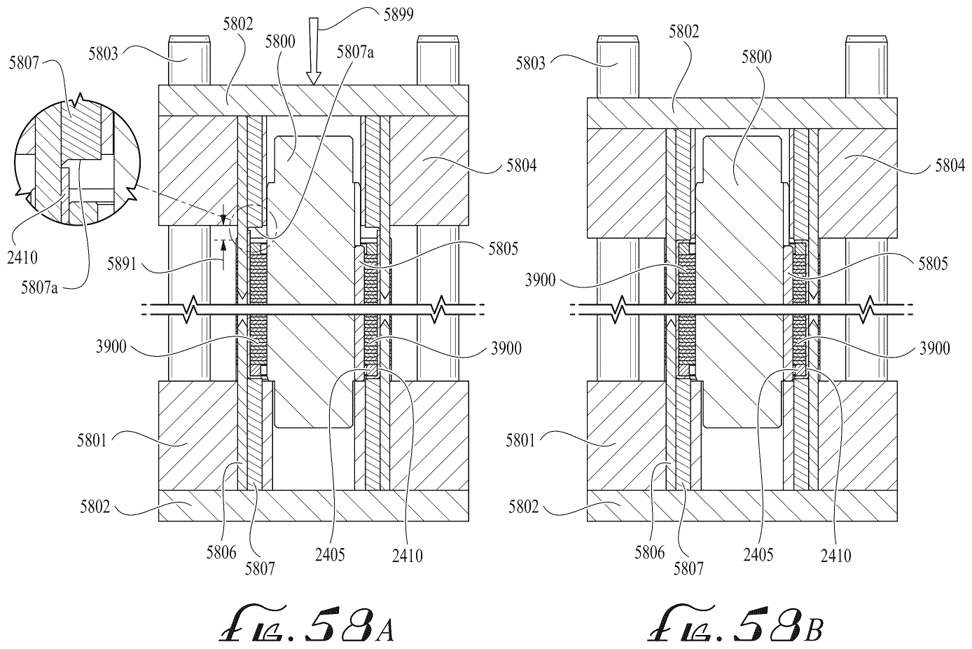

FIGS. 57A-B illustrate an exemplary device for assembling/constructing a rotor module (e.g. a rotor module similar to one illustrated in FIGS. 24-40). The device 5700 comprises a compression mechanism 5705, configured to allow for axial compression of the lamination stack (and in some embodiments the end rings), and a strip end deformation mechanism 5710. In embodiments, the compression mechanism 5705 can include mechanical compression (e.g. such as supplied by a screw element), hydraulic compression (e.g. provided by a hydraulic press), pneumatic compression (e.g. provided by a pneumatic press), electric compression (e.g. provided by an electric motor/actuator), and/or any other manner of supplying compression force. The embodiment illustrated in FIG. 57A employs one or more screws to provide the external compression force. For example, by screwing down the four bolt-nuts 5717, a press plate 5720 can be moved (e.g. closer to a base plate or another press plate) to provide compression to the lamination stack (e.g. which may be disposed between the press plate and the base plate or other press plate and/or with the retaining strips and end rings already in place).

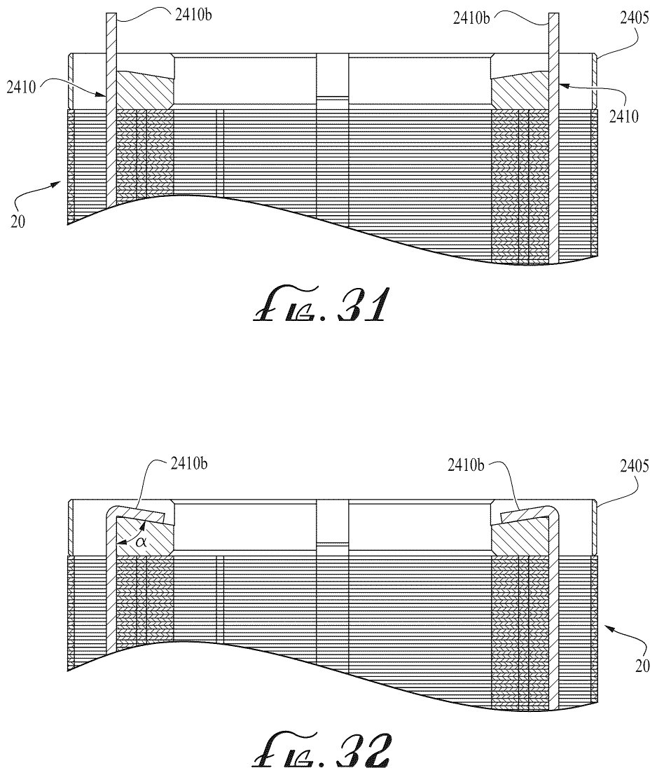

Once sufficient external compression has been applied (e.g. to the lamination stack), the strip end deformation mechanism 5710 can be used to permanently deform (e.g. bend) the ends of the strips (e.g. either the carrier strips or the retaining strips). See for example FIG. 57B. In FIG. 57B, the strip end deformation mechanism 5710 can comprise one or more pivoting arms 5718, for example pivotable between a first position in which the strip ends extend approximately axially (e.g. see for example FIG. 57A, which may correlate to FIG. 31 for the module) and a second position in which the strip ends are bent (e.g. folded radially inward-see for example FIGS. 57B-C, which may correlate to FIG. 32 for the module). For example, in FIGS. 57A-C, in the first position the base of the arms 5718 can be laterally disposed adjacent to the axially extending unbent strip ends, while in the second position the base of the arms 5718 can be disposed atop the bent ends of the strips (e.g. with the bent strip ends folded radially inward).

In some embodiments, the same device 5700 can be used to compress and permanently deform the carrier strips, as well as the retaining strips (e.g. a similar process can be used for both carrier and retaining strips). For example, the lamination stack may be placed on a mandrel, which is then disposed in the device 5700 (e.g. between the press plate and the base or other press plate). The compression mechanism 5705 can be used to compress the lamination stack, and then the strip end deformation mechanism 5710 can be used to bend the carrier strips. The device 5700 can then release its external pressure (e.g. unscrew the bolt-nuts 5717), and the magnets and/or end rings (e.g. one on each side of the lamination stack/carrier) and/or retaining strips can be added to the mandrel. The mandrel can then be disposed in the device 5700 (e.g. between the press plate and the base or other press plate). The compression mechanism 5705 can be used to compress the lamination stack and end rings, and then the strip end deformation mechanism 5710 can be used to bend the retaining strips. In some embodiments, the carrier/mandrel may be rotated before it is disposed in the device 5700 (e.g. so that the same arms may be used to bend both the carrier strips and the retaining strips, which may have different radial orientation). In some embodiments, the retaining strips may be bent (to hold the end rings and lamination stack together) in this manner even without the use of carrier strips. The external compression (e.g. provided by the device 5700) can then be released, and the rotor module removed. At some point in this process, the magnets may be added within the pockets of the carrier (e.g. before the end rings are attached), and the end rings being secured by the retaining strips can hold the magnets in place within the carrier. Such a device (or a functionally comparable device) may be used to assemble/construct/manufacture rotor modules, for example using disclosed methods.

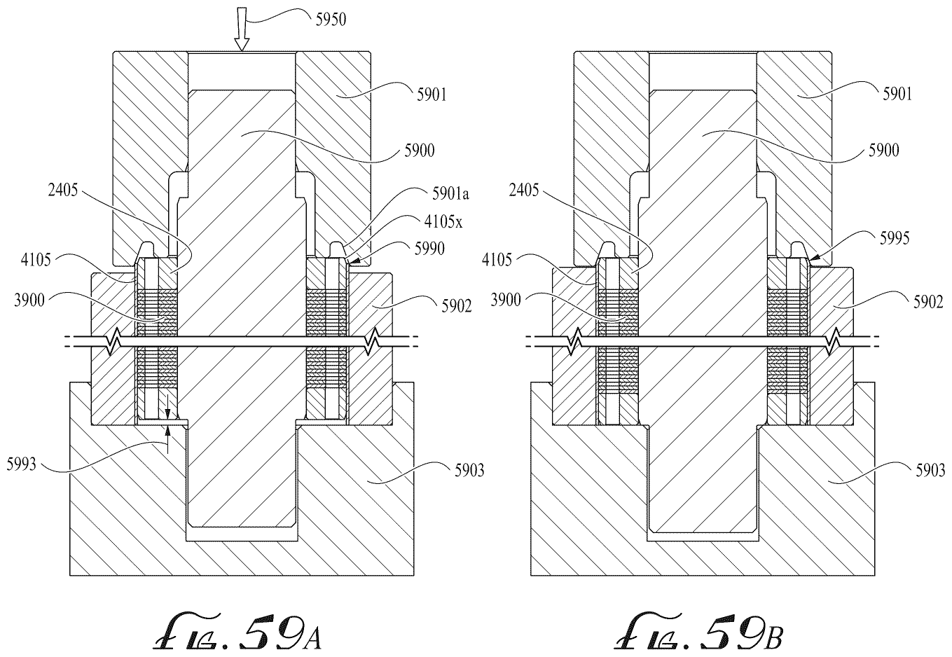

FIGS. 58A-B illustrate another exemplary device for assembling/constructing a rotor module (e.g. a rotor module similar to one illustrated in FIGS. 24-40). For example, FIGS. 58A-B show exemplary tooling that can be used concurrently for compressing the lamination stack and end ring and for bending the retaining strips. By way of example, the tooling can comprise a base 5801, a support plate 5802, the mandrel 5800 (e.g. carrying the rotor module elements such as the lamination stack, the magnets, the two end rings, as well as the strips and the alignment key 5805), the guide rods 5803 (e.g. four per assembly), the compression head 5804, the alignment pin 5806, and the bending insert 5807. The process can start by placing the support plate 5802 and the base 5801, which can have four of each of the alignment pin 5806 and the bending insert 5807, under the ram of a vertical hydraulic press. The mandrel 5800, pre-loaded with all the components mentioned above, can be aligned with the alignment pins 5806 of the base 5801 (e.g. through the balance mass channels in the end ring and/or the balance mass channel in the laminations of the lamination stack) and installed into the base 5801. The pre-shaped strips may snugly rest on the bending inserts 5807 of the base 5801. A pre-compression of the lamination stack may be performed before the final compression and the strip bending process starts. The compression head 5804, comprising four of each of the guide pin 5806 and the bending insert 5807, can be installed over the guide rods 5803 on top of the mandrel until the bending inserts 5807 rest on the straight strips.

At this position, a gap 5891 may exist between the compression head 5804 and the end ring. This gap can equal the distance that the bending inserts 5807 need to travel until the strips are bent into the final shape, as depicted in FIG. 58B. A force 5899 can then be applied by the ram of the hydraulic press onto the compression head 5804 through the support plate 5802. The compression head 5804, the support plate 5802, the alignment pins 5806 and the bending inserts 5807 can be displaced until the compression head 5804 contacts the end ring. During this process, the strips may forcibly be deformed into the final shape (e.g. in this embodiment a 90° angle) by the profiled face 5807a of the bending insert 5807. A small amount of compression of the entire lamination stack may be possible during the bending process. When the bending process is complete, no more gap 5891 may be present.

In this embodiment, the steel strip can be magnetic spring or mild steel. Magnetic steel may be useful in some embodiments for its electromagnetic properties in the assembly. The end ring may be of a material with low magnetic permeability, like austenitic stainless steel (e.g. 300 series stainless steel), to ensure it does not affect the electromagnetic properties of the rotor assembly. Alternate materials can include nickel alloys (e.g. Inconel), which also have a low magnetic permeability. To maintain its shape and act as a compression spring, the strip material can be spring steel (usually specially heat-treated magnetic steel). After the compression tooling is removed from the core, the lamination stack tends to relax (e.g. spring-back), and its length may grow; however, this expansion can be counteracted by the steel strips, which may act as compression springs. In this embodiment, the steel strip is shown as being rectangular, but in alternate embodiments the retaining strips can be of square, round, or of another shape. An assembly support mandrel and alignment key 5805 can be used through the assembly and balancing process of the rotor module. The rotor module assembly can be removed from the mandrel once the strips are in place and the rotor module is balanced.

An exemplary method of swaging the end of the retaining sleeve is depicted in FIGS. 59A-B (e.g. for forming a rotor module similar to those illustrated in FIGS. 41-56). Both figures show exemplary tooling which can be used concurrently for compressing the lamination stack and end ring and swaging the retaining sleeve. In FIG. 59A, the tooling used for this process comprises a base 5903, a support tube 5902, the mandrel 5900 carrying the rotor module (i.e. the lamination stack 3900, the magnets and the two end rings 2405), and the compression and swaging tool 5901. The process can include placing the base 5903 and support tube 5902 under the ram of a vertical hydraulic press. The retaining sleeve 4105 can be slid into the support tube 5902, for example until it bottoms out in the counter-bore of the base 5903. The mandrel 5900, pre-loaded with the lamination stack 3900, the magnets (not shown in this cross-section) and the two end rings 2405, can then be positioned on top of the retaining sleeve 4105, concentrically with the retaining sleeve 4105. The compression and swaging tool 5901 can be placed over the mandrel 5900 end diameter (e.g. resting on the upper end ring 2405). The mandrel 5900 and the swaging tool 5901 can then both be pushed by the ram of the hydraulic press with a force 5950. The mandrel 5900, the swaging tool 5901, the lamination stack 3900, the magnets and the end rings 2405 can be simultaneously driven into the retaining sleeve 4105. Due to the light interference between the retaining sleeve 4105 and the lamination stack 3900/end rings 2405, the force 5950 may progressively increase during the insertion process. At the same time, the lamination stack 3900 may be compressed due to the reaction force (friction) between the components.

The pressing process can continue until the swaging tool 5901 contacts the retaining sleeve 4105, as depicted in FIG. 59A. In this position, the end of the retaining sleeve 4105 is still in an un-swaged state 5990. At this point, at the lower end of the assembly, between the end ring 2405/mandrel 5900 and the counterbore in the base 5903, a gap 5993 may exist. This gap can equal the distance the swaging tool 5901 needs to travel until the end of the retaining sleeve 4105 is fully swaged, as depicted in FIG. 59B (e.g. swaged state 5995). The swaging of the end of the retaining sleeve 4105 can occur due to the interaction between the tapered face 5901a on the swaging tool 5901 and the end of the circular profile of the retaining sleeve 4105. The force required to perform the swaging may increase until the end of the retaining sleeve 4105 is permanently deformed (e.g. plastic deformation) into the shape of the tapered face 5901a on the swaging tool 5901 and the taper 4105x on the end ring. When the retaining ring is fully swaged, no more gap may be present at the lower end of the assembly. The swaging process of one end of the rotor module 405 can be considered complete. A small spring back in the lamination stack may be possible after the force 5950 is removed from the assembly.

To swage the opposite end, the rotor module 405 can be removed from the support tube 5902, rotated 180° degrees, and reinserted into the tooling. The swaging process of the opposite end can be similar to the process presented above. In some embodiments, a custom tooling component (not shown in the figures) may be used in the counterbore of the base 5903 so that the swaged end of the rotor module 405 may be preserved during the swaging process of the opposite end (e.g. so it will not be impacted by deformation of the opposite end of the retaining sleeve 4105). A small spring back of the lamination stack is possible at the end of the process. The spring back can be beneficial in embodiments of the assembled rotor module, as it can create a tension force between the swaged ends of the retaining sleeve 4105, thus providing a permanent pre-load (compression) on the lamination stack.

### Additional Disclosure

The following are non-limiting, specific embodiments in accordance with the present disclosure:

In a first embodiment, a rotor module (e.g. configured to be concentrically disposed on a drive shaft (e.g. for an ESP motor) can comprise: a plurality of laminations, each configured to be concentrically disposed on the drive shaft; a plurality of magnets (e.g. half south polarity and half north polarity); two end rings; and two or more retaining strips; wherein: the plurality of laminations are axially stacked to form a carrier (e.g. core) having a plurality of axially-extending pockets, each configured to retain/receive one or more of the plurality of magnets, and two or more axially extending slots, each configured to retain/receive one of the two or more retaining strips; and each of the two or more retaining strips extends through both end rings (e.g. openings such as holes or slots in the end rings) and the corresponding slot (e.g. in the carrier), and is configured to retain the end rings onto both ends of the carrier.

A second embodiment can include the rotor module of the first embodiment, wherein the carrier is disposed between the two end rings (e.g. an axial stack of first end ring, carrier, and second end ring, for example with the carrier contacting one of the end rings at each end).

A third embodiment can include the rotor module of the first or second embodiment, wherein the two or more retaining strips are configured to retain the end rings onto both ends of the carrier without threading and/or without an inner support tube.

A fourth embodiment can include the rotor module of any one of the first to third embodiments, wherein the two or more retaining strips are configured to retain the end rings onto both ends of the carrier using permanent deformation of one or more ends of the strip.

A fifth embodiment can include the rotor module of any one of the first to fourth embodiments, wherein each lamination comprises a thin, magnetically permeable material (e.g. metal).

A sixth embodiment can include the rotor module of any one of the first to fifth embodiments, wherein each lamination comprises a shaped steel sheet.

A seventh embodiment can include the rotor module of any one of the first to sixth embodiments, wherein each lamination comprises one or more clinches (e.g. configured to align when stacked and interlock).

An eighth embodiment can include the rotor module of any one of the first to seventh embodiments, wherein each lamination comprises a bore opening, a rotational connection mechanism (e.g. a key/keyway), a plurality of magnet pocket openings (e.g. disposed around the bore opening, typically evenly spaced, which may be formed between an outer perimeter wall (e.g. cylindrical) and an interior support), a plurality of slot openings (e.g. shaped to receive the corresponding strip), and/or a plurality of balance holes (which can form channels for balance rods when the laminations are stacked).

A ninth embodiment can include the rotor module of the eighth embodiment, wherein each slot may be located radially inward of a corresponding balance hole and/or may be connected to the corresponding balance hole.

A tenth embodiment can include the rotor module of any one of the eighth to ninth embodiments, wherein the outer perimeter wall may be circular and/or may encompass the remainder of the lamination (e.g. form the continuous perimeter of the lamination), and wherein the interior support may be coupled to an inner surface of the outer perimeter wall (e.g. entire lamination is a single integral unit (e.g. stamped out of a single sheet of material)).

An eleventh embodiment can include the rotor module of any one of the eighth to tenth embodiments, wherein the outer perimeter wall may have a cross-sectional thickness (e.g. when viewed as in FIG. 39A) of approximately 0.3-1 mm.

A twelfth embodiment can include the rotor module of any one of the eighth to eleventh embodiments, wherein the pocket openings may be shaped to match the corresponding magnets (e.g. in cross-section).

A thirteenth embodiment can include the rotor module of any one of the eighth to twelfth embodiments, wherein the interior support may connect to the outer perimeter wall at four locations (and four magnet pocket openings may be disposed around the bore).

A fourteenth embodiment can include the rotor module of any one of the eighth to thirteenth embodiments, wherein the interior support may comprise a square structure (e.g. having four struts/braces, which may each be arch-shaped (e.g. flat on the outer surface but curved on the inner surface) to match the bore on the inner surface) extending between connection points to the perimeter wall), with the bore opening disposed therein (e.g. centered within the square).

A fifteenth embodiment can include the rotor module of the fourteenth embodiment, wherein each strut of the interior support may have a cross-sectional thickness no less than approximately 0.5 mm.

A sixteenth embodiment can include the rotor module of any one of the eighth to fifteenth embodiments, wherein the rotational connection mechanism (e.g. key/keyway) is disposed on the interior of the interior support and/or bore opening (and configured to directly interact with the drive shaft).

A seventeenth embodiment can include the rotor module of any one of the thirteenth to sixteenth embodiments, wherein one or more balance hole may be disposed radially inward of and/or within each connection point.

An eighteenth embodiment can include the rotor module of any one of the eighth to seventeenth embodiments, wherein the one or more clinches comprises a plurality of clinches, which may be evenly spaced around the interior support.

A nineteenth embodiment can include the rotor module of the eighteenth embodiment, wherein at least one clinch is disposed radially inward from each slot and/or balance hole and/or connection point.

A twentieth embodiment can include the rotor module of any one of the eighteenth to nineteenth embodiments, wherein at least one (e.g. two) clinches are disposed on each struct of the interior support (e.g. between the connection points at each end).

A twenty-first embodiment can include the rotor module of any one of the first to twentieth embodiments, wherein each lamination may have an axial thickness (e.g. depth which when stacked forms the axial length of the rotor carrier) of approximately 0.3-0.6 mm.

A twenty-second embodiment can include the rotor module of any one of the first to twenty-first embodiments, wherein all of the laminations (e.g. of the carrier/stack) have the same configuration (e.g. size, shape, and/or features) (e.g. are identical, for example with a plurality of laminations being stamped at the same time from stacked sheets of material).

A twenty-third embodiment can include the rotor module of any one of the first to twenty-second embodiments, wherein the pockets and/or magnets are disposed around the drive shaft (e.g. evenly spaced).

A twenty-fourth embodiment can include the rotor module of any one of the first to twenty-third embodiments, wherein the carrier comprises a bore, configured to receive the drive shaft.

A twenty-fifth embodiment can include the rotor module of the twenty-fourth embodiment, wherein the bore comprises a rotational connection mechanism (e.g. keyway or key), for example corresponding to the key or keyway on the shaft.

A twenty-sixth embodiment can include the rotor module of any one of the first to twenty-fifth embodiments, wherein each magnet is a permanent magnet.

A twenty-seventh embodiment can include the rotor module of any one of the first to twenty-sixth embodiments, wherein each magnet is shaped to fit within the corresponding pocket (e.g. cross-sectional shape corresponds, for example with a curved exterior and a flat interior).

A twenty-eighth embodiment can include the rotor module of any one of the first to twenty-seventh embodiments, wherein each end ring comprises openings configured for passage of the corresponding strip therethrough (e.g. with the strip passing through both end rings and the carrier).

A twenty-ninth embodiment can include the rotor module of any one of the first to twenty-eighth embodiments, wherein each end ring has low magnetic permeability.

A thirtieth embodiment can include the rotor module of any one of the first to twenty-ninth embodiments, wherein each end ring comprises austenitic stainless steel (e.g. 300 series) or Inconel.

A thirty-first embodiment can include the rotor module of any one of the first to thirtieth embodiments, wherein the end rings (e.g. disposed on either axial end of the carrier) can protect the end of the magnets and/or can provide a stop for the carrier and/or magnets (e.g. holding the magnets axially within the pockets).

A thirty-second embodiment can include the rotor module of any one of the first to thirty-first embodiments, wherein the end rings may be used for rotor balancing purposes in some embodiments (e.g. by either adding weights in dedicated holes or remove weight by drilling).

A thirty-third embodiment can include the rotor module of any one of the first to thirty-second embodiments, wherein each retaining strips comprises magnetic steel (e.g. magnetic spring steel) (e.g. heat-treated).

A thirty-fourth embodiment can include the rotor module of any one of the first to thirty-third embodiments, wherein each retaining strip is configured to act as a compression spring (e.g. comprises spring steel).

A thirty-fifth embodiment can include the rotor module of any one of the first to thirty-fourth embodiments, wherein each retaining strip comprises a flat and rectangular shape (e.g. elongate rectangular shape that is thin—e.g. approximately 1-3 mm or larger) (In other embodiments, the retaining strips may each have a different shape).

A thirty-sixth embodiment can include the rotor module of any one of the first to thirty-fifth embodiments, wherein the slots are configured with shapes matching the corresponding retaining strip.

A thirty-seventh embodiment can include the rotor module of any one of the first to thirty-sixth embodiments, wherein the slots and/or retaining strips are evenly spaced circumferentially (e.g. there is equal angular displacement therebetween, as they are located around the drive shaft).

A thirty-eighth embodiment can include the rotor module of any one of the first to thirty-seventh embodiments, wherein the plurality of laminations and end rings are pre-compressed before being secured by the two or more retaining strips (e.g. typical compression range, for example press force provided by external device can be in the range of tens of metric tons).

A thirty-ninth embodiment can include the rotor module of any one of the first to thirty-eighth embodiments, wherein the pockets are disposed internally within the carrier (e.g. internal permanent magnet configuration-IPM).

A fortieth embodiment can include the rotor module of any one of the first to thirty-ninth embodiments, wherein the magnets do not extend (e.g. axially) into the end rings (e.g. the magnets are entirely disposed between the end rings).

A forty-first embodiment can include the rotor module of any one of the first to fortieth embodiments, wherein at least one end of each strip is configured to be permanently deformed (e.g. bent) (e.g. on or in contact with an exterior surface of one or more of the end rings) in order to retain the end rings onto the carrier.

A forty-second embodiment can include the rotor module of any one of the first to forty-first embodiments, wherein both ends are permanently deformed (e.g. bent).

A forty-third embodiment can include the rotor module of any one of the first to forty-second embodiments, wherein one end of each retaining strip is pre-bent (e.g. before the strip is inserted into the slot).

A forty-fourth embodiment can include the rotor module of any one of the first to forty-third embodiments, wherein at least one end of each retaining strip is configured to be bent after insertion through the corresponding slot and/or end rings.

A forty-fifth embodiment can include the rotor module of any one of the forty-first to forty-fourth embodiments, wherein each end ring comprises two or more recesses/indentations on an exterior surface, each configured to receive the corresponding bent end (e.g. of the corresponding strip).

A forty-sixth embodiment can include the rotor module of the forty-fifth embodiment, wherein each recess/indentation has sufficient depth so that the corresponding bent portion does not extend axially beyond the exterior surface of the corresponding end ring (e.g. no portion of the bent end extends axially out of the recess/indentation).

A forty-seventh embodiment can include the rotor module of any one of the forty-fifth to forty-sixth embodiments, wherein each bent end matches the profile of the corresponding recess/indentation (e.g. the profile bend angle may be approximately 70-90 degrees or approximately 80 or 90 degrees).

A forty-eighth embodiment can include the rotor module of any one of the forty-first to forty-seventh embodiments, wherein each bent end extends radially inward (e.g. the end is bent radially inward) (but does not extend into the bore of the carrier).

A forty-ninth embodiment can include the rotor module of any one of the first to forty-eighth embodiments, wherein the carrier further comprises a plurality of channels, each extending axially into the active length (e.g. the portion of the carrier with magnets, for example the active length may extend longitudinally/axially) and each configured to retain one of a plurality of balance masses.

A fiftieth embodiment can include the rotor module of the forty-ninth embodiment, wherein the plurality of channels are configured to be disposed around the drive shaft/longitudinal centerline/axis (e.g. concentrically around the axis).

A fifty-first embodiment can include the rotor module of any one of the forty-ninth to fiftieth embodiments, wherein the plurality of channels are evenly spaced around the drive shaft/longitudinal centerline/axis (e.g. spacing of the plurality of channels around the drive shaft/longitudinal centerline/axis ranges from approximately 60-120 degrees, approximately 60-90 degrees, approximately 45-60 degrees, or approximately 45-90 degrees (e.g. between adjacent channels, which may be circumferentially spaced around the axis).

A fifty-second embodiment can include the rotor module of any one of the forty-ninth to fifty-first embodiments, further comprising one or more (e.g. a plurality of) balance masses each configured to fit within the corresponding channel (e.g. to allow for balancing of the rotor module).

A fifty-third embodiment can include the rotor module of any one of the forty-ninth to fifty-second embodiments, wherein each end ring has a plurality of openings configured to align with the balance mass channels (e.g. configured to allow for insertion of a balance mass into the corresponding channel) (e.g. the openings may be similar in size (cross-section), shape (cross-section), and spacing/location (e.g. about the shaft/bore) to the balance mass channels).

A fifty-fourth embodiment can include the rotor module of any one of the first to fifty-third embodiments, further comprising two or more carrier strips, wherein the carrier further comprises two or more carrier slots (which in some embodiments may be some or all of the retaining slots) extending axially therethrough, each configured to receive/retain one of the carrier strips.

A fifty-fifth embodiment can include the rotor module of the fifty-fourth embodiment, wherein each carrier strip extends axially through the corresponding carrier slot to secure the lamination stack into a single/unitary carrier (e.g. axially hold the lamination strips together as a carrier, for example before end rings and/or magnets are retained to form the rotor module) (e.g. without threads and/or using permanent deformation).

A fifty-sixth embodiment can include the rotor module of any one of the fifty-fourth to fifty-fifth embodiments, wherein each of the carrier strips is similar to the retaining strips (e.g. shorter length, but otherwise approximately the same in shape, material, etc.).

A fifty-seventh embodiment can include the rotor module of any one of the fifty-fourth to fifty-sixth embodiments, wherein at least one end of each carrier strip is configured to be permanently deformed (e.g. bent) (e.g. on or in contact with an exterior surface of the carrier and/or an internal surface of one or more of the end rings) in order to retain the lamination stack together as the carrier.

A fifty-eighth embodiment can include the rotor module of any one of the fifty-fourth to fifty-seventh embodiments, wherein both ends of each carrier strip are permanently deformed (e.g. bent).

A fifty-ninth embodiment can include the rotor module of any one of the fifty-fourth to fifty-eighth embodiments, wherein at least one end of each carrier strip is pre-bent (e.g. before the carrier strip is inserted into the corresponding carrier slot).

A sixtieth embodiment can include the rotor module of any one of the fifty-fourth to fifty-ninth embodiments, wherein at least one end of each carrier strip is bent after insertion through the corresponding carrier slot.

A sixty-first embodiment can include the rotor module of any one of the fifty-fourth to sixtieth embodiments, wherein each end ring comprises two or more recesses/indentations on an interior surface, each configured to receive the corresponding bent end (e.g. of the corresponding carrier strip).

A sixty-second embodiment can include the rotor module of the sixty-first embodiment, wherein each recess/indentation has sufficient depth so that the corresponding bent portion of the carrier strip does not extend axially beyond the interior surface of the corresponding end ring (e.g. no portion of the bent end of the carrier strip extends axially out of the recess/indentation on the interior surface of the end ring) (e.g. so that the end ring can be/sit/stack flush with the end of the carrier).

A sixty-third embodiment can include the rotor module of any one of the sixty-first to sixty-second embodiments, wherein each bent end of the carrier strip matches the profile of the corresponding recess/indentation on the interior surface of the end ring (e.g. the profile bend angle may be approximately 70-90 degrees or approximately 80 or 90 degrees).

A sixty-fourth embodiment can include the rotor module of any one of the fifty-seventh to sixty-third embodiments, wherein each bent end of the carrier strip extends radially inward (e.g. the end is bent radially inward) (but does not extend into the bore of the carrier).

A sixty-fifth embodiment can include the rotor module of any one of the fifty-seventh to sixty-fourth embodiments, wherein the carrier strips are bent before attachment of the end rings.

A sixty-sixth embodiment can include the rotor module of any one of the first to sixty-fifth embodiments, further comprising a weld configured to attach one or more (e.g. each) bent end of the retaining strip to the end ring.

A sixty-seventh embodiment can include the rotor module of the sixty-sixth embodiment, wherein the weld comprises a tack or fillet weld.

A sixty-eighth embodiment can include the rotor module of any one of the sixty-sixth to sixty-seventh embodiments, wherein the weld does not extend beyond the recess/indentation (e.g. does not extend axially beyond the exterior surface of the corresponding end ring).

A sixty-ninth embodiment can include the rotor module of any one of the first to sixty-eighth embodiments, wherein the retaining strips comprise carbon steel.

A seventieth embodiment can include the rotor module of any one of the first to sixty-ninth embodiments, wherein the two or more retaining strips comprise four retaining strips, for example disposed in four retaining strip slots (e.g. evenly disposed around the shaft and/or bore).

In a seventy-first embodiment, a rotor module (e.g. configured to be concentrically disposed on a drive shaft (e.g. for an ESP motor) can comprise: a plurality of laminations, each configured to be concentrically disposed on the drive shaft; a plurality of magnets (e.g. half south polarity and half north polarity); two end rings; and a retaining sleeve; wherein: the plurality of laminations are axially stacked to form a carrier (e.g. core) having a plurality of axially-extending grooves (e.g. external pockets), each configured to retain/receive one or more of the plurality of magnets; the magnets are surface/externally mounted on the carrier (e.g. within the grooves); and the retaining sleeve extends concentrically around the carrier and magnets (e.g. encompassing them), and is configured to retain the end rings onto both ends of the carrier (e.g. without threading and/or via permanent deformation and/or via interference fit).

A seventy-second embodiment can include the rotor module of the seventy-first embodiment, wherein the magnets are held within the grooves by the retaining sleeve (e.g. the magnets are radially disposed between and in contact with both the carrier and the sleeve).

A seventy-third embodiment can include the rotor module of any one of the seventy-first to seventy-second embodiments, wherein the grooves and/or magnets are disposed around the drive shaft (e.g. evenly spaced).

A seventy-fourth embodiment can include the rotor module of any one of the seventy-first to seventy-third embodiments, wherein each magnet is a permanent magnet.

A seventy-fifth embodiment can include the rotor module of any one of the seventy-first to seventy-fourth embodiments, wherein each magnet is shaped to fit within the corresponding groove and to be held within the retraining sleeve (e.g. cross-sectional shape corresponds, for example with a curved exterior and a flat interior).

A seventy-sixth embodiment can include the rotor module of any one of the seventy-first to seventy-fifth embodiments, wherein the retaining sleeve is interference fit onto the carrier (and in some further optional embodiments also to the magnets) (e.g. the sleeve holds the magnets in place within the grooves and/or the end rings in place on the ends of the carrier via interference fit).

A seventy-seventh embodiment can include the rotor module of the seventy-sixth embodiment, wherein the interference fit is configured to maintain interference throughout the motor temperature operating range (e.g. up to 220 degrees C.).

A seventy-eighth embodiment can include the rotor module of any one of the seventy-first to seventy-seventh embodiments, wherein an inner surface of the carrier is configured to directly contact and/or couple (e.g. rotationally couple) to the drive shaft (e.g. no inner tube between the carrier and the drive shaft).

A seventy-ninth embodiment can include the rotor module of any one of the seventy-first to seventy-eighth embodiments, wherein both ends of the sleeve extend axially beyond the carrier, and the ends of the sleeve are permanently deformed (e.g. folded inward and/or swaged and/or having inner diameter less than the outer diameter of the end rings and/or carrier) to retain the end rings and/or to form a unitary rotor module.

An eightieth embodiment can include the rotor module of the seventy-ninth embodiment, wherein an exterior surface of each end ring comprises a profiled end (e.g. beveled outer circumference/perimeter).

An eighty-first embodiment can include the rotor module of any one of the seventy-ninth to eightieth embodiments, wherein the swag (e.g. inward folded portion) of the ends of the retaining sleeve matches the profile of the bevel/profiled end of the end ring).

An eighty-second embodiment can include the rotor module of any one of the seventy-ninth to eighty-first embodiments, wherein the swaging/deformation (e.g. radially inward) of each end of the sleeve extends all around the circumference of the sleeve (e.g. the inner diameter of the swaged ends of the sleeve is smaller than the inner diameter of the remainder of the sleeve and/or the outer diameter of the carrier and/or end rings) (e.g. there is contact between the swaged ends of the sleeve and the ends of the carrier substantially around the entire circumference of each end of the carrier).

An eighty-third embodiment can include the rotor module of any one of the seventy-first to eighty-second embodiments, wherein the carrier further comprises a bore (e.g. configured to receive the drive shaft) and/or a rotational connection mechanism (e.g. configured to rotationally couple the rotor module (e.g. carrier) to the shaft) (e.g. a keyway or key configured to rotationally couple to a corresponding key or keyway on the shaft)).

An eighty-fourth embodiment can include the rotor module of any one of the seventy-first to eighty-third embodiments, wherein the sleeve is configured to retain the end rings onto both ends of the carrier when the carrier is compressed and to retain such compression (e.g. pre-compression, for example with the carrier/lamination stack being pre-compressed before swaging of the sleeve by a separate device).

An eighty-fifth embodiment can include the rotor module of any one of the seventy-first to eighty-fourth embodiments, wherein the sleeve has an axial length greater than the pre-compressed length of the carrier with the end rings and/or greater than the compressed length (e.g. the final length) of the carrier with the end rings.

An eighty-sixth embodiment can include the rotor module of any one of the seventy-first to eighty-fifth embodiments, wherein the retaining sleeve extends axially substantially a length of the rotor module.

An eighty-seventh embodiment can include the rotor module of any one of the seventy-first to eighty-sixth embodiments, wherein the retaining sleeve comprises or is composed of non-magnetic material, such as Inconel (e.g. a nickel-chromium superalloy, for example comprising nickel, chromium, iron and a selection of other metals such as cobalt, manganese, copper, niobium, and/or tantalum) or carbon fiber.

An eighty-eighth embodiment can include the rotor module of any one of the seventy-first to eighty-seventh embodiments, wherein the retaining sleeve comprises or is composed of non-magnetic stainless steel (such as 300 series austenitic stainless steel).

An eighty-ninth embodiment can include the rotor module of any one of the seventy-first to eighty-eighth embodiments, wherein the retaining sleeve is formed of only a single material (e.g. a monolithic cylinder/tube).

A ninetieth embodiment can include the rotor module of any one of the seventy-first to eighty-ninth embodiments, wherein the retaining sleeve may be interference fitted (e.g. around the carrier—and in some optional embodiments the magnets) to ensure thermal expansion during operation will not impact the contact area between the carrier and the sleeve.

A ninety-first embodiment can include the rotor module of any one of the seventy-ninth to ninetieth embodiments, wherein the swag provides contact between the sleeve and each end ring around an entire circumference (e.g. entire circumference of the end rings is axially held by the sleeve).

A ninety-second embodiment can include the rotor module of any one of the seventy-ninth to ninety-first embodiments, wherein the swag (e.g. folded-in portion) of each end of the sleeve projects radially inward approximately 2-10 mm.

A ninety-third embodiment can include the rotor module of any one of the seventy-first to ninety-second embodiments, wherein each lamination comprises a thin, magnetically permeable material (e.g. metal).

A ninety-fourth embodiment can include the rotor module of any one of the seventy-first to ninety-third embodiments, wherein each lamination comprises a shaped steel sheet.

A ninety-fifth embodiment can include the rotor module of any one of the seventy-first to ninety-fourth embodiments, wherein each lamination comprises one or more (e.g. a plurality of) clinches (e.g. configured to align when stacked and interlock).

A ninety-sixth embodiment can include the rotor module of any one of the seventy-first to ninety-fifth embodiments, wherein each lamination comprises a bore opening, a rotational connection mechanism (e.g. a key/keyway), a plurality of exterior groove openings (e.g. disposed around the bore opening, typically evenly spaced, which may be formed between connection/contact points (e.g. tabs) of an interior support), and/or a plurality of balance holes (which can form channels for balance rods when the laminations are stacked).

A ninety-seventh embodiment can include the rotor module of the ninety-sixth embodiment, wherein the interior support may be shaped similarly to that of internal magnet embodiments (e.g. FIG. 39) (e.g. fitting within the retaining sleeve in a manner similar to the perimeter wall of FIG. 39A and/or with the retaining sleeve serving as a perimeter wall for retaining the magnets in the grooves of the interior support) and/or as in FIG. 50.

A ninety-eighth embodiment can include the rotor module of any one of the ninety-sixth to ninety-seventh embodiments, wherein the interior support may be configured to span a bore/opening of the retaining sleeve.

A ninety-ninth embodiment can include the rotor module of any one of the seventy-first to ninety-eighth embodiments, wherein the lamination (e.g. interior support) is a single integral unit (e.g. stamped out of a single sheet of material).

A one hundredth embodiment can include the rotor module of any one of the seventy-first to ninety-ninth embodiments, wherein the groove openings may be shaped to match the corresponding magnets (e.g. in cross-section, for example when disposed in the retaining sleeve).

A one hundred first embodiment can include the rotor module of any one of the ninety-sixth to one hundredth embodiments, wherein the interior support may comprise connection/contact points (e.g. tabs extending radially outward) configured to contact the bore/opening of the retaining sleeve and/or to center the lamination/interior support within the bore of the retaining sleeve.

A one hundred second embodiment can include the rotor module of any one of the ninety-sixth to one hundred first embodiments, wherein each groove opening may be disposed between two adjacent contact points/tabs.

A one hundred third embodiment can include the rotor module of any one of the ninety-sixth to one hundred second embodiments, wherein the contact points/tabs and/or groove openings may be spaced evenly around the bore opening.

A one hundred fourth embodiment can include the rotor module of any one of the ninety-sixth to one hundred third embodiments, wherein each contact point/tab has an exterior surface that is curved (e.g. to match the curvature of the bore of the retaining sleeve).

A one hundred fifth embodiment can include the rotor module of any one of the ninety-sixth to one hundred fourth embodiments, wherein the interior support may comprise four contact points/tabs (and four groove openings may be disposed around the bore).

A one hundred sixth embodiment can include the rotor module of any one of the ninety-sixth to one hundred fifth embodiments, wherein a balance hole may be disposed radially inward of or within each contact point.

A one hundred seventh embodiment can include the rotor module of any one of the ninety-sixth to one hundred sixth embodiments, wherein the interior support may comprise a square structure (e.g. having four struts/braces, which may each be arch-shaped (e.g. flat on the outer surface but curved on the inner surface) to match the bore on the inner surface) extending between contact points), with the bore opening disposed therein (e.g. centered within the square).

A one hundred eighth embodiment can include the rotor module of the one hundred seventh embodiment, wherein each strut of the interior support may have a cross-sectional thickness no less than or between approximately 0.5-1 mm.

A one hundred ninth embodiment can include the rotor module of any one of the one hundred seventh to one hundred eighth embodiments, wherein the rotational connection mechanism (e.g. key/keyway) is disposed on the interior (e.g. bore hole) of the interior support (and configured to directly interact with the drive shaft).

A one hundred tenth embodiment can include the rotor module of any one of the one hundred seventh to one hundred ninth embodiments, wherein the one or more clinches comprises a plurality of clinches, which may be evenly spaced around the interior support.

A one hundred eleventh embodiment can include the rotor module of any one of the one hundred seventh to one hundred tenth embodiments, wherein at least one clinch is disposed radially inward from each balance hole and/or contact point.

A one hundred twelfth embodiment can include the rotor module of any one of the one hundred seventh to one hundred eleventh embodiments, wherein at least one (e.g. two) clinches are disposed on each struct of the interior support (e.g. between the contact points at each end).

A one hundred thirteenth embodiment can include the rotor module of any one of the seventy-first to one hundred twelfth embodiments, wherein each lamination is thin and/or may have an axial thickness (e.g. depth which when stacked forms the axial length of the rotor carrier) of approximately 0.3-0.6 mm.

A one hundred fourteenth embodiment can include the rotor module of any one of the seventy-first to one hundred thirteenth embodiments, wherein all of the laminations (e.g. of the carrier/stack) have the same configuration (e.g. size, shape, and/or features) (e.g. are identical, for example with a plurality of laminations being stamped with the same or identical punch from a sheet of material) (e.g. and typically all laminations are oriented identically in the stack, so that their features align axially).

A one hundred fifteenth embodiment can include the rotor module of any one of the seventy-first to one hundred fourteenth embodiments, wherein each end ring has low magnetic permeability.

A one hundred sixteenth embodiment can include the rotor module of any one of the seventy-first to one hundred fifteenth embodiments, wherein each end ring comprises austenitic stainless steel (e.g. 300 series) or Inconel.

A one hundred seventeenth embodiment can include the rotor module of any one of the seventy-first to one hundred sixteenth embodiments, wherein the end rings (e.g. disposed on either axial end of the carrier) can protect the end of the magnets and/or can provide a stop for the carrier and/or magnets (e.g. holding the magnets axially within the pockets/grooves).

A one hundred eighteenth embodiment can include the rotor module of any one of the seventy-first to one hundred seventeenth embodiments, wherein the end rings may be used for rotor balancing purposes in some embodiments (e.g. by either adding weights in dedicated holes or remove weight by drilling).

A one hundred nineteenth embodiment can include the rotor module of any one of the seventy-first to one hundred eighteenth embodiments, wherein each end ring has no recesses/indentations on an inner and/or outer surface (e.g. wherein each end ring is configured to fit flush with the corresponding end of the carrier, for example around the entire circumference and/or is configured to contact the corresponding end of the carrier around the entire circumference).

A one hundred twentieth embodiment can include the rotor module of any one of the seventy-first to one hundred nineteenth embodiments, wherein the magnets do not extend (e.g. axially) into the end rings (e.g. the magnets are entirely disposed between the end rings).

A one hundred twenty-first embodiment can include the rotor module of any one of the seventy-first to one hundred twentieth embodiments, wherein the carrier further comprises a plurality of channels, each extending axially into the active length (e.g. the portion of the carrier with magnets, for example the active length may extend longitudinally/axially) and each configured to retain one of a plurality of balance masses.

A one hundred twenty-second embodiment can include the rotor module of the one hundred twenty-first embodiment, wherein the plurality of channels are configured to be disposed around the drive shaft/longitudinal centerline/axis (e.g. concentrically around the axis).

A one hundred twenty-third embodiment can include the rotor module of any one of the one hundred twenty-first to one hundred twenty-second embodiments, wherein the plurality of channels are evenly spaced around the drive shaft/longitudinal centerline/axis (e.g. spacing of the plurality of channels around the drive shaft/longitudinal centerline/axis ranges from approximately 60-120 degrees, approximately 60-90 degrees, approximately 45-60 degrees, or approximately 45-90 degrees (e.g. between adjacent channels, which may be circumferentially spaced around the axis).

A one hundred twenty-fourth embodiment can include the rotor module of any one of the one hundred twenty-first to one hundred twenty-third embodiments, further comprising one or more (e.g. a plurality of) balance masses each configured to fit within the corresponding channel (e.g. to allow for balancing of the rotor module).

A one hundred twenty-fifth embodiment can include the rotor module of any one of the one hundred twenty-first to one hundred twenty-fourth embodiments, wherein each end ring has a plurality of openings configured to align with the channels (e.g. configured to allow for insertion of a balance mass into the corresponding channel) (e.g. the openings may be similar in size (cross-section), shape (cross-section), and spacing/location (e.g. about the shaft/bore) to the channels).

A one hundred twenty-sixth embodiment can include the rotor module of any one of the seventy-first to one hundred twenty-fifth embodiments, wherein a portion of each lamination (e.g. a portion of the carrier and/or a contact point/tab) between adjacent magnets is configured to contact the interior surface of the sleeve (e.g. and to separate and/or space the magnets circumferentially and/or angularly) (e.g. exterior of the portions matches a curvature of the interior of the sleeve).

A one hundred twenty-seventh embodiment can include the rotor module of any one of the seventy-first to one hundred twenty-sixth embodiments, wherein an exterior of the portions of the laminations/carrier/tabs jointly match the interior surface/circumference of the sleeve (e.g. with full contact all around).

A one hundred twenty-eighth embodiment can include the rotor module of any one of the one hundred twenty-first to one hundred twenty-seventh embodiments, wherein the channels and/or balance rod(s) are disposed in proximity to and/or in the portions of the laminations/carrier.

A one hundred twenty-ninth embodiment can include the rotor module of any one of the seventy-first to one hundred twenty-eighth embodiments, wherein the plurality of laminations are pre-formed into a plurality of carrier subsections each having an axial length approximately equal to a length of the magnets, wherein the plurality of carrier subsections jointly form (e.g. when axially stacked) the carrier (e.g. the carrier comprises a plurality of subsections, wherein each subsections comprises a plurality of laminations axially stacked to form the subsection).

A one hundred thirtieth embodiment can include the rotor module of the one hundred twenty-ninth embodiment, wherein the subsections are configured to hold form as a unit during storage and/or manufacture of the rotor module (e.g. the laminations hold together axially and/or the magnets stay in place within the grooves).

A one hundred thirty-first embodiment can include the rotor module of any one of the one hundred twenty-ninth to one hundred thirtieth embodiments, wherein the clinches of the laminations hold the laminations of each subsection together prior to application of the sleeve (e.g. before assembly of the rotor module).

A one hundred thirty-second embodiment can include the rotor module of any one of the one hundred twenty-ninth to one hundred thirty-first embodiments, wherein the magnets are retained on the carrier subsections prior to application of the sleeve (e.g. before assembly of the rotor module) (for example, the magnets may be bonded to the corresponding carrier subsections, for example using adhesive

A one hundred thirty-third embodiment can include the rotor module of any one of the one hundred twenty-ninth to one hundred thirty-second embodiments, wherein the retaining sleeve (e.g. a single outer sleeve) is disposed around the plurality of carrier subsections (e.g. thereby joining the subsections into a complete rotor module carrier) (although in another embodiment, each subsection may have magnets held by a sleeve outside, and a plurality of subsections can be built into a rotor module held together by strips (e.g. stacked subsections can be joined into a rotor module using retaining strips, similar to the discussion above, for example using a combination of the sleeved rotor module and the rotor module held together by retaining strips).

A one hundred thirty-fourth embodiment can include the rotor module of any one of the one hundred twenty-ninth to one hundred thirty-third embodiments, wherein the retaining sleeve holds the magnets of each subsection onto the corresponding carrier subsection.

A one hundred thirty-fifth embodiment can include the rotor module of any one of the one hundred twenty-ninth to one hundred thirty-fourth embodiments, wherein the retaining sleeve holds the plurality of subsections together as a single, integral rotor module unit (although in another embodiment, each subsection may have magnets held by a sleeve outside or otherwise (such as adhesive), and a plurality of subsections can be built into a rotor module held together by strips (e.g. stacked subsections can be joined into a rotor module using retaining strips, similar to the discussion above, for example using a combination of the sleeved rotor module and the rotor module held together by retaining strips).

In a one hundred thirty-sixth embodiment, a method of assembling/constructing/manufacturing a rotor module can comprise: stacking a plurality of laminations on a mandrel (e.g. which has a diameter approximately equal to that of the drive shaft) to form a carrier (e.g. having axially-extending pockets configured to retain a plurality of magnets); disposing a plurality of magnets within pockets of the carrier (e.g. wherein each magnet is disposed in a corresponding pocket);

disposing an end ring at each end of the carrier (e.g. with one of the end rings contacting each end of the carrier); (externally) compressing the laminations and end rings axially (e.g. using separate compression tooling and/or not provided by any part of the rotor module—e.g. not provided by screw threads of a rotor module element); inserting a plurality of retaining strips into corresponding (axially-extending) slots within the carrier (e.g. and through aligned openings in the end rings), wherein the retaining strips extend axially through the end rings and the carrier (this may occur before compressing in some embodiments); permanently deforming (e.g. bending) one or more end of each retaining strip (e.g. to fix the compressed axial length of the lamination stack/carrier/rotor module and/or to form the end rings and carrier into a unitary rotor module); and removing/releasing the (e.g. external) compression (e.g. by removing compression tooling from the carrier, wherein the formed rotor module can maintain the compression internally, even after release of the external compression) (e.g. without screw threading).

A one hundred thirty-seventh embodiment can include the method of the one hundred thirty-sixth embodiment, wherein the permanently deformed (e.g. bent) one or more ends of each retaining strip secures/retains the end rings onto both ends of the carrier and/or secures the lamination stack into a unitary carrier (e.g. without threading).

A one hundred thirty-eighth embodiment can include the method of any one of the one hundred thirty-sixth to one hundred thirty-seventh embodiments, wherein upon releasing the (external) compression, the rotor module retains its compressed axial length (e.g. with the retaining strips retaining the compressed axial length).

A one hundred thirty-ninth embodiment can include the method of any one of the one hundred thirty-sixth to one hundred thirty-eighth embodiments, wherein the rotor module has no threading (e.g. no screw threads on the retaining strips and/or no inner support tube (e.g. between the carrier and the drive shaft and/or having screw threads)) (e.g. wherein each retaining strip is free of screw threading).

A one hundred fortieth embodiment can include the method of any one of the one hundred thirty-sixth to one hundred thirty-ninth embodiments, further comprising providing, by the retaining strips, a compression spring force on the carrier and end rings.

A one hundred forty-first embodiment can include the method of any one of the one hundred thirty-sixth to one hundred fortieth embodiments, wherein the retaining strips each comprise spring steel.

A one hundred forty-second embodiment can include the method of any one of the one hundred thirty-sixth to one hundred forty-first embodiments, wherein disposing an end ring at each end of the carrier comprises orienting the end ring so that the corresponding permanently deformed (e.g. bent) end of each retaining strip is disposed within a recess/indentation on an exterior surface of the end ring.

A one hundred forty-third embodiment can include the method of the one hundred forty-second embodiment, wherein permanently deforming (e.g. bending) one or more end of each retaining strip comprises disposing the one or more end in the corresponding recess/indentation.

A one hundred forty-forth embodiment can include the method of any one of the one hundred thirty-sixth to one hundred forty-third embodiments, wherein an angle of bend of the one or more end of the retaining strip matches a profile of the exterior surface of the end ring.

A one hundred forty-fifth embodiment can include the method of any one of the one hundred forty-second to one hundred forty-fourth embodiments, wherein an angle of bend of the one or more end of the retaining strip matches a profile of the corresponding recess/indentation of the end ring.

A one hundred forty-sixth embodiment can include the method of the one hundred forty-fifth embodiment, wherein the angle of bend is approximately 70-90 degrees, approximately 80-90 degrees, or approximately 70-80 degrees (e.g. approximately 80 or 90 degrees).

A one hundred forty-seventh embodiment can include the method of any one of the one hundred thirty-sixth to one hundred forty-sixth embodiments, wherein each lamination is configured to be concentrically disposed on a drive shaft.

A one hundred forty-eighth embodiment can include the method of any one of the one hundred thirty-sixth to one hundred forty-seventh embodiments, further comprising removing the mandrel (e.g. from the formed carrier and/or rotor module).

A one hundred forty-ninth embodiment can include the method of any one of the one hundred forty-second to one hundred forty-eighth embodiments, wherein the bent end of the one or more retaining strip does not extend axially beyond the recess/indentation (e.g. does not extend axially beyond the exterior surface of the end ring).

A one hundred fiftieth embodiment can include the method of any one of the one hundred thirty-sixth to one hundred forty-ninth embodiments, further comprising welding the permanently deformed (e.g. bent) end of one or more retaining strip (e.g. to the corresponding end ring).

A one hundred fifty-first embodiment can include the method of the one hundred fiftieth embodiments, wherein the welded end of the one or more retaining strip does not extend beyond the recess/indentation (e.g. does not extend axially beyond the exterior surface of the end ring).

A one hundred fifty-second embodiment can include the method of any one of the one hundred thirty-sixth to one hundred fifty-first embodiments, wherein each retaining strip initially has one pre-bent end (e.g. non-straight end) and one un-bent end (e.g. straight end), and permanently deforming (e.g. bending) one or more end of each retaining strip comprises permanently deforming (e.g. bending) the un-bent end.

A one hundred fifty-third embodiment can include the method of any one of the one hundred thirty-sixth to one hundred fifty-second embodiments, wherein the angle of bend of the pre-bent end of the retaining strip matches a profile of the exterior surface of the end ring.

A one hundred fifty-fourth embodiment can include the method of any one of the one hundred forty-second to one hundred fifty-third embodiments, wherein the angle of bend of the pre-bent end of the retaining strip matches a profile of the corresponding recess/indentation of the end ring.

A one hundred fifty-fifth embodiment can include the method of any one of the one hundred thirty-sixth to one hundred fifty-fourth embodiments, wherein upon permanently deforming (e.g. bending) the un-bent end, the un-bent end and the pre-bent end have approximately the same angle of bend.

A one hundred fifty-sixth embodiment can include the method of any one of the one hundred thirty-sixth to one hundred fifty-fifth embodiments, wherein inserting a plurality of retaining strips into corresponding (axially-extending) slots within the carrier comprises inserting the un-bent end through a first one of the end rings, through the corresponding slot in the carrier, and through the second one of the end rings.

A one hundred fifty-seventh embodiment can include the method of the one hundred fifty-sixth embodiment, wherein the pre-bent end contacts the exterior surface of the first end ring.

A one hundred fifty-eighth embodiment can include the method of any one of the one hundred thirty-sixth to one hundred fifty-seventh embodiments, wherein each retaining strip initially has two un-bent ends (e.g. straight ends), and permanently deforming (e.g. bending) one or more end of each retaining strip comprises permanently deforming (e.g. bending) both un-bent ends (e.g. after insertion into the slots and end rings).

A one hundred fifty-ninth embodiment can include the method of any one of the one hundred thirty-sixth to one hundred fifty-eighth embodiments, wherein the compression tool also bends the one or more end of the retaining strip (e.g. during or after external compression, provided by the compression tooling, for example using pivoting arms-see for example FIG. 57A, or profiled surface-see for example FIG. 58A).

A one hundred sixtieth embodiment can include the method of any one of the one hundred thirty-sixth to one hundred fifty-ninth embodiments, further comprising inserting a plurality of carrier strips into corresponding slots within the carrier, wherein the carrier strips extend axially through the carrier (but not the end rings); and permanently deforming (e.g. bending) one or more end of each carrier strip (to secure the lamination stack into a unitary carrier).

A one hundred sixty-first embodiment can include the method of the one hundred sixtieth embodiment, wherein inserting a plurality of carrier strips occurs before disposing end rings (e.g. when there are no end rings attached and/or contacting the ends of the carrier).

A one hundred sixty-second embodiment can include the method of any one of the one hundred sixtieth to one hundred sixty-first embodiments, wherein each carrier strip is free of screw threading.

A one hundred sixty-third embodiment can include the method of any one of the one hundred sixtieth to one hundred sixty-second embodiments, wherein disposing an end ring at each end of the carrier comprises orienting the end ring so that the corresponding permanently deformed (e.g. bent) end of each carrier strip is disposed within a recess/indentation on an interior surface of the end ring.

A one hundred sixty-fourth embodiment can include the method of the one hundred sixty-third embodiment, wherein an angle of bend of the one or more end of the carrier strip matches a profile of a corresponding recess/indentation on the interior surface of the end ring.

A one hundred sixty-fifth embodiment can include the method of any one of the one hundred sixtieth to one hundred sixty-fourth embodiments, wherein a bent end of each carrier strip does not extend axially beyond the recess/indentation on the interior of the end ring (e.g. does not extend axially beyond the interior surface of the end ring).

A one hundred sixty-sixth embodiment can include the method of any one of the one hundred sixtieth to one hundred sixty-fifth embodiments, wherein each carrier strip comprises a rectangular cross-section.

A one hundred sixty-seventh embodiment can include the method of any one of the one hundred sixtieth to one hundred sixty-sixth embodiments, wherein each carrier strip initially has one pre-bent end (e.g. non-straight end) and one un-bent end (e.g. straight end), and permanently deforming (e.g. bending) one or more end of each carrier strip comprises permanently deforming (e.g. bending) the un-bent end.

A one hundred sixty-eighth embodiment can include the method of the one hundred sixty-seventh embodiment, wherein the angle of bend of the pre-bent end of the carrier strip matches a profile of the exterior surface of the carrier and/or matches a profile of an interior surface of the end ring.

A one hundred sixty-ninth embodiment can include the method of any one of the one hundred sixty-seventh to one hundred sixty-eighth embodiments, wherein the angle of bend of the pre-bent end of the carrier strip matches a profile of the corresponding recess/indentation on the internal surface of the end ring.

A one hundred seventieth embodiment can include the method of any one of the one hundred sixty-seventh to one hundred sixty-ninth embodiments, wherein upon permanently deforming (e.g. bending) the un-bent end, the un-bent end and the pre-bent end of the carrier strip have approximately the same angle of bend.

A one hundred seventy-first embodiment can include the method of any one of the one hundred sixty-seventh to one hundred seventieth embodiments, wherein inserting a plurality of carrier strips into corresponding (axially-extending) slots within the carrier comprises inserting the un-bent end of the carrier strip through a first one of the end rings, through the corresponding slot in the carrier, and through a second one of the end rings.

A one hundred seventy-second embodiment can include the method of the one hundred seventy-first embodiment, wherein the pre-bent end of the carrier strip contacts the exterior surface of the first end ring.

A one hundred seventy-third embodiment can include the method of any one of the one hundred sixtieth to one hundred sixty-sixth embodiments, wherein each carrier strip initially has two un-bent ends (e.g. straight ends), and permanently deforming (e.g. bending) one or more end of each carrier strip comprises permanently deforming (e.g. bending) both un-bent ends.

A one hundred seventy-fourth embodiment can include the method of any one of the one hundred sixtieth to one hundred seventy-third embodiments, wherein the same compression tooling is used to compress and bend the ends of the carrier strips (e.g. as is used to compress and bend the ends of the retaining strips) (e.g. the compression tooling initially bends the one or more end of each carrier strips, and then bends the one or more end of each retaining strip (e.g. after rotation of the rotor module/carrier within the compression tooling and/or repositioning (e.g. by angular displacement/rotation) of the rotor module/carrier within the compression tooling)) (e.g. wherein the compression tool also bends the one or more end of the carrier strip (e.g. during or after external compression) (in addition to bending the retaining strips)).

A one hundred seventy-fifth embodiment can include the method of any one of the one hundred thirty-sixth to one hundred seventy-fourth embodiments, further comprising balancing the rotor module (e.g. before removing the mandrel and/or after the end rings are attached to the ends of the carrier).

A one hundred seventy-sixth embodiment can include the method of the one hundred seventy-fifth embodiment, wherein balancing the rotor module comprises inserting one or more balance rods axially into an active length of the rotor module (e.g. into the portion of the rotor module axial length having magnets) (e.g. into channels in the carrier).

A one hundred seventy-seventh embodiment can include the method of any one of the one hundred thirty-sixth to one hundred seventy-sixth embodiments, further comprising clinching the stacked laminations prior to permanently deforming (e.g. bending) one or more end of each retaining strip and/or prior to permanently deforming (e.g. bending) one or more end of each carrier strip.

A one hundred seventy-eighth embodiment can include the method of the one hundred seventy-seventh embodiments, further comprising aligning the laminations of the stack for clinching (e.g. axially aligning the clinches on each lamination of the stack).

A one hundred seventy-ninth embodiment can include the method of any one of the one hundred thirty-sixth to one hundred seventy-eighth embodiments, wherein (externally) compressing the laminations and end rings axially occurs via hydraulic, pneumatic, electrical, or mechanical press (e.g. the only threading in the system during assembly would be on the separate compression tooling).

A one hundred eightieth embodiment can include the method of any one of the one hundred thirty-sixth to one hundred seventy-ninth embodiments, wherein (externally) compressing the laminations and end rings axially occurs via one or more (e.g. external) screw threading configured to axially displace a press plate of the compression tooling (configured to contact one of the end rings and/or carrier and/or one end of the rotor module).

A one hundred eighty-first embodiment can include the method of any one of the one hundred thirty-sixth to one hundred eightieth embodiments, wherein pivoting arms (e.g. of the compression tooling) bend the ends of the retaining strips and/or carrier strips (e.g. the arms are initially disposed laterally adjacent the straight end, but after pivoting to bend the ends, are disposed above the corresponding bent end) (e.g. one arm positioned with respect to each strip end).

A one hundred eighty-second embodiment can include the method of any one of the one hundred thirty-sixth to one hundred eighty-first embodiments, wherein (externally) compressing the laminations and end rings axially occurs before (e.g. and is held during) permanently deforming (e.g. bending) one or more end of each retaining strip and/or before permanently deforming (e.g. bending) one or more end of each carrier strip.

A one hundred eighty-third embodiment can include the method of any one of the one hundred thirty-sixth to one hundred eighty-second embodiments, further comprising disposing the mandrel (e.g. with the stacked laminations) within the compression tooling (e.g. prior to compression).

In a one hundred eighty-fourth embodiment, a method of assembling/constructing a rotor module, comprising: stacking a plurality of laminations on a mandrel (e.g. which has a diameter approximately equal to that of the drive shaft) to form a carrier (e.g. having axially-extending external pockets/grooves configured to retain a plurality of magnets); disposing a plurality of magnets within grooves of the carrier (e.g. wherein each magnet is disposed (e.g. surface mounted) in a corresponding groove); disposing an end ring at each end of the carrier (e.g. with one of the end rings contacting each end of the carrier); (externally) compressing the laminations/carrier and end rings axially (e.g. using separate compression tooling and/or not provided by any part of the rotor module—e.g. not provided by screw threads of a rotor module element); disposing a retaining sleeve around the carrier and end rings; and permanently deforming (e.g. swaging and/or folding radially inward) an end of the retaining sleeve (e.g. to fix the compressed axial length of the lamination stack/carrier/rotor module and/or to secure the end rings to the carrier, and/or to hold the magnets in place, and/or to form the end rings and carrier into a unitary rotor module).

A one hundred eighty-fifth embodiment can include the method of the one hundred eighty-fourth embodiment, further comprising releasing the (e.g. external) compression (e.g. by removing compression tooling from the carrier).

A one hundred eighty-sixth embodiment can include the method of any one of the one hundred eighty-fourth to one hundred eighty-fifth embodiments, wherein disposing the retaining sleeve around the carrier and end rings comprises compressing the carrier and end rings axially into the retaining sleeve (e.g. using the same external compression above).

A one hundred eighty-seventh embodiment can include the method of any one of the one hundred eighty-fourth to one hundred eighty-sixth embodiments, wherein (externally) compressing the laminations/carrier and end rings axially comprises two-stage compression.

A one hundred eighty-eighth embodiment can include the method of the one hundred eighty-seventh embodiment, wherein a first stage of compression compresses just the lamination stack/carrier and end rings (e.g. compressing them axially into the retaining sleeve), and the second stage of compression compresses the end(s) of the retaining sleeve (e.g. to sway the end(s) of the sleeve).

A one hundred eighty-ninth embodiment can include the method of the one hundred eighty-eighth embodiment, wherein the first stage of compression is radially inward of the second stage of compression.

A one hundred ninetieth embodiment can include the method of any one of the one hundred eighty-eighth to one hundred eighty-ninth embodiments, wherein the first stage of compression is planar (e.g. using a flat press plate), and the second stage of compression comprises an angled compression (e.g. configured to swag the end of the sleeve and/or using a press plate having an angled/beveled portion (e.g. around the perimeter circumference)).

A one hundred ninety-first embodiment can include the method of any one of the one hundred eighty-fourth to one hundred ninetieth embodiments, wherein both ends of the retaining sleeve are simultaneously swaged (e.g. by the second stage of compression).

A one hundred ninety-second embodiment can include the method of any one of the one hundred eighty-fourth to one hundred ninety-first embodiments, wherein the retaining sleeve provides interference fit.

A one hundred ninety-third embodiment can include the method of any one of the one hundred eighty-fourth to one hundred ninety-second embodiments, wherein the retaining sleeve secures the end rings to the carrier using both interference fit and swaged ends.

A one hundred ninety-fourth embodiment can include the method of any one of the one hundred eighty-fourth to one hundred ninety-third embodiments, further comprising permanently deforming (e.g. swaging and/or folding radially inward) a second end of the retaining sleeve (e.g. so that the swaged ends of the sleeve axially secure the end rings to the carrier and/or retain the compressed axial length of the stacked laminations/carrier) (e.g. after rotation of the carrier in the compression device).

A one hundred ninety-fifth embodiment can include the method of any one of the one hundred eighty-fourth to one hundred ninety-fourth embodiments, wherein permanently deforming (e.g. swaging and/or folding radially inward) an end of the retaining sleeve comprises bending the end of the sleeve radially inward around a circumference of the sleeve and/or end ring (e.g. so that the end of the sleeve contacts substantially the entire circumference of an exterior surface of the end ring).

A one hundred ninety-sixth embodiment can include the method of any one of the one hundred eighty-fourth to one hundred ninety-fifth embodiments, wherein an exterior surface of the end ring comprises a bevel/profiled end, and the bent end of the sleeve (e.g. an angle of bend of the bent end of the sleeve) approximately matches a profile of the bevel/profiled end of the end ring (e.g. all around the circumference of the sleeve and/or end ring) (or alternately, there may be a groove or indentation on the side of the end rings, into which the bend of the sleeve can fit, for example around the entire circumference).

A one hundred ninety-seventh embodiment can include the method of any one of the one hundred eighty-fourth to one hundred ninety-sixth embodiments, wherein the magnets are surface mounted on the carrier (e.g. disposed between and held radially by the carrier and the retaining sleeve).

A one hundred ninety-eighth embodiment can include the method of any one of the one hundred eighty-fourth to one hundred ninety-seventh embodiments, wherein upon releasing the (external) compression, the rotor module retains its compressed axial length (e.g. with the retaining sleeve retaining the compressed axial length, for example between its swaged ends).

A one hundred ninety-ninth embodiment can include the method of any one of the one hundred eighty-fourth to one hundred ninety-eighth embodiments, wherein the rotor module has no threading (e.g. no screw threads on the retaining sleeve and/or no inner support tube (e.g. between the carrier and the drive shaft and/or having screw threads)).

A two hundredth embodiment can include the method of any one of the one hundred eighty-fourth to one hundred ninety-ninth embodiments, wherein the angle of bend is approximately 70-90 degrees, approximately 80-90 degrees, or approximately 70-80 degrees (e.g. approximately 80 or 90 degrees).

A two hundred first embodiment can include the method of any one of the one hundred eighty-fourth to two hundredth embodiments, wherein each lamination is configured to be concentrically disposed on a drive shaft.

A two hundred second embodiment can include the method of any one of the one hundred eighty-fourth to two hundred first embodiments, further comprising removing the mandrel (e.g. from the formed carrier and/or rotor module).

A two hundred third embodiment can include the method of any one of the one hundred eighty-fourth to two hundred second embodiments, further comprising inserting a plurality of carrier strips into corresponding slots within the carrier, wherein the carrier strips extend axially through the carrier (but not the end rings); and permanently deforming (e.g. bending) one or more end of each carrier strip (to secure the lamination stack into a unitary carrier).

A two hundred fourth embodiment can include the method of the two hundred third embodiment, wherein inserting a plurality of carrier strips occurs before disposing end rings (e.g. when there are no end rings attached and/or contacting the ends of the carrier).

A two hundred fifth embodiment can include the method of any one of the two hundred third to two hundred fourth embodiments, wherein each carrier strip is free of screw threading.

A two hundred sixth embodiment can include the method of any one of the two hundred third to two hundred fifth embodiments, wherein disposing an end ring at each end of the carrier comprises orienting the end ring so that the corresponding permanently deformed (e.g. bent) end of each carrier strip is disposed within a recess/indentation on an interior surface of the end ring.

A two hundred seventh embodiment can include the method of any one of the two hundred third to two hundred sixth embodiments, wherein an angle of bend of the one or more end of the carrier strip matches a profile of a corresponding recess/indentation on the interior surface of the end ring.

A two hundred eighth embodiment can include the method of any one of the two hundred third to two hundred seventh embodiments, wherein a bent end of each carrier strip does not extend axially beyond the recess/indentation on the interior of the end ring (e.g. does not extend axially beyond the interior surface of the end ring).

A two hundred ninth embodiment can include the method of any one of the two hundred third to two hundred eighth embodiments, wherein each carrier strip comprises a rectangular cross-section.

A two hundred tenth embodiment can include the method of any one of the two hundred third to two hundred ninth embodiments, wherein each carrier strip initially has one pre-bent end (e.g. non-straight end) and one un-bent end (e.g. straight end), and permanently deforming (e.g. bending) one or more end of each carrier strip comprises permanently deforming (e.g. bending) the un-bent end.

A two hundred eleventh embodiment can include the method of the two hundred tenth embodiment, wherein the angle of bend of the pre-bent end of the carrier strip matches a profile of the exterior surface of the carrier and/or matches a profile of an interior surface of the end ring.

A two hundred twelfth embodiment can include the method of any one of the two hundred tenth to two hundred eleventh embodiments, wherein the angle of bend of the pre-bent end of the carrier strip matches a profile of the corresponding recess/indentation on the internal surface of the end ring.

A two hundred thirteenth embodiment can include the method of any one of the two hundred tenth to two hundred twelfth embodiments, wherein upon permanently deforming (e.g. bending) the un-bent end, the un-bent end and the pre-bent end of the carrier strip have approximately the same angle of bend.

A two hundred fourteenth embodiment can include the method of any one of the two hundred tenth to two hundred thirteenth embodiments, wherein inserting a plurality of carrier strips into corresponding (axially-extending) slots within the carrier comprises inserting the un-bent end of the carrier strip through a first one of the end rings, through the corresponding slot in the carrier, and through a second one of the end rings.

A two hundred fifteenth embodiment can include the method of any one of the two hundred tenth to two hundred fourteenth embodiments, wherein the pre-bent end of the carrier strip contacts the exterior surface of the first end ring.

A two hundred sixteenth embodiment can include the method of any one of the two hundred third to two hundred ninth embodiments, wherein each carrier strip initially has two un-bent ends (e.g. straight ends), and permanently deforming (e.g. bending) one or more end of each carrier strip comprises permanently deforming (e.g. bending) both un-bent ends.

A two hundred seventeenth embodiment can include the method of any one of the one hundred eighty-fourth to two hundred sixteenth embodiments, further comprising balancing the rotor module (e.g. before removing the mandrel and/or after the end rings are attached to the ends of the carrier).

A two hundred eighteenth embodiment can include the method of the two hundred seventeenth embodiments, wherein balancing the rotor module comprises inserting one or more balance rods axially into an active length of the rotor module (e.g. into the portion of the rotor module axial length having magnets).

A two hundred nineteenth embodiment can include the method of any one of the one hundred eighty-fourth to two hundred eighteenth embodiments, further comprising clinching the stacked laminations prior to permanently deforming (e.g. bending) one or more end of the retaining sleeve and/or prior to permanently deforming (e.g. bending) one or more end of each carrier strip.

A two hundred twentieth embodiment can include the method of the two hundred nineteenth embodiment, further comprising aligning the laminations of the stack for clinching (e.g. axially aligning the clinches on each lamination of the stack).

A two hundred twenty-first embodiment can include the method of any one of the one hundred eighty-fourth to two hundred twentieth embodiments, wherein (externally) compressing the laminations and end rings axially occurs via hydraulic, pneumatic, electrical, or mechanical press (e.g. the only threading in the system during assembly would be on the separate compression tooling).

A two hundred twenty-second embodiment can include the method of any one of the one hundred eighty-fourth to two hundred twenty-first embodiments, wherein stacking a plurality of laminations on a mandrel to form a carrier comprises stacking a portion of the plurality of laminations to form a plurality of carrier subsections.

A two hundred twenty-third embodiment can include the method of the two hundred twenty-second embodiments, wherein each carrier subsection has an axial length approximately equal to that of the corresponding magnet.

A two hundred twenty-fourth embodiment can include the method of any one of the two hundred twenty-second to two hundred twenty-third embodiments, wherein the plurality of carrier subsections are stored (e.g. until needed to manufacture a rotor module).

A two hundred twenty-fifth embodiment can include the method of any one of the two hundred twenty-second to two hundred twenty-fourth embodiments, further comprising stacking a plurality of carrier subsections onto the mandrel to form the (e.g. complete) carrier.

A two hundred twenty-sixth embodiment can include the method of any one of the two hundred twenty-second to two hundred twenty-third embodiments, further comprising disposing the corresponding magnets onto each carrier subsection.

A two hundred twenty-seventh embodiment can include the method of any one of the two hundred twenty-second to two hundred twenty-sixth embodiments, wherein disposing the corresponding magnets are disposed within grooves of the carrier subsection (e.g. wherein each magnet is disposed in a corresponding groove).

A two hundred twenty-eighth embodiment can include the method of any one of the two hundred twenty-second to two hundred twenty-seventh embodiments, wherein disposing the corresponding magnets onto each carrier subsection comprises affixing/attaching the magnets to the corresponding carrier subsection.

A two hundred twenty-ninth embodiment can include the method of any one of the two hundred twenty-second to two hundred twenty-eighth embodiments, wherein the retaining sleeve joins the carrier subsections into a complete carrier.

In a two-hundred thirtieth embodiment, a rotor (e.g. for an ESP motor) can comprise a plurality of rotor modules concentrically disposed on a drive shaft, wherein at least one (e.g. each) rotor module comprises one of the first to one hundred thirty-fifth embodiments (e.g. wherein the plurality of rotor modules are stacked axially on the drive shaft (e.g. in some embodiments with radial bearings disposed therebetween) and/or are fixed to the shaft so that the shaft and the rotor modules rotate as one).

A two hundred thirty-first embodiment can include the rotor of the two hundred thirtieth embodiment, wherein each of the rotor modules is balanced (e.g. sufficiently to meet a standard).

In a two hundred thirty-second embodiment, an ESP assembly comprises an electric motor coupled to a pump, wherein any one of the rotor modules or rotors of the first to one hundred thirty-fifth or two-hundred thirtieth to two hundred thirty first embodiments are in the motor.

In a two-hundred thirty-third embodiment, a system comprising the ESP assembly of the two hundred thirty-second embodiment disposed downhole in a well.

A two hundred thirty-fourth embodiment can include the method of any one of the one hundred thirty-sixth to one hundred eighty-third embodiments, wherein the rotor module comprises any one of the first to seventieth embodiments; or can include the method of any one of the one hundred eighty-fourth to two hundred twenty-ninth embodiments, wherein the rotor module comprises any one of the seventy-first to one hundred thirty-fifth embodiments.

In a two-hundred thirty-fifth embodiment, a method of operating an ESP assembly (e.g. similar to the two hundred thirty-second embodiment), comprising: using the method of the two hundred thirty-fourth embodiment to form one or more rotor modules (e.g. similar to the any one of the first to one hundred thirty-fifth embodiments); disposing the one or more rotor modules concentrically on the drive shaft of an electric motor (e.g. axially stacking the rotor modules and/or and fixing their rotational position with respect to the drive shaft); disposing a stator concentrically around the plurality of rotor modules; coupling the drive shaft to a pump to form the ESP assembly; electrically connecting the stator and/or rotor to a power source for operation of the motor; disposing the ESP assembly downhole in a well; and/or using the ESP assembly to pump fluid uphole (e.g. towards the surface).

A two-hundred thirty-sixth embodiment can comprise the method of the two hundred thirty-fifth embodiment, further comprising removing pre-existing rotor modules ((e.g. conventional modules, not according to one or more disclosed embodiments and/or having screw threading to retain the end rings in place) to be replaced (e.g. during retrofit) by the disclosed rotor modules).

A two-hundred thirty-seventh embodiment can comprise the method of the two hundred thirty-sixth embodiment, wherein removing the pre-existing rotor modules occurs either at a designated end-of-service-life or when there is a failure.

A two-hundred thirty-eighth embodiment can comprise the method of the two hundred thirty-sixth or two hundred thirty-seventh embodiment, wherein removing the pre-existing rotor modules occurs to improve the performance of the motor (e.g. when there is a desire or need for improved performance which can be achieved using the disclosed modules). A two-hundred thirty-ninth embodiment can comprise the method of any one of the two hundred thirty-sixth to two hundred thirty eighth embodiments, wherein the pre-existing rotor modules are induction type.

A two-hundred fortieth embodiment can comprise the method of any one of the two hundred thirty-sixth to two hundred thirty ninth embodiments, wherein the pre-existing rotor module comprises screw threading (e.g. to attach the end rings to the lamination stack or carrier).

A two-hundred forty-first embodiment can comprise the method of any one of the two hundred thirty-sixth to two hundred fortieth embodiments, further comprising unscrewing the screw threading retaining element of the one or more pre-existing rotor module, discarding the screw threading retaining element, and replacing it with a permanent deformation retaining element (e.g. retaining strips or retaining sleeve).

A two-hundred forty-second embodiment can include the method of any one of one hundred thirty-sixth to one hundred eighty-third embodiments, using a device/compression tool similar to FIGS. 57A-B and/or FIG. 58A-B (e.g. to compress laminations and/or bend strip ends, e.g. to form a rotor module similar to any one of the first to seventieth embodiments).

A two-hundred forty-third embodiment can include the method of any one of one hundred eighty-fourth to two hundred twenty-ninth embodiments, using a device/compression tool similar to FIGS. 59A-B (e.g. to compress laminations and/or swag/fold the retaining sleeve, e.g. to form a rotor module similar to any one of the seventy-first to one hundred thirty-fifth embodiments).

A two-hundred forty-fourth embodiment can include the rotor module of the seventy-ninth embodiment, wherein the end rings have an indentation/groove/divot (e.g. recessed taper) on the side surface configured to receive the bent end of the sleeve (which may be swaged around the entire circumference in some embodiments or may be swaged at only discrete locations around the circumference in other embodiments).

A two-hundred forty-fifth embodiment can include the rotor module of any one of the seventy-first to one hundred thirty-fifth embodiments, further comprising carrier strips configured to hold the lamination stack together (but not the end rings).

A two-hundred forty-sixth embodiment can include the method of any one of the one hundred eighty-fourth to one hundred ninety-fourth embodiments, wherein permanently deforming the ends of the sleeve can comprise swaging (e.g. permanently deforming) only at discrete locations around the circumference of the sleeve (e.g. corresponding to countersink holes/indentations on the side surface of the end rings).

In a two hundred forty-seventh embodiment, a rotor module (e.g. configured to be concentrically disposed on a drive shaft for an ESP motor) can comprise: a plurality of module subsections each comprising: a plurality of laminations (e.g. each configured to be concentrically disposed on the drive shaft) axially stacked to form a carrier subsection, a plurality of magnets, and an external sleeve; and a retaining mechanism; wherein: each carrier subsection comprises a plurality of axially-extending grooves, each configured to receive one or more of the plurality of magnets; the plurality of magnets are surface mounted on the corresponding carrier subsection within the grooves; an axial length of the external sleeve for each module subsection is approximately the same as that of the corresponding carrier subsection and/or the external sleeve extends concentrically around the corresponding carrier subsection and the corresponding magnets (e.g. to hold the magnets within the grooves in the carrier subsection); and the plurality of module subsections are joined/coupled together in an axial stack (e.g. to form the rotor module) by the retaining mechanism.

A two hundred forty-eighth embodiment can include the rotor module of the two hundred forty-seventh embodiment, wherein the retaining mechanism is configured to axially fix the module subsections together (e.g. to form a unitary rotor module).

A two hundred forty-ninth embodiment can include the rotor module of any one of the two hundred forty-seventh to two hundred forty-eighth embodiments, wherein the retaining mechanism comprises two or more retaining strips and two end rings disposed at opposite ends of the axial stack of module subsections.

A two hundred fiftieth embodiment can include the rotor module of the two hundred forty-ninth embodiment, wherein the two or more retaining strips axially fix/couple the end rings and module subsections together (e.g. with the axial stack of module subsections disposed between the end rings and/or compressed between the end rings).

A two hundred fifty-first embodiment can include the rotor module of any one of the two hundred forty-ninth to two hundred fiftieth embodiments, wherein each retaining strip extends axially through corresponding holes in the end rings and aligned slots in the axial stack of module subsections.

A two hundred fifty-second embodiment can include the rotor module of any one of the two hundred forty-ninth to two hundred fifty-first embodiments, wherein the two or more retaining strips are configured to retain the end rings onto both ends of the axial stack of module subsections using permanent deformation of one or more end of the strip.

In a two hundred fifty-third embodiment, a method of assembling a rotor module (e.g. for use on a drive shaft of an ESP motor), can comprise: axially stacking a plurality of module subsections (e.g. on a mandrel); disposing an end ring at each end of the axial stack of module subsections; inserting a plurality of retaining strips into corresponding slots with the axial stack of module subsections, wherein the retaining strips each extend axially through the end rings and the stack of module subsections; compressing (e.g. externally) the axial stack of module subsections and end rings; and permanently deforming one or more end of each retaining strip, wherein the permanently deformed one or more end of each retaining strip retains the end rings onto both ends of the axial stack of module subsections (e.g. to form the rotor module).

A two hundred fifty-fourth embodiment can include the method of the two hundred fifty-third embodiment, further comprising releasing the (e.g. external) compression and/or removing the mandrel.

A two hundred fifty-fifth embodiment can include the method of any one of the two hundred fifty-third to two hundred fifty-fourth embodiments, wherein each module subsection comprises: a plurality of laminations (each configured to be concentrically disposed on the drive shaft) axially stacked to form a carrier subsection; a plurality of magnets; and an external sleeve; wherein: each carrier subsection comprises a plurality of axially-extending grooves, each configured to receive one or more of the plurality of magnets; the plurality of magnets are surface mounted on the corresponding carrier subsection within the grooves; and an axial length of the external sleeve for each module subsection is approximately the same as that of the corresponding carrier subsection and/or the external sleeve extends concentrically around the corresponding carrier subsection and the corresponding magnets (e.g. to hold the magnets within the grooves in the carrier subsection).

A two hundred fifty-sixth embodiment can include the method of any one of the two hundred fifty-third to two hundred fifty-fifth embodiments, further comprising forming each of the plurality of module subsections.

A two hundred fifty-seventh embodiment can include the method of the two hundred fifty-sixth embodiment, wherein forming each of the plurality of module subsections comprises: axially stacking (e.g. on a mandrel) a plurality of laminations to form a carrier subsection; disposing magnets within axially extending grooves of the corresponding carrier subsection; and disposing an external sleeve around the carrier subsection and corresponding magnets.

A two hundred fifty-eighth embodiment can include the method of the two hundred fifty-seventh embodiment, further comprising compressing the plurality of laminations.

A two hundred fifty-ninth embodiment can include the method of the two hundred fifty-seventh or two hundred fifth eighth embodiments, further comprising releasing the (e.g. external) compression, removing the mandrel, and/or storing the module subsections (e.g. for later use assembling the rotor module) (e.g. where the module subsections may be pe-assembled and/or stored well in advance of the rotor module assembly (e.g. stacking of module subsections), for example more than a day, more than a week, or more than a month).

While embodiments have been shown and described, modifications thereof can be made by one skilled in the art without departing from the spirit and teachings of this disclosure. The embodiments described herein are exemplary only and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru−RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded. The use of the terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. A rotor module configured to be concentrically disposed on a drive shaft for an ESP motor comprises:
a plurality of laminations, each configured to be concentrically disposed on the drive shaft;
a plurality of magnets;
two end rings; and
a retaining sleeve;
wherein:
the plurality of laminations are axially stacked to form a carrier having a plurality of axially-extending grooves, each configured to receive one or more of the plurality of magnets;
the plurality of magnets are surface mounted on the carrier within the grooves; and
the retaining sleeve extends concentrically around the carrier and the plurality of magnets, and is configured to retain the end rings onto both ends of the carrier without threading.

2. The rotor module of claim 1, wherein the retaining sleeve is interference fit onto the carrier and the end rings.

3. The rotor module of claim 2, wherein the interference fit is configured to maintain interference throughout a motor temperature operating range of the ESP motor.

4. The rotor module of claim 1, wherein both ends of the retaining sleeve extend axially beyond the carrier, and the ends of the retaining sleeve are permanently deformed to retain each end ring on the corresponding end of the carrier.

5. The rotor module of claim 4, wherein:
an exterior surface of each end ring comprises a profiled surface; and
each permanently deformed end of the retaining sleeve approximately matches the profiled surface of the corresponding end ring.

6. The rotor module of claim 4, wherein the permanent deformation of each end of the retaining sleeve extends around a perimeter circumference of the sleeve to provide circumferential contact between the retaining sleeve and an exterior surface of each end ring.

7. The rotor module of claim 1, wherein the retaining sleeve comprises a non-magnetic steel (e.g. austenitic stainless steel), low magnetic permeability steel (e.g. Inconel), or carbon fiber.

8. The rotor module of claim 4, wherein the retaining sleeve is press fitted around the carrier and end rings to ensure that thermal expansion during operation will not impact contact area between the end rings, the carrier, and the sleeve.

9. The rotor module of claim 4, wherein:
the carrier further comprises a plurality of channels, each extending axially into an active length of the rotor module, and each configured to retain one of a plurality of balance masses;
the plurality of channels are configured to be disposed around the drive shaft; and
each end ring has a plurality of openings configured to align with the channels.

10. The rotor module of claim 1, wherein:
the plurality of laminations are pre-formed into a plurality of carrier subsections each having an axial length approximately equal to a length of the corresponding magnets, wherein when axially stacked, the plurality of carrier subsections jointly form the carrier;
the retaining sleeve is disposed around the plurality of carrier subsections;
the retaining sleeve holds the magnets corresponding to each carrier subsection onto the corresponding carrier subsection; and
the retaining sleeve holds the plurality of carrier subsections together axially.

11. A method of assembling a rotor module, comprising:
stacking a plurality of laminations on a mandrel to form a carrier;
disposing a plurality of magnets within grooves of the carrier;
disposing an end ring at each end of the carrier;
externally compressing the carrier and end rings axially;
disposing a retaining sleeve around the carrier and end rings; and
permanently deforming one or more end of the retaining sleeve to secure the end rings to the carrier.

12. The method of claim 11, wherein disposing the retaining sleeve around the carrier and end rings occurs during externally compressing the carrier and end rings axially by compressing the carrier and end rings axially into the retaining sleeve; and wherein externally compressing the carrier and end rings axially comprises two-stage compression.

13. The method of claim 12, wherein a first stage of compression compresses the carrier and end rings axially into the retaining sleeve, but does not compress the retaining sleeve, and the second stage of compression additionally compresses the one or more end of the retaining sleeve to permanently deform the one or more end of the retaining sleeve.

14. The method of claim 11, wherein permanently deforming one or more end of the retaining sleeve comprises bending the one or more end of the retaining sleeve radially inward around a perimeter circumference of the sleeve to provide circumferential contact between the retaining sleeve and an exterior surface of each end ring.

15. The method of claim 14, wherein the exterior surface of each end ring comprises a profiled surface, and the one or more bent end of the retaining sleeve approximately matches the profile surface.

16. The method of claim 11, further comprising releasing the external compression; wherein upon releasing the external compression, the rotor module retains a compressed axial length.

17. The method of claim 11, further comprising balancing the rotor module; wherein balancing the rotor module comprises inserting one or more balance rods axially into an active length of the rotor module.

18. The method of claim 11, further comprising clinching the stacked plurality of laminations prior to permanently deforming one or more end of each retaining sleeve, wherein clinching further comprises axially aligning the clinches on each lamination of the stack.

19. The method of claim 11, wherein stacking a plurality of laminations on a mandrel to form a carrier comprises stacking a portion of the plurality of laminations to form a plurality of carrier subsections, wherein each carrier subsection has an axial length approximately equal to that of the corresponding magnets; and stacking the plurality of carrier subsections onto the mandrel to form the carrier.

20. A rotor module comprising:
a plurality of module subsections each comprising:
a plurality of laminations axially stacked to form a carrier subsection,
a plurality of magnets, and
an external sleeve, and
a retaining mechanism;
wherein:
each carrier subsection comprises a plurality of axially-extending grooves, each configured to receive one or more of the plurality of magnets;
the plurality of magnets are surface mounted on the corresponding carrier subsection within the grooves;
the external sleeve extends concentrically around the corresponding carrier subsection and the corresponding magnets; and
the plurality of module subsections are joined together in an axial stack by the retaining mechanism.
